(19) United States
(12) Patent Application Publication
(10) Pub. No.: US 2016/0122547 A1
(43) Pub. Date: May 5, 2016

(54) METHOD FOR PRODUCING DYE MULTIMER, AND METHOD FOR PRODUCING COLORING COMPOSITION

(71) Applicant: FUJIFILM Corporation, Tokyo (JP)

(72) Inventors: Suguru SAMEJIMA, Shizuoka (JP); Tetsuya WATANABE, Shizuoka (JP); Yuushi KANEKO, Shizuoka (JP); Junichi ITO, Shizuoka (JP); Naotsugu MURO, Shizuoka (JP); Yoshinori TAGUCHI, Shizuoka (JP); Kazuya OOTA, Shizuoka (JP)

(73) Assignee: FUJIFILM Corporation, Tokyo (JP)

(21) Appl. No.: 14/994,837

(22) Filed: Jan. 13, 2016

Related U.S. Application Data
(63) Continuation of application No. PCT/JP2014/068692, filed on Jul. 14, 2014.

(30) Foreign Application Priority Data
Jul. 18, 2013 (JP) 2013-149771
Jun. 4, 2014 (JP) 2014-115702

(51) Int. Cl. C09B 69/10; G02B 5/22

(52) U.S. Cl. CPC C09B 69/109; C09B 69/105; C09B 69/103; G02B 5/223

(57) ABSTRACT

Provided are a method for producing a dye multimer having excellent heat resistance, and a coloring composition including a dye multimer obtained by the production method.

The method for producing a dye multimer includes reacting a compound having a dye structure with a polymer.

### CROSS-REFERENCE TO RELATED APPLICATIONS

This application is a Continuation of PCT International Application No. PCT/JP2014/068692 filed on Jul. 14, 2014, which claims priority under 35 U.S.C §119(a) to Japanese Patent Application No. 2013-149771 filed on Jul. 18, 2013 and Japanese Patent Application No. 2014-115702 filed on Jun. 4, 2014. Each of the above application(s) is hereby expressly incorporated by reference, in its entirety, into the present application.

### BACKGROUND OF THE INVENTION

1. Field of the Invention

The present invention relates to a method for producing a dye multimer and a method for producing a coloring composition, which are suitable for manufacturing a color filter used in a liquid crystal display element, a solid-state imaging element, or the like.

2. Description of the Related Art

As one of the methods for manufacturing a color filter which is used for a liquid crystal display device, a solid-state imaging element, or the like, there is a pigment dispersion method. As the pigment dispersion method, there is a method for manufacturing a color filter by a photolithography method by using a coloring photosensitive composition which is obtained by dispersing pigments in various photosensitive compositions. That is, a curable composition is applied onto a substrate by using a spin coater, a roll coater, or the like, the substrate is dried to form a coating film, and the coating film is developed by pattern exposure, thereby obtaining colored pixels. This operation is repeated for the number of the desired hues to manufacture a color filter.

The method is stable with respect to light or heat due to a use of pigments, and positional accuracy is sufficiently secured since patterning is performed by a photolithography method. Accordingly, the method has been widely used as a method suitable for manufacturing a color filter for color display, or the like.

Meanwhile, it is common to use a coloring composition including a dye or pigment for manufacturing a color filter, and it has been disclosed that as the dye or pigment, a dye multimer formed by polymerization of a dye is used (see, for example, JP2012-32754A, JP3736221B (JP2000-162429A), and JP1997-204047A (JP-H09-204047A)).

### SUMMARY OF THE INVENTION

However, in the related art as described above, a method for obtaining a dye multimer is solely a method involving subjecting a dye compound having a polymerizable group to a polymerization reaction, in which a variance in the molecular weights of the obtained dye multimer have occurred easily. As a result, dye multimers obtained by the related art have partially decomposed in an excessive heating process. Further, in the related art, dye multimers were formed by a polymerization reaction, and therefore, decomposed products of a polymerization initiator or the like remained in the obtained dye multimers.

The present invention has been made taking into consideration the above-described problems, and relates to a method for producing a dye multimer having excellent heat resistance, and a method for producing a coloring composition, including the production method.

The present inventors have conducted extensive studies, and as a result, have completed the present invention by reacting a compound having a dye structure with a polymer components constituted with a polymer.

Specifically, the problems were solved by the following means <1>, and preferably <2> to <9>.

<1> A method for producing a dye multimer, including reacting a compound having a dye structure with a polymer.

<2> The method for producing a dye multimer as described in <1>, in which the reaction is a reaction for forming a covalent bond between the compound having a dye structure and the polymer.

<3> The method for producing a dye multimer as described in <1> or <2>, further including a step of reacting a compound having a polymerizable group with the polymer.

<4> The method for producing a dye multimer as described in any one of <1> to <3>, in which the compound having a dye structure includes a cation moiety and a counter anion.

<5> The method for producing a dye multimer as described in <4>, in which the dye structure is a dye structure derived from a dye selected from a dipyrromethene dye, a triarylmethane dye, a xanthene dye, a cyanine dye, and a squarylium dye.

<6> The method for producing a dye multimer as described in <4> or <5>, in which the counter anion is selected from a sulfonic acid anion, a sulfonylimide anion, a bis(alkylsulfonyl)imide anion, a tris(alkylsulfonyl)methide anion, a carboxylic acid anion, a tetraarylborate anion, BF₄⁻, PF₆⁻, and SbF₆⁻.

<7> The method for producing a dye multimer as described in any one of <1> to <3>, in which the compound having a dye structure includes a cation and an anion in the same molecule.

<8> The method for producing a dye multimer as described in any one of <1> to <7>, in which the molecular weight distribution of the polymer is 1.0 to 2.5.

<9> A method for producing a coloring composition, including producing a dye multimer by the method for producing a dye multimer as described in any one of <1> to <8>; and blending a polymerizable compound, a pigment other than the dye multimer, and a photopolymerization initiator with one another.

By the present invention, it became possible to provide a coloring composition involving a method for producing a dye multimer having excellent heat resistance and a method for producing a coloring composition.

### DESCRIPTION OF THE PREFERRED EMBODIMENTS

Hereinafter, the method for producing a dye multimer and the method for producing a coloring composition of the present invention will be described in detail.

The explanation of constituents in the present invention as described below will be based on typical embodiments of the present invention, but the present invention is not limited to such embodiments.

In citations for a group (atomic group) in the present specification, when the group is denoted without specifying whether it is substituted or unsubstituted, the group includes both a group having no substituent and a group having a substituent. For example, an “alkyl group” includes not only an alkyl group having no substituent (unsubstituted alkyl group), but also an alkyl group having a substituent (substituted alkyl group).

Furthermore, “actinic ray(s)” or “radiation” in the present specification means, for example, a bright line spectrum of a mercury lamp and the like, far ultraviolet rays represented by an excimer laser, extreme ultraviolet rays (EUV rays), X-rays, electron beams, or the like. In addition, in the present invention, light means actinic rays or radiation. “Exposure” in the present specification includes, unless otherwise specified, not only exposure by a mercury lamp, far ultraviolet rays represented by an excimer laser, X-rays, EUV rays, or the like, but also writing by particle rays such as electron beams and ion beams.

In the present specification, a numeral value range represented by “(a value) to (a value)” means a range including the numeral values represented before and after “(a value) to (a value)” as a lower limit value and an upper limit value, respectively.

In the present specification, the total solid content refers to a total mass of the components remaining when a solvent is excluded from the entire composition of a coloring composition.

Furthermore, in the present specification, “(meth)acrylate” represents either or both of acrylate and methacrylate, “(meth)acryl” represents either or both of acryl and methacryl, and “(meth)acryloyl” represents either or both of acryloyl and methacryloyl.

Me represents a methyl group, Et represents an ethyl group, Ph represents a phenyl group, and Bu represents a butyl group.

In addition, in the present specification, a “monomer material” and a “monomer” have the same definition as each other. The monomer in the present specification refers to a compound which is distinguished from an oligomer or a polymer and has a weight-average molecular weight of 2,000 or less. In the present specification, a polymerizable compound refers to a compound having a polymerizable functional group, and may be a monomer or a polymer. The polymerizable functional group refers to a group involved in a polymerization reaction.

In the present specification, a term “step” includes not only an independent step, but also a step which is not clearly distinguished from other steps if an intended action of the step is obtained.

In the present specification, the weight-average molecular weight and the number-average molecular weight are defined as values in terms of polystyrene by GPC measurement. In the present specification, the weight-average molecular weight (Mw) and the number-average molecular weight (Mn) can be determined by using, for example, HLC-8220 (manufactured by Tosoh Corporation), TSKgel Super AWM-H (manufactured by Tosoh Corporation, 6.0 mmID×15.0 cm) as a column and a 10 mmol/L lithium bromide N-methylpyrrolidinone (NMP) solution as an eluant.

<Method for Producing Dye Multimer>

The method for producing a dye multimer of the present invention may include reacting a compound having a dye structure with a polymer. That is, in the method for producing a dye multimer of the present invention, a compound (polymerizable monomer) having a dye structure is not subjected to a polymerization reaction, but the compound having a dye structure is reacted with the polymer to produce a dye multimer.

In the related art, a dye multimer was produced by polymerizing a dye compound having a polymerizable group. As a result, variances in molecular weights or compositions of the obtained dye multimer easily occurred. For such a dye multimer having a variance in the molecular weight or the composition, the dye multimer easily decomposed by an excessive heating process and color migration to different patterns easily occurred. Further, the resistance to a developer and the resistance to a peeling solution tended to deteriorate when a pattern was formed by a dry etching method, using such a dye multimer.

Furthermore, in the related art, since a method for obtaining a dye multimer used a low-molecular compound such as a polymerization initiator as a catalyst, it could be seen that the heat resistance of the color filter deteriorated due to the presence of the low-molecular compound included in the obtained dye multimer. It could also be seen that the light resistance also deteriorated. In addition, since the molecular weight distribution of the polymer component of the dye multimer was wide, it could be seen that the pattern deficit or the linearity of a pattern deteriorated.

In contrast, according to the present invention, there is no problem as described above, and thus, it is possible to provide a cured film having excellent color characteristics and a color filter having the cured film.

The step of reacting a compound having a dye structure with a polymer in the production method of the present invention is a step of subjecting a reactive group contained in the polymer and a reactive group contained in the compound having a dye structure to a polymer reaction, and preferably a step of forming a covalent bond between the reactive group contained in the polymer and the reactive group contained in the compound having a dye structure.

The polymer reaction refers to a reaction with which a polymer is involved, and examples thereof include a reaction of a polymer with a low-molecular substance and a reaction of a polymer with a polymer, with each substance having a reactive group.

Examples (reaction example group X) of the reaction in the polymer reaction are shown below, but the present invention is not limited thereto.

Furthermore, the reactions described in “Polymer Functional Material Series 2, Synthesis and Reaction (2) of Polymer” (Kyoritsu Shuppan Co., Ltd.), “New Polymer Experimental Studies, Vol. 4, Synthesis and Reaction (3) of Polymer—Reaction and Decomposition of Polymer—” (Kyoritsu Shuppan Co., Ltd.), and the like can also be used.

Reaction Example Group X

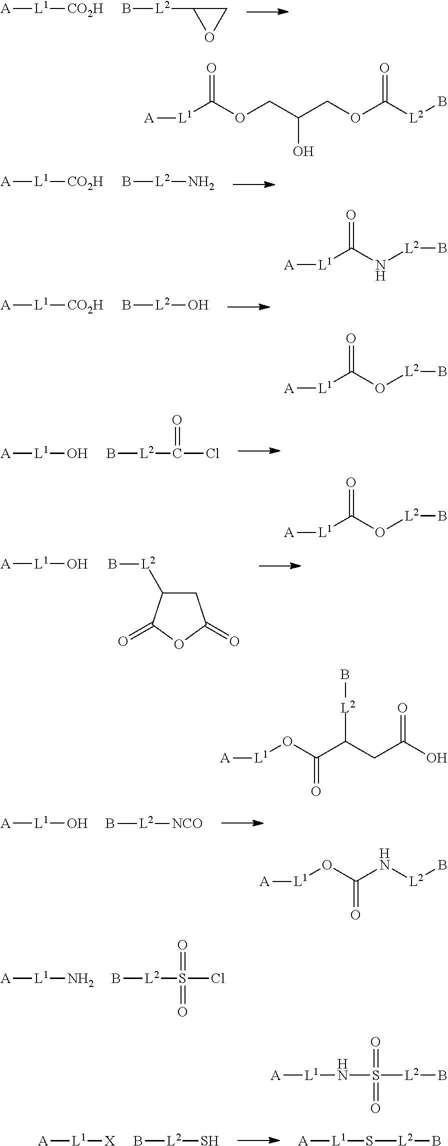

In the following reaction example group, one of A and B represents a polymer, the other represents a compound having a dye structure, L¹ and L² each represent a single bond or a linking group, and X represents a halogen.

The compound having a dye structure is reacted in an amount of preferably 0.3 moles to 1.0 mole, and more preferably 0.5 moles to 1.0 mole, with respect to 1 mole of the reactive group contained in the polymer.

In the step of reacting the compound having a dye structure with the polymer in the production method of the present invention, a catalyst may be blended, as desired. In the case of blending the catalyst, the blending amount thereof is preferably 1% by mass to 15% by mass, and more preferably 1% by mass to 10% by mass, with respect to the polymer, and it is also possible to employ an embodiment in which a catalyst is substantially not blended. Further, substantially not blending a catalyst means, for example, blending a catalyst in the amount of 0.1% by mass or less with respect to the polymer.

As the catalyst, various known catalysts for forming covalent bonds can be used, and reference may be made to those described in (“Experimental Chemistry Lecture” (published by Maruzen Co., Ltd.), “New Polymer Experimental Studies” (Kyoritsu Shuppan Co., Ltd., etc.)). Specifically, tetraethylammonium bromide, tetrabutylammonium bromide, NEOSTANN (manufactured by NITTO KASEI Co., Ltd.), or the like can be used.

In the present invention, a solvent may be used when the polymer is reacted with the compound having a dye structure. In this case, examples of the solvent include esters (for example, methyl 3-ethoxypropionate, ethyl 3-ethoxypropionate, ethyl lactate, butyl acetate, and methyl 3-methoxypropionate), ethers (for example, methyl cellosolve acetate, ethyl cellosolve acetate, propylene glycol monomethyl ether, and propylene glycol monomethyl ether acetate), ketones (methyl ethyl ketone, cyclohexanone, 2-heptanone, and 3-heptanone), and aromatic hydrocarbons (for example, toluene and xylene).

<<Polymer>>

In the present invention, the above-described problems can be solved by reacting a compound having a dye structure with a polymer. In particular, by using a polymer having a uniform molecular weight distribution, for example, a polymer having a molecular weight distribution of 1.0 to 2.5, or a polymer having a molecular weight distribution of 1.0 to 2.0, more uniform dye multimers can be obtained, whereby the effects of the present invention can be more effectively exerted. The molecular weight distribution can be measured by, for example, gel permeation chromatography (GPC).

The weight-average molecular weight of the polymer which is used in the present invention is preferably 2,000 to 20,000, more preferably 3,000 to 15,000, and particularly preferably 4,000 to 10,000.

The polymer which is used in the present invention usually includes a repeating unit having a reactive group capable of reacting with a compound having a dye structure. One kind or two or more kinds of these repeating units may be used. The amount of the repeating unit having a reactive group is preferably 20% by mole to 90% by mole, and more preferably 30% by mole to 70% by mole, with respect to the total repeating units. As the reactive group, a reactive group capable of forming a covalent bond with the reactive group contained in the compound having a dye structure is preferable, and a carboxyl group, a hydroxyl group, an epoxy group, an isocyanate group, an amino group, or an acid anhydride is more preferable.

Specific examples of the repeating units having a reactive group of the polymer are shown below, but the present invention is not limited thereto.

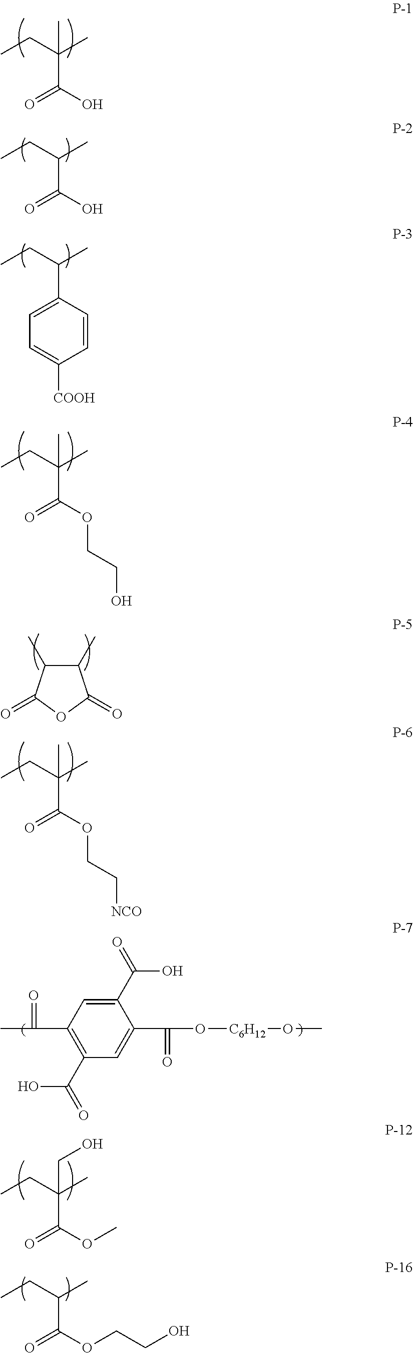

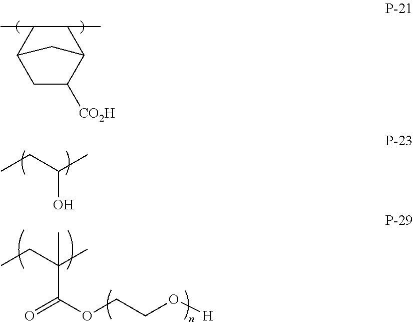

Among these, as the polymer, P-1 to P-8, and P-16 are preferable. n is a positive integer.

<<Compound Having Dye Structure>>

The compound having a dye structure, which is used in the present invention, is usually a compound having a dye structure derived from a dye whose maximum absorption wavelength is in the range from 400 nm to 780 nm in a molecule structure thereof, and is usually a dye monomer. However, within a range not departing from the objects of the present invention, a dye dimer or a dye trimer can also be used.

Furthermore, the compound having a dye structure usually has a reactive group capable of reacting with the polymer. As the reactive group, reactive group capable of forming a covalent bond with a reactive group of the polymer is preferable; a carboxyl group, a hydroxyl group, an epoxy group, an isocyanate group, an acid halide, an amino group, or an acid anhydride is more preferable; and a carboxyl group, a hydroxyl group, an epoxy group, an isocyanate group, or an acid halide is still more preferable.

The compound having a dye structure may have one or more reactive groups capable of reacting with the polymer within one molecule, and preferably has one reactive group in one molecule.

In addition, the compound having a dye structure is introduced preferably in the amount of 20% by mole to 90% by mole, and more preferably in the amount of 30% by mole to 70% by mole, with respect to all the repeating units which the polymer has.

<<Dye Structure>>

Examples of the dye structure in the compound having a dye structure include dye structures derived from a dye selected from a dipyrromethene dye, a carbonium dye (a diphenylmethane dye, a triarylmethane dye, a xanthene dye, an acridine dye, and the like), a polymethine dye (an oxonol dye, a merocyanine dye, an arylidene dye, a styryl dye, a cyanine dye, a squarylium dye, a croconium dye, and the like), a subphthalocyanine dye, and metal complex dyes of these.

Among these dye structures, from the viewpoint of color characteristics, dye structures derived from a dye selected from a dipyrromethene dye, a carbonium dye, and a polymethine dye are preferable; dye structures derived from a dye selected from a triarylmethane dye, a xanthene dye, a cyanine dye, a squarylium dye, a quinophthalone dye, a phthalocyanine dye, and a subphthalocyanine dye are more preferable; dye structures derived from a dye selected from a dipyrromethene dye, a triarylmethane dye, a xanthene dye, a cyanine dye, and a squarylium dye are still more preferable; and dye structures derived from a dye selected from xanthene dyes are most preferable.

Specific dye compounds which can form a dye structure are described in “New Edition of Dye Handbook” (edited by The Society of Synthetic Organic Chemistry, Japan; Maruzen Co., Ltd., 1970), “Color index” (edited by The Society of Dyers and colourists), “Dye Handbook” (Gen Ogawara, et al.; Kodansha, Ltd., 1986), and the like.

Details of the compound having a dye structure are described below.

Dipyrromethene Dye

As the dipyrromethene dye in the present invention, a dipyrromethene compound, and a dipyrromethene metal complex compound obtained from a dipyromethene compound with a metal or a metal compound are preferable.

Incidentally, in the present invention, a compound including a dipyrromethene structure is referred to as a dipyrromethene compound, and a complex in which a metal or a metal compound is coordinated to the compound having a dipyrromethene structure is referred to as a dipyrromethene metal complex compound.

As the dipyrromethene metal complex compound, a dipyrromethene metal complex compound obtained from a dipyrromethene compound represented by the following General Formula (M) with a metal or a metal compound and a tautomer thereof are preferable. Among these, a dipyrromethene metal complex compound represented by the following General Formula (7) and a dipyrromethene metal complex compound represented by the following General Formula (8) are exemplified as preferred embodiments, and the dipyrromethene metal complex compound represented by the following General Formula (8) is most preferable.

Dipyrromethene Metal Complex Compound Obtained from Dipyrromethene Compound Represented by General Formula (M) with Metal or a Metal Compound, and Tautomer Thereof

One of the preferred embodiments of the dye structure in the compound having a dye structure is a dye structure which includes, as a dye moiety, a complex (hereinafter appropriately referred to as a “specific complex”) in which a compound (dipyrromethene compound) represented by the following General Formula (M) or a tautomer thereof is coordinated to a metal or a metal compound. In the present invention, the following compound preferably forms a cationic structure, and for example, an NH moiety in General Formula (M) forms a cationic structure.

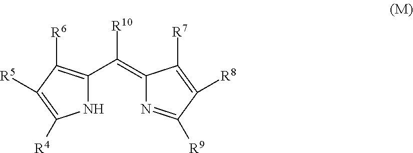

In General Formula (M), R⁴ to R¹⁰ each independently represent a hydrogen atom or a monovalent substituent, provided that there is no case where R⁴ and R⁹ are bonded to each other to form a ring. Further, at least one of R⁴ to R¹⁰ has a reactive group capable of reacting with a polymer.

When the compound represented by General Formula (M) is introduced into the polymer, the introduction site is preferably introduced at any one site of R⁴ to R⁹, more preferably introduced at any one site of R⁴, R⁶, R⁷, and R⁹, and still more preferably introduced at any one site of R⁴ and R⁹.

In the case where R⁴ to R⁹ in General Formula (M) represent a monovalent substituent, examples of the monovalent substituent include the substituents exemplified in the section of the substituent group A which will be described later.

In the case where the monovalent substituents represented by R⁴ to R⁹ in General Formula (M) are each a group which can be further substituted, the group may further have the substituent(s) described for R⁴ to R⁹, and in the case where the group has two or more substituents, these substituents may be the same as or different from each other.

In General Formula (M), R⁴ and R⁵, R⁵ and R⁶, R⁷ and R⁸, and R⁸ and R⁹ may be each independently bonded to each other to form a 5-, 6-, or 7-membered saturated or unsaturated ring, provided that there is no case where R⁴ and R⁹ are bonded to each other to form a ring. In the case where the formed 5-, 6-, or 7-membered ring is a group which can be further substituted, the ring may be substituted with the substituents described for R⁴ to R⁹, and in the case where the ring is substituted with two or more substituents, these substituents may be the same as or different from each other.

In General Formula (M), in the case where R⁴ and R⁵, R⁵ and R⁶, R⁷ and R⁸, and R⁸ and R⁹ are each independently bonded to each other to form a 5-, 6-, or 7-membered saturated or unsaturated ring not having a substituent, examples of the 5-, 6-, or 7-membered saturated or unsaturated ring not having a substituent include a pyrrole ring, a furan ring, a thiophene ring, a pyrazole ring, an imidazole ring, a triazole ring, an oxazole ring, a thiazole ring, a pyrrolidine ring, a piperidine ring, a cyclopentene ring, a cyclohexene ring, a benzene ring, a pyridine ring, a pyrazine ring, and a pyridazine ring, and preferably a benzene ring and a pyridine ring.

R¹⁰ in General Formula (M) preferably represents a hydrogen atom, a halogen atom, an alkyl group, an aryl group, or a heterocyclic group. The halogen atom, the alkyl group, the aryl group, and the heterocyclic group have the same definitions as those of the halogen atom, the alkyl group, the aryl group, and the heterocyclic group, respectively, described in the section of the substituent group A which will be described later, and a preferred range thereof is also the same.

In the case where R¹⁰ represents an alkyl group, an aryl group, or a heterocyclic group, if the alkyl group, the aryl group, and the heterocyclic group are groups which can be further substituted, they may be substituted with the substituents described in the section of the substituent group A which will be described later. In the case where the groups are substituted with two or more substituents, the substituents may be the same as or different from each other.

˜Metal or Metal Compound˜

The specific complex in the present invention is a complex in which the dipyrromethene compound represented by General Formula (M) or a tautomer thereof is coordinated to a metal or a metal compound.

Herein, the metal or metal compound may be any types of metal or metal compound as long as it can form a complex, and examples thereof include a divalent metal atom, a divalent metal oxide, a divalent metal hydroxide, and a divalent metal chloride. Examples of the metal or metal compound include metals such as Zn, Mg, Si, Sn, Rh, Pt, Pd, Mo, Mn, Pb, Cu, Ni, Co, and Fe, metal chlorides such as AlCl, InCl, FeCl, TiCl₂, SnCl₂, SiCl₂, and GeCl₂, metal oxides such as TiO and VO, and metal hydroxides such as Si(OH)₂.

Among these, in view of the stability, spectral characteristics, heat resistance, light fastness, and production suitability of the complex, Fe, Zn, Mg, Si, Pt, Pd, Mo, Mn, Cu, Ni, Co, TiO, or VO is preferable, Zn, Mg, Si, Pt, Pd, Cu, Ni, Co, or VO is more preferable, and Zn is particularly preferable.

Next, a more preferred range of the specific complex of the compound represented by General Formula (M) in the present invention will be described.

A preferred range of the specific complex in the present invention is a range in which in General Formula (M), R⁴ and R⁹ are each independently a hydrogen atom, an alkyl group, an alkenyl group, an aryl group, a heterocyclic group, a silyl group, a hydroxyl group, a cyano group, an alkoxy group, an aryloxy group, a heterocyclic oxy group, an acyl group, an alkoxycarbonyl group, a carbamoyl group, an amino group, an anilino group, a heterocyclic amino group, a carbonamide group, a ureido group, an imide group, an alkoxycarbonylamino group, an aryloxycarbonylamino group, a sulfonamide group, an azo group, an alkylthio group, an arylthio group, a heterocyclic thio group, an alkylsulfonyl group, an arylsulfonyl group, or a phosphinoylamino group; R⁵ and R⁸ are each independently a hydrogen atom, a halogen atom, an alkyl group, an alkenyl group, an aryl group, a heterocyclic group, a hydroxyl group, a cyano group, a nitro group, an alkoxy group, an aryloxy group, a heterocyclic oxy group, an acyl group, an alkoxycarbonyl group, an aryloxycarbonyl group, a carbamoyl group, an imide group, an alkoxycarbonylamino group, a sulfonamide group, an azo group, an alkylthio group, an arylthio group, a heterocyclic thio group, an alkylsulfonyl group, an arylsulfonyl group, or a sulfamoyl group; R⁶ and R⁷ are each independently a hydrogen atom, a halogen atom, an alkyl group, an alkenyl group, an aryl group, a heterocyclic group, a silyl group, a hydroxyl group, a cyano group, an alkoxy group, an aryloxy group, a heterocyclic oxy group, an acyl group, an alkoxycarbonyl group, a carbamoyl group, an anilino group, a carbonamide group, a ureido group, an imide group, an alkoxycarbonylamino group, a sulfonamide group, an azo group, an alkylthio group, an arylthio group, a heterocyclic thio group, an alkylsulfonyl group, an arylsulfonyl group, a sulfamoyl group, or a phosphinoylamino group; R¹⁰ is a hydrogen atom, a halogen atom, an alkyl group, an aryl group, or a heterocyclic group; and the metal or metal compound is Zn, Mg, Si, Pt, Pd, Mo, Mn, Cu, Ni, Co, TiO, or V═O.

A more preferred range of the specific complex in the present invention is a range in which in General Formula (M), R⁴ and R⁹ are each independently a hydrogen atom, an alkyl group, an alkenyl group, an aryl group, a heterocyclic group, a cyano group, an acyl group, an alkoxycarbonyl group, a carbamoyl group, an amino group, a heterocyclic amino group, a carbonamide group, a ureido group, an imide group, an alkoxycarbonylamino group, an aryloxycarbonylamino group, a sulfonamide group, an azo group, an alkylsulfonyl group, an arylsulfonyl group, or a phosphinoylamino group; R⁵ and R⁸ are each independently an alkyl group, an alkenyl group, an aryl group, a heterocyclic group, a cyano group, a nitro group, an acyl group, an alkoxycarbonyl group, an aryloxycarbonyl group, a carbamoyl group, an imide group, an alkylsulfonyl group, an aryl sulfonyl group, or a sulfamoyl group; R⁶ and R⁷ are each independently a hydrogen atom, an alkyl group, an alkenyl group, an aryl group, a heterocyclic group, a cyano group, an acyl group, an alkoxycarbonyl group, a carbamoyl group, a carbonamide group, a ureido group, an imide group, an alkoxycarbonylamino group, a sulfonamide group, an alkylthio group, an arylthio group, a heterocyclic thio group, an alkylsulfonyl group, an arylsulfonyl group, or a sulfamoyl group; R¹⁰ is a hydrogen atom, a halogen atom, an alkyl group, an aryl group, or a heterocyclic group; and the metal or metal compound is Zn, Mg, Si, Pt, Pd, Cu, Ni, Co, or V═O.

A particularly preferred range of the specific complex in the present invention is a range in which in General Formula (M), R⁴ and R⁹ are each a hydrogen atom, an alkyl group, an aryl group, a heterocyclic group, an amino group, a heterocyclic amino group, a carbonamide group, a ureido group, an imide group, an alkoxycarbonylamino group, a sulfonamide group, an azo group, an alkylsulfonyl group, an arylsulfonyl group, or a phosphinoylamino group; R⁵ and R⁸ are each independently an alkyl group, an aryl group, a heterocyclic group, a cyano group, an acyl group, an alkoxycarbonyl group, a carbamoyl group, an alkylsulfonyl group, or an arylsulfonyl group; R⁶ and R⁷ are each independently a hydrogen atom, an alkyl group, an aryl group, or a heterocyclic group; R¹⁰ is a hydrogen atom, an alkyl group, an aryl group, or a heterocyclic group; and the metal or metal compound is Zn, Cu, Co, or V═O.

Moreover, a dipyrromethene metal complex compound represented by General Formula (7) or General Formula (8), which will be described in detail below, is also a particularly preferred embodiment of the dipyrromethene dye.

One of the suitable embodiments of the compound having a dye structure is a dye structure derived from a dipyrromethene metal complex compound represented by the following General Formula (7). In the present invention, the following compound forms a cationic structure, and for example, Ma in General Formula (7) can form a cationic structure.

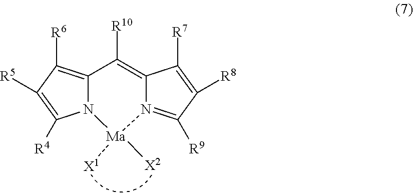

In General Formula (7), R⁴ to R⁹ each independently represent a hydrogen atom or a monovalent substituent, and R¹⁰ represents a hydrogen atom, a halogen atom, an alkyl group, an aryl group, or a heterocyclic group. Ma represents a metal atom or a metal compound. X¹ represents a group which can be bonded to Ma, X² represents a group which neutralizes the charge of Ma, and X¹ and X² may be bonded to each other to form a 5-, 6-, or 7-membered ring together with Ma, provided that there is no case where R⁴ and R⁹ are bonded to each other to form a ring. Further, at least one of R⁴ to R¹⁰ has a reactive group capable of reacting with a polymer.

Incidentally, the dipyrromethene metal complex compound represented by General Formula (7) includes a tautomer.

In the case where the dipyrromethene metal complex compound represented by General Formula (7) is introduced into the polymer, in view of synthesis suitability, the compound is preferably introduced at any one site of R⁴ to R⁹, more preferably introduced at any one site of R⁴, R⁶, R⁷, and R⁹, and still more preferably introduced at any one site of R⁴ and R⁹.

In the case where the compound having a dye structure has an alkali-soluble group, as a method for introducing the alkali-soluble group, a method of bonding the alkali-soluble group to one, two, or more substituents out of R⁴ to R¹⁰, X¹ and X² in General Formula (7) can be used. Among these substituents, any one of R⁴ to R⁹ and X¹ is preferable, any one of R⁴, R⁶, R⁷, and R⁹ is more preferable, and any one of R⁴ and R⁹ is still more preferable.

R⁴ to R⁹ in General Formula (7) have the same definitions as R⁴ to R⁹ in General Formula (M), and preferred embodiments thereof are also the same.

In General Formula (7), Ma represents a metal atom or a metal compound. The metal atom or metal compound may be any type as long as it is a metal atom or a metal compound which can form a complex, and examples thereof include a divalent metal atom, a divalent metal oxide, a divalent metal hydroxide, or a divalent metal chloride.

Examples of the metal atom or metal compound include Zn, Mg, Si, Sn, Rh, Pt, Pd, Mo, Mn, Pb, Cu, Ni, Co, and Fe; metal chlorides such as AlCl, InCl, FeCl, TiCl₂, SnCl₂, SiCl₂, and GeCl₂; metal oxides such as TiO and V═O, and metal hydroxides such as Si(OH)₂.

Among these, in view of stability, spectral characteristics, heat resistance, light fastness, and production suitability of the complex, as the metal atom or metal compound, Fe, Zn, Mg, Si, Pt, Pd, Mo, Mn, Cu, Ni, Co, TiO, and V═O are preferable, Zn, Mg, Si, Pt, Pd, Cu, Ni, Co, and V═O are more preferable, Zn, Co, V═O, and Cu are particularly preferable, and Zn is most preferable.

In General Formula (7), R¹⁰ represents a hydrogen atom, a halogen atom, an alkyl group, an aryl group, or a heterocyclic group, and is preferably a hydrogen atom.

In General Formula (7), X¹ may be any group as long as the group can be bonded to Ma, and specific examples thereof include water, alcohols (for example, methanol, ethanol, and propanol), and compounds disclosed in “Metal Chelates” ([1] Takeichi Sakaguchi and Kagehira Ueno (1995, Nankodo Co., Ltd.), [2] (1996), [3] (1997), and the like). Among these, in view of production thereof, water, a carboxylic acid compound, and alcohols are preferable, and water and a carboxylic acid compound are more preferable.

In General Formula (7), examples of the “group which neutralizes the charge of Ma” represented by X² include a halogen atom, a hydroxyl group, a carboxylic acid group, a phosphoric acid group, a sulfonic acid group, and the like. Among these, in view of production thereof, a halogen atom, a hydroxyl group, a carboxylic acid group, and a sulfonic acid group are preferable, and a hydroxyl group and a carboxylic acid group are more preferable.

In General Formula (7), X¹ and X² may be bonded to each other to form a 5-, 6-, or 7-membered ring together with Ma. The formed 5-, 6-, or 7-membered ring may be a saturated or unsaturated ring. In addition, the 5-, 6-, or 7-membered ring may be constituted only with carbon atoms or may form a heterocycle having at least one atom selected from a nitrogen atom, an oxygen atom, or/and a sulfur atom.

In a preferred embodiment of the compound represented by General Formula (7), R⁴ to R⁹ each independently represent the group described as the preferred embodiment of R⁴ to R⁹; R¹⁰ represents the group described as the preferred embodiment of R¹⁰, Ma is Zn, Cu, Co, or V═O; X¹ is water or a carboxylic acid compound; X² is a hydroxyl group or a carboxylic acid group; and X¹ and X² may be each independently bonded to each other to form a 5- or 6-membered ring.

One of suitable embodiments of the compound having a dye structure is a dye structure derived from a dipyrromethene metal complex compound represented by the following General Formula (8). In the present invention, the following compound preferably forms a cationic structure, and for example, it is preferable that Ma in General Formula (8) forms a cationic structure and X¹ forms an anionic structure.

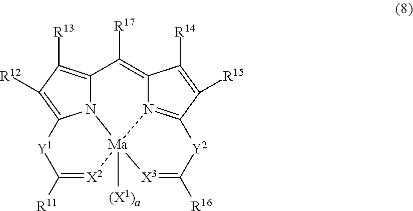

In General Formula (8), R¹¹ and R¹⁶ each independently represent an alkyl group, an alkenyl group, an aryl group, a heterocyclic group, an alkoxy group, an aryloxy group, an alkylamino group, an arylamino group, or a heterocyclic amino group. R¹² to R¹⁵ each independently represent a hydrogen atom or a substituent. R¹⁷ represents a hydrogen atom, a halogen atom, an alkyl group, an aryl group, or a heterocyclic group. Ma represents a metal atom or a metal compound. X² and X³ each independently represent NR (in which R represents a hydrogen atom, an alkyl group, an alkenyl group, an aryl group, a heterocyclic group, an acyl group, an alkylsulfonyl group, or an arylsulfonyl group), a nitrogen atom, an oxygen atom, or a sulfur atom. Y¹ and Y² each independently represent NR^{c} (in which R^{c} represents a hydrogen atom, an alkyl group, an alkenyl group, an aryl group, a heterocyclic group, an acyl group, an alkylsulfonyl group, or an arylsulfonyl group), a nitrogen atom or a carbon atom. R¹¹ and Y¹ may be bonded to each other to form a 5-, 6-, or 7-membered ring, and R¹⁶ and Y² may be bonded to each other to form a 5-, 6-, or 7-membered ring. X¹ represents a group which can be bonded to Ma, and a represents 0, 1, or 2. Further, at least one of R, R^{c} and R¹¹ to R¹⁶ has a reactive group capable of reacting with a polymer.

Incidentally, the dipyrromethene compound represented by General Formula (8) includes a tautomer.

The site at which the compound represented by General Formula (8) is introduced into synthesis suitability, it is preferable that the compound is introduced at one of R¹¹ to R¹⁶ and X¹. In a more preferred embodiment, the compound is introduced at one of R¹¹, R¹³, R¹⁴, and R¹⁶, and in a still more preferred embodiment, the compound is introduced at one of R¹¹ and R¹⁶.

In the case where the compound having a dye structure has an alkali-soluble group, if a dye monomer or a structural unit having the alkali-soluble group is used, as a method for introducing the alkali-soluble group, it is possible to use a method for introducing the alkali-soluble group into one, two, or more substituents out of R¹¹ to R¹⁷, X¹, Y¹ to Y² in General Formula (8). Among these substituents, one of R¹¹ to R¹⁶ and X¹ is preferable, one of R¹¹, R¹³, R¹⁴, and R¹⁶ is more preferable, and one of R¹¹ and R¹⁶ is still more preferable.

In General Formula (8), R¹² to R¹⁵ have the same definitions as R⁵ to R⁸ in General Formula (M), and preferred embodiments thereof are also the same. R¹⁷ has the same definition as R¹⁰ in General Formula (M), and a preferred embodiment thereof is also the same. Ma has the same definition as Ma in General Formula (7), and a preferred range thereof is also the same.

More specifically, among R¹² to R¹⁵ in General Formula (8), as R¹² and R¹⁵, an alkoxycarbonyl group, an aryloxycarbonyl group, a carbamoyl group, an alkylsulfonyl group, an arylsulfonyl group, a nitrile group, an imide group, and a carbamoylsulfonyl group are preferable, an alkoxycarbonyl group, an aryloxycarbonyl group, a carbamoyl group, an alkylsulfonyl group, a nitrile group, an imide group, and a carbamoylsulfonyl group are more preferable, an alkoxycarbonyl group, an aryloxycarbonyl group, a carbamoyl group, a nitrile group, an imide group, and a carbamoylsulfonyl group are still more preferable, and an alkoxycarbonyl group, an aryloxycarbonyl group, and a carbamoyl group are particularly preferable.

As R¹³ and R¹⁴, a substituted or unsubstituted alkyl group, a substituted or unsubstituted aryl group, and a substituted or unsubstituted heterocyclic group are preferable, and a substituted or unsubstituted alkyl group and a substituted or unsubstituted aryl group are more preferable. Specific examples of the more preferable alkyl group, aryl group, and heterocyclic group include the same specific examples as listed for R⁶ and R⁷ in General Formula (M).

In General Formula (8), and R¹⁶ each represent an alkyl group (a linear, branched, or cyclic alkyl group preferably having 1 to 36 carbon atoms, and more preferably having 1 to 12 carbon atoms, for example, a methyl group, an ethyl group, a propyl group, an isopropyl group, a butyl group, an isobutyl group, a tert-butyl group, a hexyl group, a 2-ethylhexyl group, a dodecyl group, a cyclopropyl group, a cyclopentyl group, a cyclohexyl group, and a 1-adamantyl group), an alkenyl group (an alkenyl group preferably having 2 to 24 carbon atoms, and more preferably having 2 to 12 carbon atoms, for example, a vinyl group, an allyl group, and a 3-buten-1-yl group), an aryl group (an aryl group preferably having 6 to 36 carbon atoms, and more preferably having 6 to 18 carbon atoms, for example, a phenyl group and a naphthyl group), a heterocyclic group (a heterocyclic group preferably having 1 to 24 carbon atoms, and more preferably having 1 to 12 carbon atoms, for example, a 2-thienyl group, a 4-pyridyl group, a 2-furyl group, a 2-pyrimidinyl group, a 2-pyridyl group, a 2-benzothiazolyl group, a 1-imidazolyl group, a 1-pyrazolyl group, and a benzotriazol-1-yl group), an alkoxy group (an alkoxy group preferably having 1 to 36 carbon atoms, and more preferably having 1 to 18 carbon atoms, for example, a methoxy group, an ethoxy group, a propyloxy group, a butoxy group, a hexyloxy group, a 2-ethylhexyloxy group, a dodecyloxy group, and a cyclohexyloxy group), an aryloxy group (an aryloxy group preferably having 6 to 24 carbon atoms, and more preferably having 1 to 18 carbon atoms, for example, a phenoxy group and a naphthyloxy group), an alkylamino group (an alkylamino group preferably having 1 to 36 carbon atoms, and more preferably having 1 to 18 carbon atoms, for example, a methylamino group, an ethylamino group, a propylamino group, a butylamino group, a hexylamino group, a 2-ethylhexylamino group, an isopropylamino group, a tert-butylamino group, a tert-octylamino group, a cyclohexylamino group, an N,N-diethylamino group, an N,N-dipropylamino group, an N,N-dibutylamino group, and an N-methyl-N-ethylamino group), an arylamino group (an arylamino group preferably having 6 to 36 carbon atoms, and more preferably having 6 to 18 carbon atoms, for example, a phenylamino group, a naphthylamino group, an N,N-diphenylamino group, and an N-ethyl-N-phenylamino group), and a heterocyclic amino group (a heterocyclic amino group preferably having 1 to 24 carbon atoms, and more preferably having 1 to 12 carbon atoms, for example, a 2-aminopyrrole group, 3-aminopyrazole, a 2-aminopyridine group, and a 3-aminopyridine group).

Among the above groups, as R¹¹ and R¹⁶, an alkyl group, an alkenyl group, an aryl group, a heterocyclic group, an alkylamino group, an arylamino group, and a heterocyclic amino group are preferable, an alkyl group, an alkenyl group, an aryl group, and a heterocyclic group are more preferable, an alkyl group, an alkenyl group, and an aryl group are still more preferable, and an alkyl group is particularly preferable.

In General Formula (8), in the case where the alkyl group, the alkenyl group, the aryl group, the heterocyclic group, the alkoxy group, the aryloxy group, the alkylamino group, the arylamino group, or the heterocyclic amino group represented by R¹¹ and R¹⁶ is a group which can be further substituted, the group may be substituted with the substituents described in the section of the substituent group A which will be described later. In the case where the group is substituted with two or more substituents, these substituents may be the same as or different from each other.

In General Formula (8), X² and X³ each independently represent NR, a nitrogen atom, an oxygen atom, or a sulfur atom. Herein, R represents a hydrogen atom, an alkyl group (a linear, branched, or cyclic alkyl group preferably having 1 to 36 carbon atoms, and more preferably having 1 to 12 carbon atoms, for example, a methyl group, an ethyl group, a propyl group, an isopropyl group, a butyl group, an isobutyl group, a tert-butyl group, a hexyl group, a 2-ethylhexyl group, a dodecyl group, a cyclopropyl group, a cyclopentyl group, a cyclohexyl group, and a 1-adamantyl group), an alkenyl group (an alkenyl group preferably having 2 to 24 carbon atoms, and more preferably having 2 to 12 carbon atoms, for example, a vinyl group, an allyl group, and a 3-buten-1-yl group), an aryl group (an aryl group preferably having 6 to 36 carbon atoms, and more preferably having 6 to 18 carbon atoms, for example, a phenyl group and a naphthyl group), a heterocyclic group (a heterocyclic group preferably having 1 to 24 carbon atoms, and more preferably having 1 to 12 carbon atoms, for example, a 2-thienyl group, a 4-pyridyl group, a 2-furyl group, a 2-pyrimidinyl group, a 1-pyridyl group, a 2-benzothiazolyl group, a 1-imidazolyl group, a 1-pyrazolyl group, and a benzotriazol-1-yl group), an acyl group (an acyl group preferably having 1 to 24 carbon atoms, and more preferably having 2 to 18 carbon atoms, for example, an acetyl group, a pivaloyl group, a 2-ethylhexyl group, a benzoyl group, and a cyclohexanoyl group), an alkylsulfonyl group (an alkylsulfonyl group preferably having 1 to 24 carbon atoms, and more preferably having 1 to 18 carbon atoms, for example, a methylsulfonyl group, an ethylsulfonyl group, an isopropylsulfonyl group, and a cyclohexylsulfonyl group), and an arylsulfonyl group (an arylsulfonyl group preferably having 6 to 24 carbon atoms, and more preferably having 6 to 18 carbon atoms, for example, a phenylsulfonyl group and a naphthylsulfonyl group).

In General Formula (8), Y¹ and Y² each independently represent NR^{c}, a nitrogen atom, or a carbon atom. R^{c} has the same definition as R of X² and X³, and a preferred embodiment thereof is also the same.

In General Formula (8), R^{H} and Y¹ may be each independently bonded to each other to form a 5-membered ring (for example, a cyclopentane ring, a pyrrolidine ring, a tetrahydrofuran ring, a dioxolane ring, a tetrahydrothiophene ring, a pyrrole ring, a furan ring, a thiophene ring, an indole ring, a benzofuran ring, and a benzothiophene ring), a 6-membered ring (for example, a cyclohexane ring, a piperidine ring, a piperazine ring, a morpholine ring, a tetrahydropyran ring, a dioxane ring, a pentamethylene sulfide ring, a dithiane ring, a benzene ring, a piperidine ring, a piperazine ring, a pyridazine ring, a quinoline ring, and a quinazoline ring), or a 7-membered ring (for example, a cycloheptane ring and a hexamethylenimine ring) together with a carbon atom.

In General Formula (8), R¹⁶ and Y² may be each independently bonded to each other to form a 5-membered ring (for example, a cyclopentane ring, a pyrrolidine ring, a tetrahydrofuran ring, a dioxolane ring, a tetrahydrothiophene ring, a pyrrole ring, a furan ring, a thiophene ring, an indole ring, a benzofuran ring, and a benzothiophene ring), a 6-membered ring (for example, a cyclohexane ring, a piperidine ring, a piperazine ring, a morpholine ring, a tetrahydropyran ring, a dioxane ring, a pentamethylene sulfide ring, a dithiane ring, a benzene ring, a pyridazine ring, a quinoline ring, and a quinazoline ring), or a 7-membered ring (for example, a cycloheptane ring and a hexamethyleneimine ring) together with a carbon atom.

In General Formula (8), in the case where the 5-, 6-, and 7-membered rings formed by mutual bonding of R¹¹ and Y¹ as well as R¹⁶ and Y² are substitutable rings, the rings may be substituted with the substituents described in the section of the substituent group A which will be described later. In the case where the rings are substituted with two or more substituents, these substituents may be the same as or different from each other.

In General Formula (8), R¹¹ and R¹⁶ are each independently a monovalent substituent having an −Es′value, which is a steric parameter, of preferably 1.5 or more, more preferably 2.0 or more, still more preferably 3.5 or more, and particularly preferably 5.0 or more.

Herein, the steric parameter, −Es′ value, is a parameter which represents the steric bulkiness of a substituent. As the value, the −Es′ value disclosed in the document (J. A. Macphee, et al, Tetrahedron, Vol. 34, pp 3553-3562, and Chemistry Special Edition 107, Structure-activity Correlation and Drug Design, edited by Toshio Fujita, published on Feb. 20, 1986 (Kagaku-Doujin Publishing Company, Inc.)) is used.

In General Formula (8), X¹ represents a group which can be bonded to Ma. Specific examples thereof include the same group as X¹ in General Formula (7), and preferred embodiments thereof are also the same. a represents 0, 1, or 2.

With respect to a preferred embodiment of the compound represented by General Formula (8), R¹² to R¹⁵ are each independently one in the preferred embodiment cited in the description of R⁵ to R⁸ in General Formula (M), R¹⁷ is one in the preferred embodiment cited in the description of R¹⁰ in General Formula (M), Ma is Zn, Cu, Co, or V═O, X² is NR (in which R represents a hydrogen atom or an alkyl group), a nitrogen atom, or an oxygen atom, X³ is NR (in which R represents a hydrogen atom or an alkyl group) or an oxygen atom, Y¹ is NR^{c} (in which R^{c} represents a hydrogen atom or an alkyl group), a nitrogen atom, or a carbon atom, Y² is a nitrogen atom or a carbon atom, R¹¹ and R¹⁶ are each independently an alkyl group, an aryl group, a heterocyclic group, an alkoxy group, or an alkylamino group, X¹ is a group bonded via an oxygen atom, and a is 0 or 1. R¹¹ and Y¹ may be bonded to each other to form a 5- or 6-membered ring, or R¹⁶ and Y² may be bonded to each other to form a 5- or 6-membered ring.

With respect to a more preferred embodiment of the compound represented by General Formula (8), R¹² to R¹⁵ are each independently one in the preferred embodiment cited in the description of R⁵ to R⁸ in the compound represented by General Formula (M), R¹⁷ is one in the preferred embodiment cited in the description of R¹⁰ in General Formula (M), Ma is Zn, X² and X³ are each an oxygen atom, Y¹ is NH, Y² is a nitrogen atom, R¹¹ and R¹⁶ are each independently an alkyl group, an aryl group, a heterocyclic group, an alkoxy group, or an alkylamino group, X¹ is a group bonded via an oxygen atom, and a is 0 or 1. R¹¹ and Y¹ may be bonded to each other to form a 5- or 6-membered ring, or R¹⁶ and Y² may be bonded to each other to form a 5- or 6-membered ring.

From the viewpoint of coloring ability, the molar absorption coefficient of the dipyrromethene metal complex compound represented by General Formula (7) and General Formula (8) is preferably as high as possible. Further, from the viewpoint of improving color purity, the maximum absorption wavelength λmax is preferably 520 nm to 580 nm, and more preferably 530 nm to 570 nm. If the value is within this range, it is possible to manufacture a color filter having excellent color reproducibility by using the coloring composition of the present invention.

Furthermore, an absorbance at the maximum absorption wavelength (λmax) of the compound having a dye structure derived from a dipyrromethene dye is preferably 1,000 times or more, more preferably 10,000 times or more, and still more preferably 100,000 times or more the absorbance at 450 nm. If the ratio is within this range, particularly in the case where a blue color filter is manufactured using the coloring composition of the present invention, a color filter having a higher transmittance can be formed. Incidentally, the maximum absorption wavelength and the molar absorption coefficient are measured by a spectrophotometer Cary 5 (manufactured by Varian Medical Systems, Inc.).

From the viewpoint of solubility, it is preferable that the melting points of the dipyrromethene metal complex compounds represented by General Formula (7) and General Formula (8) are not too high.

The dipyrromethene metal complex compounds represented by General Formula (7) and General Formula (8) can be synthesized by the method described in U.S. Pat. No. 4,774,339A, U.S. Pat. No. 5,433,896A, JP2001-240761A, JP2002-155052A, JP3614586B, Aust. J. Chem., 1965, 11, 1835-1845, J. H. Boger, et al., Heteroatom Chemistry, Vol. 1, No. 5,389 (1990), and the like. Specifically, the method described in paragraphs “0131” to “0157” of JP2008-292970A can be applied.

Specific examples of the dipyrromethene dye are shown below, but the present invention is not limited thereto. X⁻ represents a counter anion (which shall apply hereinafter).

A compound obtained by substituting an arbitrary hydrogen atom of the dipyrromethene dye exemplified below with a reactive group capable of reacting with a polymer is preferably used as the compound having a dye structure of the present invention.

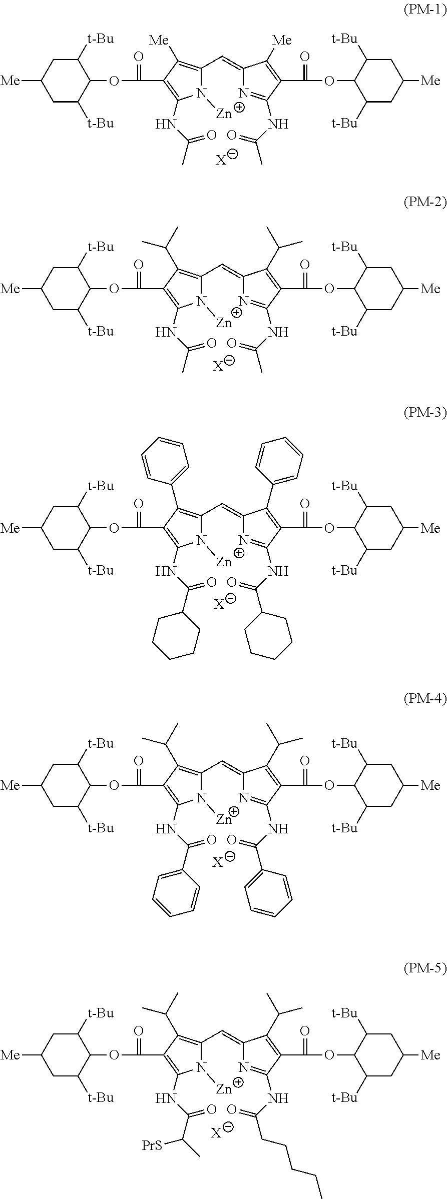

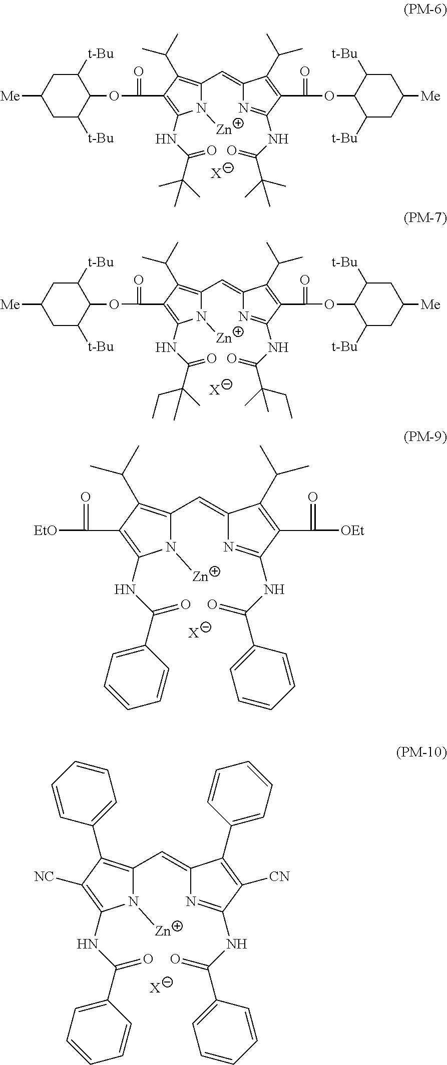

As a dipyrromethene dye having a reactive group capable of reacting with a polymer, specifically, a compound represented by the following General Formula (M-1) is preferable.

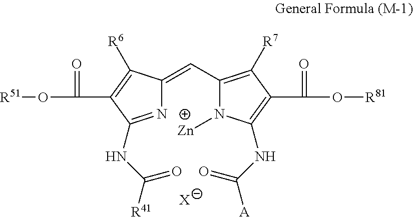

(In General Formula (M-1), R⁶, R⁷, R⁴¹, R⁵¹, and R⁸¹ each independently represent a hydrogen atom or a monovalent substituent, A represents a group having a reactive group, and X represents a counter anion.)

In the case where R⁶, R⁷, R⁴¹, R⁵¹ and R⁸¹ in General Formula (M-1) represent a monovalent substituent, examples of the monovalent substituent include the substituents exemplified in the section of the substituent group A which will be described later.

A in General Formula (M-1) represents a group having a reactive group. The reactive group is not particularly limited as long as it is capable of reacting with a reactive group contained in the polymer, and is preferably a group in which a terminal of the substituent exemplified in the section of the substituent group A which will be described later is bonded with a (meth)acryloyl group, a vinyl group, a vinyl ether group, an oxetanyl group, an oxylane group, an epoxy group, an amino group, a hydroxy group, a carboxy group, a halogen-acyl group, or the like is preferable, among which a group bonded with a hydroxy group, a carboxy group, a halogen acyl group, or an epoxy group is preferable.

X in General Formula (M-1) represents a counter anion. Examples of the counter anion represented by X include the counter anions which will be described later.

Specific examples of the dipyrromethene dye having a reactive group capable of reacting with a polymer are shown below, but the present invention is not limited thereto. X⁻ represents a counter anion (which shall apply hereinafter).

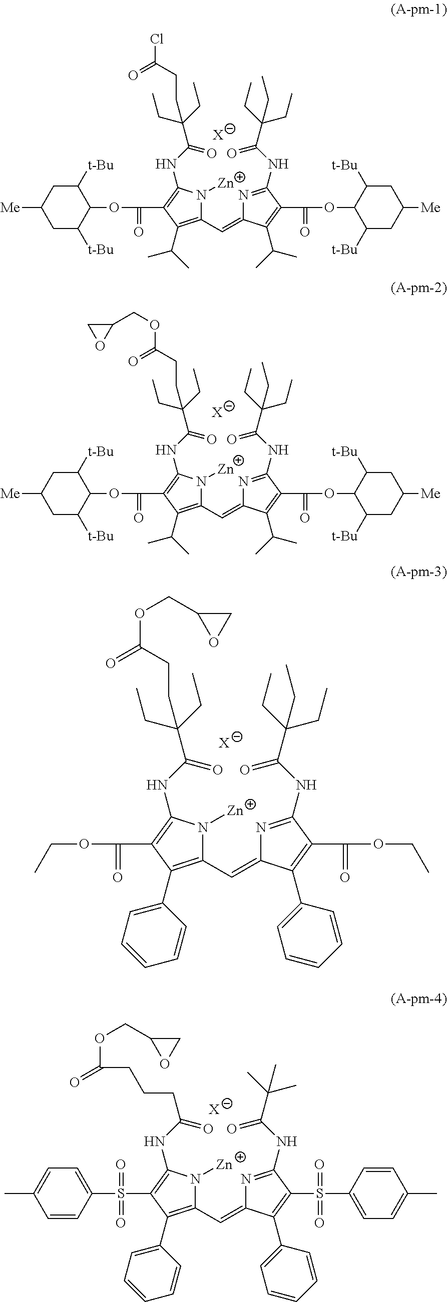

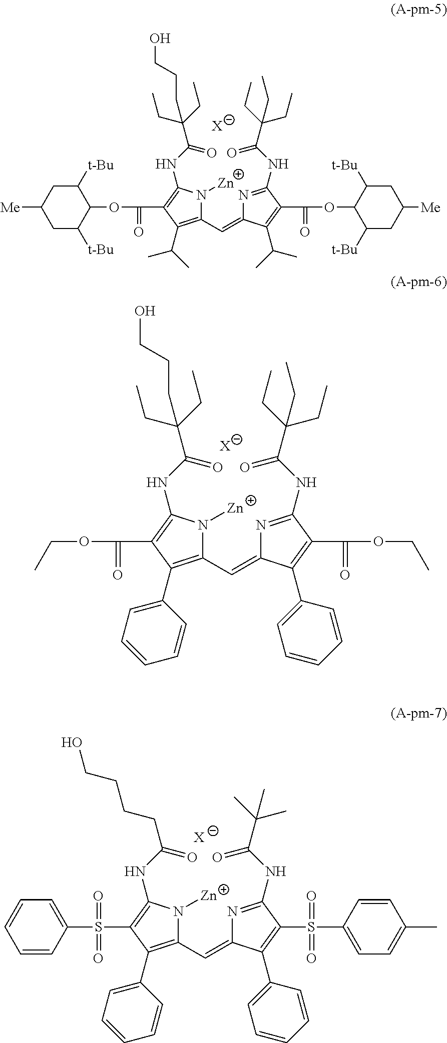

TABLE 1

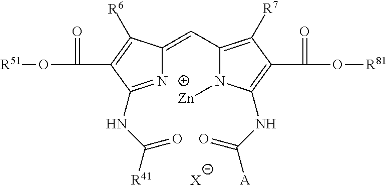

| Reactive | | | | | |
|---|---|---|---|---|---|
| group A | R⁶ | R⁷ | R⁵¹ | R⁸¹ | R⁴¹ |
| A-1 | i-Pr | i-Pr | COOMG | COOMG | t-Bu |
| A-2 | Ph | Ph | COOEt | COOEt | Ph |
| A-3 | Me | Me | COOMe | COOMe | Me |
| A-4 | Bu | Bu | SO₂Me | SO₂Me | C(Et)₃ |
| A-1 to | Bu | Bu | SO₂PhMe | SO₂PhMe | t-Bu, Ph, Me, |
| A-4 | | | | | or C(Et)₃ |
| A-1 to | i-Pr, Ph, | i-Pr, Ph, | CN | CN | t-Bu, Ph, Me, |
| A-4 | Me, or Bu | Me, or Bu | | | or C(Et)₃ |

A (reactive group)

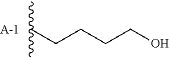

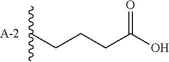

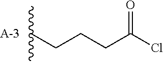

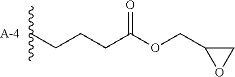

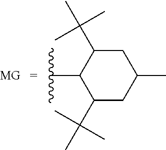 [SMILES: *C1C(C(C)(C)C)CC(C)CC1C(C)(C)C]

Triarylmethane Dye

One of the embodiments of the compound having a dye structure according to the present invention is one having a dye structure derived from a triarylmethane dye (triarylmethane compound). Examples of the compound having a dye structure include a compound which has a dye structure derived from a compound (triarylmethane compound) represented by the following General Formula (TP) as a dye structure of a dye moiety. The triarylmethane compounds in the present invention collectively refer to compounds having a dye moiety containing a triarylmethane skeleton in a molecule thereof.

General Formula (TP)

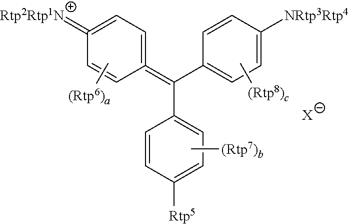

(In General Formula (TP), Rtp¹ to Rtp⁴ each independently represent a hydrogen atom, an alkyl group, or an aryl group. Rtp⁵ represents a hydrogen atom, an alkyl group, an aryl group, or NRtp⁹Rtp¹⁰ (in which Rtp⁹ and Rtp¹⁰ represent a hydrogen atom, an alkyl group, an aryl group, or a carbonyl group). Rtp⁶, Rtp⁷, and Rtp⁸ represent substituents. a, b, and c represent an integer of 0 to 4. In the case where a, b, and c are 2 or more, Rtp⁶, Rtp⁷, and Rtp⁸ may be linked to each other to form a ring. X⁻ represents an anion. At least one of Rtp¹ to Rtp¹⁰ has a reactive group capable of reacting with a polymer.)

Rtp¹ to Rtp⁶ are preferably a hydrogen atom, a linear or branched alkyl group having 1 to 5 carbon atoms, or a phenyl group. Rtp⁵ is preferably a hydrogen atom or NRtp⁹Rtp¹⁰, and particularly preferably NRtp⁹Rtp¹⁰. Rtp⁹ and Rtp¹⁰ are preferably a hydrogen atom, a linear or branched alkyl group having 1 to 5 carbon atoms, or a phenyl group. As the substituents represented by Rtp⁶, Rtp⁷, and Rtp⁸, the substituents exemplified in the section of the substituent group A which will be described later can be used. In particular, a linear or branched alkyl group having 1 to 5 carbon atoms, an alkenyl group having 1 to 5 carbon atoms, an aryl group having 6 to 15 carbon atoms, a carboxyl group, or a sulfo group is preferable, and a linear or branched alkyl group having 1 to 5 carbon atoms, an alkenyl group having 1 to 5 carbon atoms, a phenyl group, or a carboxyl group is more preferable. Rtp⁶ and Rtp⁸ are particularly preferably an alkyl group having 1 to 5 carbon atoms, and Rtp⁷ is preferably an alkenyl group (particularly preferably a phenyl group formed by linking two adjacent alkenyl groups to each other), a phenyl group, or a carboxyl group.

a, b, or c each independently represents an integer of 0 to 4. In particular, a and b are each preferably 0 or 1, and c is preferably an integer of 0 to 2.

Specific examples of the compounds represented by the following General Formula (TP) are shown below, but the present invention is not limited thereto. A compound obtained by substituting an arbitrary hydrogen atom of the compound represented by General Formula (TP) with a reactive group capable of reacting with a polymer is preferably used as the compound having a dye structure of the present invention.

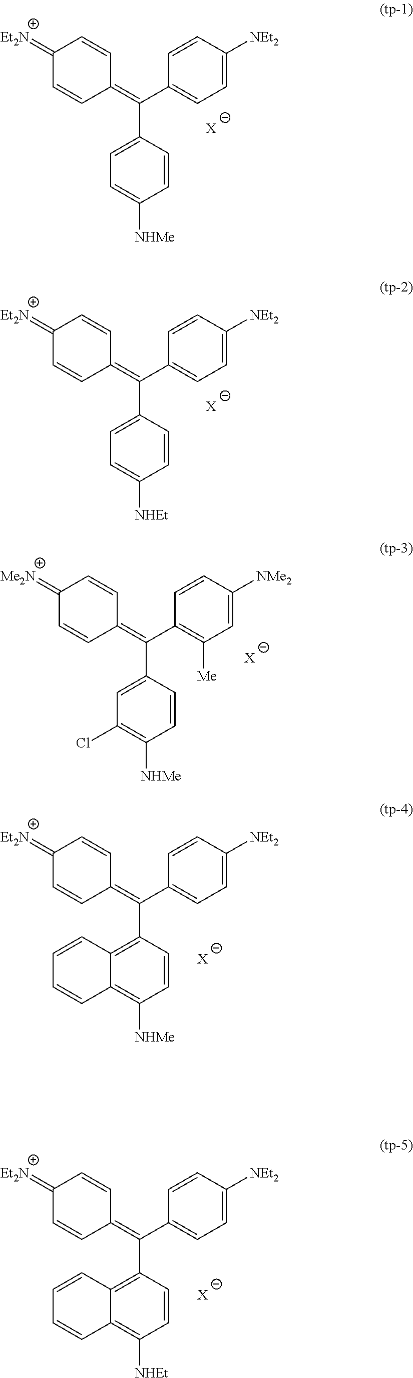

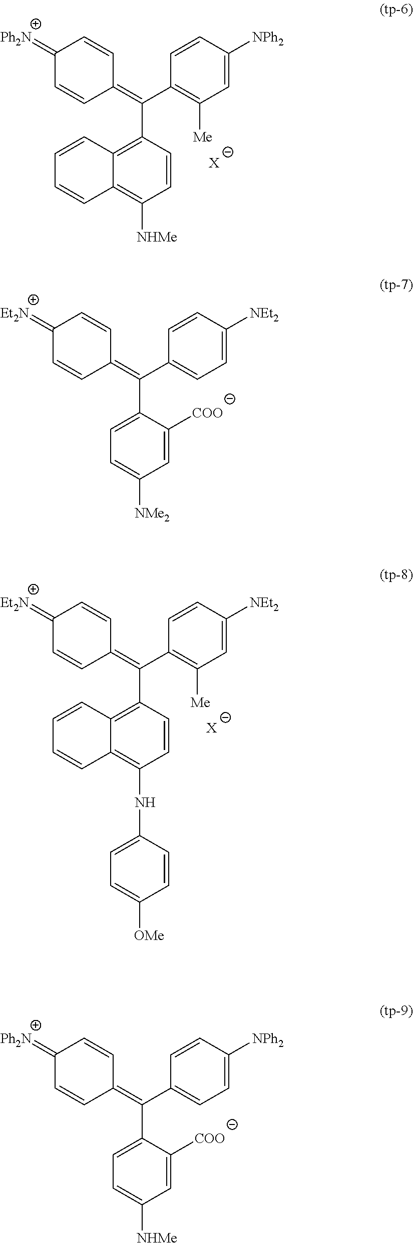

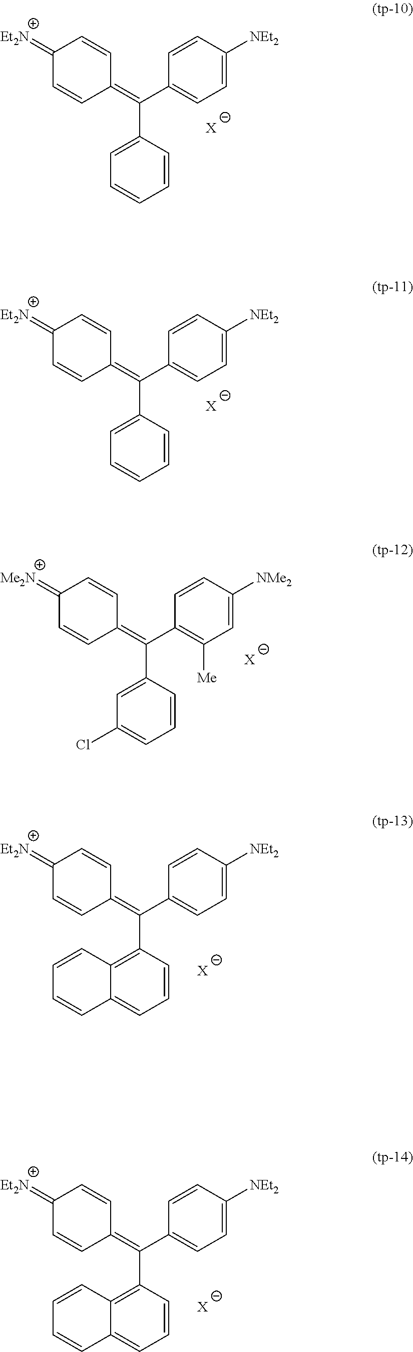

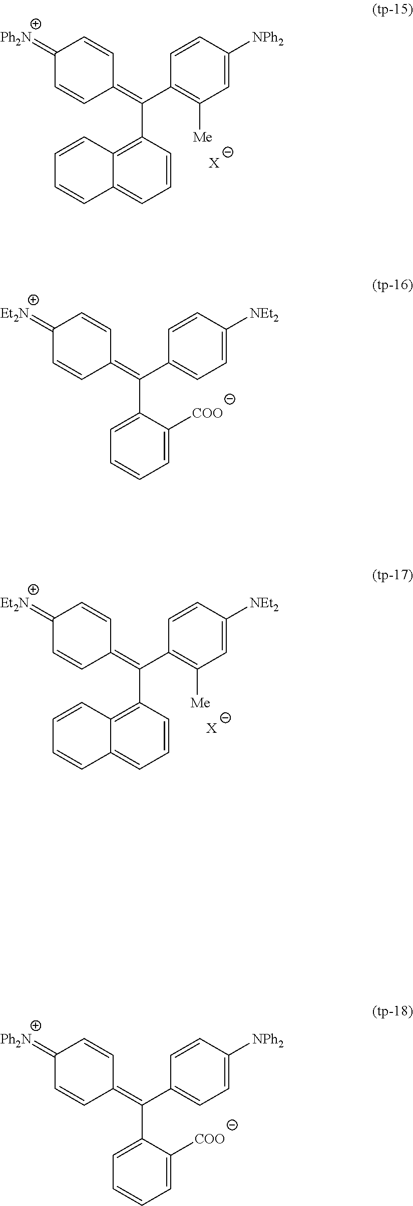

Among the specific examples, (tp-4), (tp-5), (tp-6), and (tp-8) are particularly preferable from the viewpoints of color characteristics and heat resistance.

As the triarylmethane dye having a reactive group capable of reacting with a polymer, specifically, a compound represented by any one of the following General Formulae (TP-1) to (TP-3) is preferable.

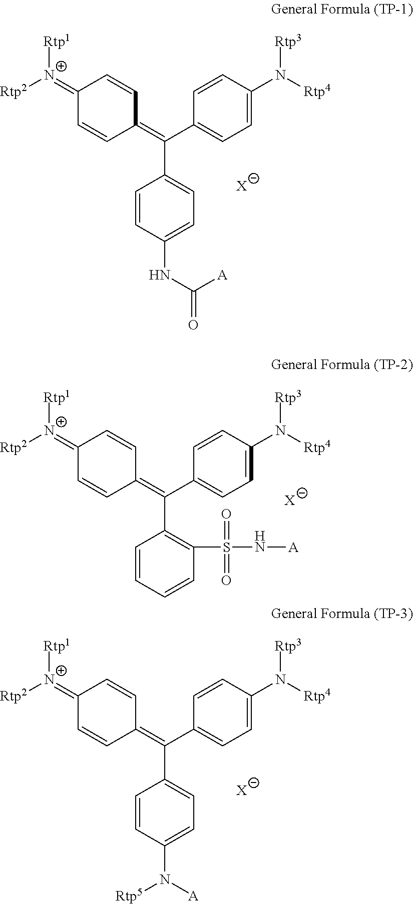

(In General Formulae (TP-1) to (TP-3), Rtp¹ to Rtp⁵ each independently represent a hydrogen atom, an alkyl group, or an aryl group, A represents a group having a reactive group, and X represents a counter anion.)

Rtp¹ to Rtp⁵ in General Formulae (TP-1) to (TP-3) have the same definitions as Rtp¹ to Rtp⁴ in General Formula (TP), and preferred ranges thereof are also the same.

A in General Formulae (TP-1) to (TP-3) represents a group having a reactive group and has the same definition as A in General Formula (M-1), and a preferred range thereof is also the same.

X in General Formulae (TP-1) to (TP-3) represents a counter anion and has the same definition as X in General Formula (M-1), and a preferred range thereof is also the same.

Specific examples of the triarylmethane dye having a reactive group capable of reacting with a polymer are shown below, but the present invention is not limited thereto.

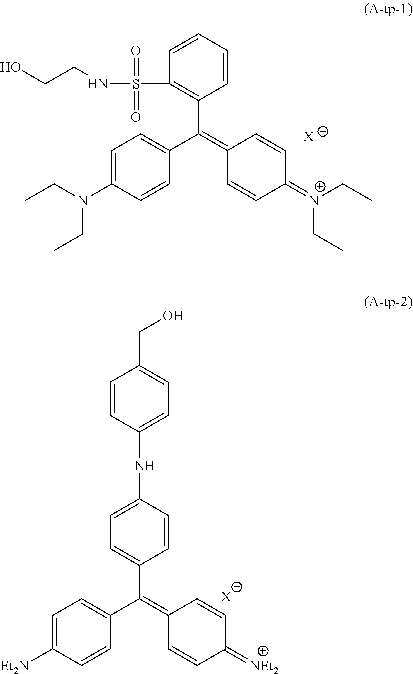

TABLE 2

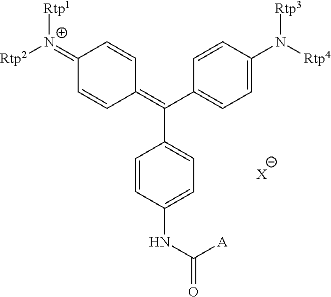

| Reactive | | | | |
|---|---|---|---|---|
| group A | Rtp¹ | Rtp² | Rtp³ | Rtp⁴ |
| A-1 | Me | Me | Me | Me |
| A-2 | Et | Et | Et | Et |
| A-3 | Ph | Ph | Ph | Ph |
| A-4 | Me, Et, or Ph | Me, Et, or Ph | Me, Et, or Ph | Me, Et, or Ph |

A (reactive group)

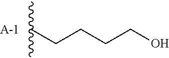

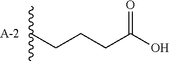

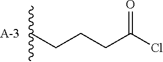

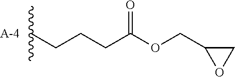

TABLE 3

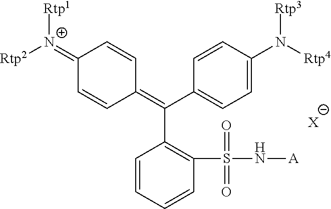

| Reactive | | | | |
|---|---|---|---|---|
| group A | Rtp¹ | Rtp² | Rtp³ | Rtp⁴ |
| A-1 | Me | Me | Me | Me |
| A-2 | Et | Et | Et | Et |
| A-3 | Ph | Ph | Ph | Ph |
| A-4 | Me, Et, or Ph | Me, Et, or Ph | Me, Et, or Ph | Me, Et, or Ph |

A (reactive group)

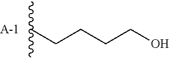

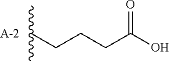

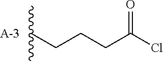

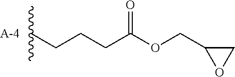

Xanthene Dye

A preferred embodiment of the compound having a dye structure in the present invention is one having a dye structure derived from a xanthene dye (xanthene compound). The xanthene dye may be present as a separate molecule in which a cation (cation moiety) and an anion are not bonded via a covalent bond, or may be a so-called intramolecular salt type which includes a cation and an anion in the same molecule.

Examples of the compound having a dye structure include a compound having a dye structure derived from a xanthene compound represented by the following General Formula (J).

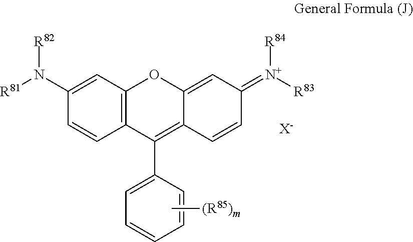

(In General Formula (J), R⁸¹, R⁸², R⁸³, and R⁸⁴ each independently represent a hydrogen atom or a monovalent substituent. R⁸⁵'s each independently represent a monovalent substituent, and m represents an integer of 0 to 5. X⁻ represents a counter anion. At least one of R⁸¹ to R⁸⁵ has a reactive group capable of reacting with a polymer.)

The substituents which R⁸¹ to R⁸⁴ and R⁸⁵ in General Formula (J) can contain are the same as the substituents exemplified in the section of the substituent group A which will be described later.

In General Formula (J), R⁸¹ and R⁸², R⁸³ and R⁸⁴, and R⁸⁵'s in a case where m is 2 or more may be bonded to each other to form a 5-, 6-, or 7-membered saturated ring or a 5-, 6-, or 7-membered unsaturated ring. In the case where the formed 5-, 6-, or 7-membered ring is a group which can be further substituted, the ring may be substituted with the substituents described for R⁸¹ to R⁸⁵. In the case where the ring is substituted with two or more substituents, these substituents may be the same as or different from each other.

In General Formula (J), in the case where R⁸¹ and R⁸², R⁸³ and R⁸⁴, and R⁸⁵'s in a case where m is 2 or more are bonded to each other to form 5-, 6-, and 7-membered saturated rings not having a substituent or form 5-, 6-, and 7-membered unsaturated rings, examples of the 5-, 6-, and 7-membered saturated rings not having a substituent or the 5-, 6-, and 7-membered unsaturated rings include a pyrrole ring, a furan ring, a thiophene ring, a pyrazole ring, an imidazole ring, a triazole ring, an oxazole ring, a thiazole ring, a pyrrolidine ring, a piperidine ring, a cyclopentene ring, a cyclohexene ring, a benzene ring, a pyridine ring, a pyrazine ring, and a pyridazine ring, and preferably a benzene ring and a pyridine ring.

In particular, R⁸² and R⁸³ are preferably a hydrogen atom or a substituted or unsubstituted alkyl group, and R⁸¹ and R⁸⁴ are preferably a substituted or unsubstituted alkyl group or phenyl group. Further, R⁸⁵ is preferably a halogen atom, a linear or branched alkyl group having 1 to 5 carbon atoms, a sulfo group, a sulfonamide group, a carboxyl group, or an amide group, and more preferably a sulfo group, a sulfonamide group, a carboxyl group, or an amide group. R⁸⁵ is preferably bonded to an adjacent portion of carbon linked to a xanthene ring. The substituent which the phenyl group represented by R⁸¹ and R⁸⁴ has is most preferably a hydrogen atom, a halogen atom, a linear or branched alkyl group having 1 to 5 carbon atoms, a sulfo group, a sulfonamide group, or a carboxyl group.

The compounds having xanthene skeletons represented by General Formula (J) may be synthesized using methods disclosed in the literature. Specifically, the methods disclosed in Tetrahedron Letters, 2003, vol. 44, No. 23, pp. 4355 to 4360; Tetrahedron Letters, 2005, vol. 61, No. 12, pp. 3097 to 3106; and the like can be applied.

In a dye structure derived from a xanthene compound represented by General Formula (J), cations are non-localized, and thus, are present on a nitrogen atom, or a carbon atom of a xanthene ring. This shall be the same as for the xanthene compound which will described later.

As the dye structure derived from a xanthene compound, one represented by the following General Formula (J1) is also preferable.

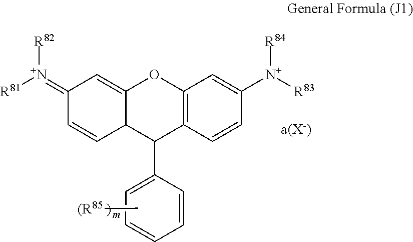

In General Formula (J1), R⁸¹, R⁸², R⁸³ and R⁸⁴ each independently represent a hydrogen atom or a monovalent substituent, R⁸⁵'s each independently represent a monovalent substituent, and m represents an integer of 0 to 5. a represents 0 or 1, and in the case where a represents 0, any one group in the dye structure contains an anion. X⁻ represents a counter anion. At least one of R⁸¹ to R⁸⁵ has a reactive group capable of reacting with a polymer.

In General Formula (J1), R⁸¹ to R⁸⁵ and m have the same definitions as R⁸¹ to R⁸⁵ and m in General Formula (J), and preferred ranges thereof are also the same.

In the case where a in General Formula (J1) represents 1, examples of X⁻ in General Formula (J1) include the counter anions described in the section of the counter anion which will be described later.

In the case where a in General Formula (J1) represents 0, any one group in the dye structure contains an anion, it is preferable that any one of R⁸¹ to R⁸⁵ contains an anion, and it is more preferable that R⁸⁵ contains an anion. As the anion in the case where a in General Formula (J1) represents 0, a non-nucleophilic anion is preferable. For example, —SO₃⁻, —COO⁻, —PO₄⁻, a group including a structure represented by the following General Formula (A1) or a group including a structure represented by the following General Formula (A2) is preferable, and a group including the structure represented by General Formula (A1) is more preferable.

General Formula (A1)

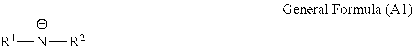

In General Formula (A1), R¹ and R² each independently represent —SO₂— or —CO—.

In General Formula (A1), it is preferable that at least one of R¹ and R² represents —SO₂—, and it is preferable that both of R¹ and R² represent —SO₂—.

In a group including structure represented by General Formula (A1), it is preferable that a group having a reactive group or a fluorine-substituted alkyl group is bonded to the terminal of R¹ or R².

The group having a reactive group has the same definition as the group having a reactive group in General Formula (M-1). The reactive group may be directly bonded to R¹ or R², and may be bonded to R¹ or R² via a linking group. In the case where the reactive group is bonded to R¹ or R² via a linking group, the linking group is preferably a fluorine-substituted alkylene group, a fluorine-substituted arylene group, —SO₂—, —S—, —O—, —CO—, an alkylene group, an arylene group, or a group formed by a combination thereof. The number of carbon atoms of the fluorine-substituted alkylene group is preferably 1 to 10, more preferably 1 to 6, and still more preferably 1 to 3. The fluorine-substituted alkylene group is preferably a perfluoroalkylene group. The number of carbon atoms of the fluorine-substituted arylene group is preferably 6 to 12, and more preferably 6 to 8. The fluorine-substituted arylene group is preferably a perfluoroarylene group.

The number of carbon atoms of the fluorine-substituted alkyl group is preferably 1 to 10, more preferably 1 to 6, and still more preferably 1 to 3. The fluorine-substituted alkyl group is preferably a perfluoroalkyl group.

General Formula (A2)

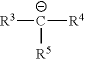

In General Formula (A2), R³ represents —SO₂— or —CO—, and R⁴ and R⁵ each independently represent —SO₂—, —CO—, or —CN.

In General Formula (A2), it is preferable that at least one of R³ to R⁵ represents —SO₂—, and it is preferable that two of R³ to R⁵ represent —SO₂—.

In a group including structure represented by General Formula (A2) in the case where R³ to R⁵ represent —SO₂— or —CO—, it is preferable that a group having a reactive group or a fluorine-substituted alkyl group is bonded to its terminal.

The group having a reactive group has the same definition as the group having a reactive group, which is described in General Formula (A1), and preferred ranges thereof are also the same. The fluorine-substituted alkyl group has the same definition as the fluorine-substituted alkyl group described in General Formula (A1), and a preferred range thereof is also the same.

Specific examples of the xanthene compounds are shown below, but the present invention is not limited thereto. Further, a compound obtained by substituting an arbitrary hydrogen atom of the xanthene compound exemplified below with a reactive group capable of reacting with a polymer is preferably used as the compound having a dye structure of the present invention.

TABLE 4

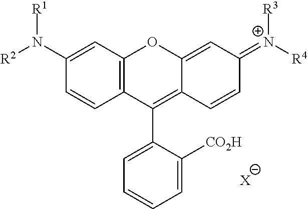

| No. | R¹ | R² | R³ | R⁴ |
|---|---|---|---|---|
| (XT-1) | Me | Me | Me | Me |
| (XT-2) | Et | Et | Et | Et |
| (XT-3) | n-Pr | n-Pr | n-Pr | n-Pr |
| (XT-4) | i-Pr | i-Pr | i-Pr | i-Pr |
| (XT-5) | n-Bu | n-Bu | n-Bu | n-Bu |
| (XT-6) | sec-Bu | sec-Bu | sec-Bu | sec-Bu |
| (XT-7) | i-Bu | i-Bu | i-Bu | i-Bu |
| (XT-8) | tert-Bu | tert-Bu | tert-Bu | tert-Bu |
| (XT-9) | n-C₆H₁₃ | n-C₆H₁₃ | n-C₆H₁₃ | n-C₆H₁₃ |
| (XT-10) | n-C₁₈H₃₇ | n-C₁₈H₃₇ | n-C₁₈H₃₇ | n-C₁₈H₃₇ |
| (XT-11) | Me | Et | Me | Et |
| (XT-12) | —CH₂CH₂OCH₂CH₂— | | —CH₂CH₂OCH₂CH₂— | |
| (XT-13) | —(CH₂)₅— | | —(CH₂)₅— | |
| (XT-14) | —(CH₂)₄— | | —(CH₂)₄— | |
| (XT-15) | —(CH₂)₅— | | —(CH₂)₄— | |
| (XT-16) | CH₂Ph | CH₂Ph | CH₂Ph | CH₂Ph |
| (XT-17) | Et | CH₂CH₂OMe | Et | CH₂CH₂OMe |
| (XT-18) | Me | cyclo-C₆H₁₁ | Me | cyclo-C₆H₁₁ |
| (XT-19) | CH₂C≡CH | CH₂C≡CH | CH₂C≡CH | CH₂C≡CH |
| (XT-20) | CH₂CH═CH₂ | CH₂CH═CH₂ | CH₂CH═CH₂ | CH₂CH═CH₂ |
| (XT-21) | Me | H | Me | H |
| (XT-22) | Et | H | Et | H |
| (XT-23) | n-Pr | H | n-Pr | H |
| (XT-24) | i-Pr | H | i-Pr | H |
| (XT-25) | n-Bu | H | n-Bu | H |
| (XT-26) | H | H | H | H |
| (XT-27) | i-Bu | H | i-Bu | H |
| (XT-28) | tert-Bu | H | tert-Bu | H |
| (XT-29) | n-C₆H₁₃ | H | n-C₆H₁₃ | H |
| (XT-30) | n-C₁₈H₃₇ | H | n-C₁₀H₃₇ | H |
| (XT-31) | Ph | H | Ph | H |
| (XT-32) | CH₂Ph | H | CH₂Ph | H |
| (XT-33) | cyclo-C₆H₁₁ | H | cyclo-C₆H₁₁ | H |
| (XT-34) | cyclo-C₅H₉ | H | cyclo-C₅H₉ | H |
| (XT-35) | CH₂C≡CH | H | CH₂C≡CH | H |
| (XT-36) | CH₂CH═CH₂ | H | CH₂CH═CH₂ | H |
| (XT-37) | 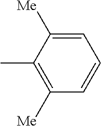 | H | 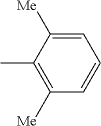 | H |
| (XT-38) | 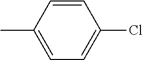 | H | 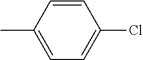 | H |

TABLE 5

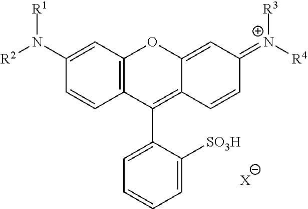

| No. | R¹ | R² | R³ | R⁴ |
|---|---|---|---|---|
| (XT-39) | Me | Me | Me | Me |
| (XT-40) | Et | Et | Et | Et |
| (XT-41) | n-Pr | n-Pr | n-Pr | n-Pr |
| (XT-42) | i-Pr | i-Pr | i-Pr | i-Pr |
| (XT-43) | n-Bu | n-Bu | n-Bu | n-Bu |
| (XT-44) | sec-Bu | sec-Bu | sec-Bu | sec-Bu |
| (XT-45) | i-Bu | i-Bu | i-Bu | i-Bu |
| (XT-46) | tert-Bu | tert-Bu | tert-Bu | tert-Bu |
| (XT-47) | n-C₆H₁₃ | n-C₆H₁₃ | n-C₆H₁₃ | n-C₆H₁₃ |
| (XT-48) | n-C₁₈H₃₇ | n-C₁₈H₃₇ | n-C₁₈H₃₇ | n-C₁₈H₃₇ |
| (XT-49) | Me | Et | Me | Et |
| (XT-50) | —CH₂CH₂OCH₂CH₂— | | —CH₂CH₂OCH₂CH₂— | |
| (XT-51) | —(CH₂)₅— | | —(CH₂)₅— | |
| (XT-52) | —(CH₂)₄— | | —(CH₂)₄— | |
| (XT-53) | —(CH₂)₅— | | —(CH₂)₄— | |
| (XT-54) | CH₂Ph | CH₂Ph | CH₂Ph | CH₂Ph |
| (XT-55) | Et | CH₂CH₂OMe | Et | CH₂CH₂OMe |
| (XT-56) | Me | cyclo-C₆H₁₁ | Me | cyclo-C₆H₁₁ |
| (XT-57) | CH₂C≡CH | CH₂C≡CH | CH₂C≡CH | CH₂C≡CH |
| (XT-58) | CH₂CH═CH₂ | CH₂CH═CH₂ | CH₂CH═CH₂ | CH₂CH═CH₂ |
| (XT-59) | Me | H | Me | H |
| (XT-60) | Et | H | Et | H |
| (XT-61) | n-Pr | H | n-Pr | H |
| (XT-62) | i-Pr | H | i-Pr | H |
| (XT-63) | H | H | H | H |
| (XT-64) | sec-Bu | H | sec-Bu | H |
| (XT-65) | i-Bu | H | i-Bu | H |
| (XT-66) | tert-Bu | H | tert-Bu | H |
| (XT-67) | n-C₆H₁₃ | H | n-C₆H₁₃ | H |
| (XT-68) | n-C₁₈H₃₇ | H | n-C₁₈H₃₇ | H |
| (XT-69) | Ph | H | Ph | H |
| (XT-70) | CH₂Ph | H | CH₂Ph | H |
| (XT-71) | cyclo-C₆H₁₁ | H | cyclo-C₆H₁₁ | H |
| (XT-72) | cyclo-C₅H₉ | H | cyclo-C₅H₉ | H |
| (XT-73) | CH₂C≡CH | H | CH₂C≡CH | H |
| (XT-74) | CH₂CH═CH₂ | H | CH₂CH═CH₂ | H |
| (XT-75) | 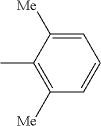 | H | 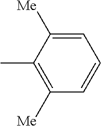 | H |
| (XT-76) | 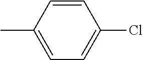 | H | 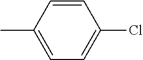 | H |

As the xanthene compound having a reactive group capable of reacting with a polymer, specifically, a compound represented by either of the following General Formulae (J-1) and (J-2) is preferable.

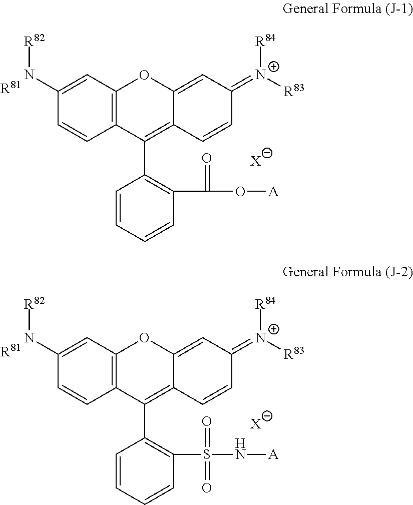

(In General Formulae (J-1) and (J-2), R⁸¹ to R⁸⁵ each independently represent a hydrogen atom or a monovalent substituent, A represents a group having a reactive group, and X represents a counter anion.)

R⁸¹ to R⁸⁵ in General Formulae (J-1) and (J-2) have the same definitions as R⁸¹ to R⁸⁴ in General Formula (J), and preferred ranges thereof are also the same.

A in General Formulae (J-1) and (J-2) represents a group having a reactive group and has the same definition as A in General Formula (M-1), and a preferred range thereof is also the same.

X in General Formulae (J-1) and (J-2) represents a counter anion and has the same definition as X in General Formula (M-1), and a preferred range thereof is also the same.

Specific examples of the xanthene compound having a reactive group capable of reacting with a polymer are shown below, but the present invention is not limited thereto.

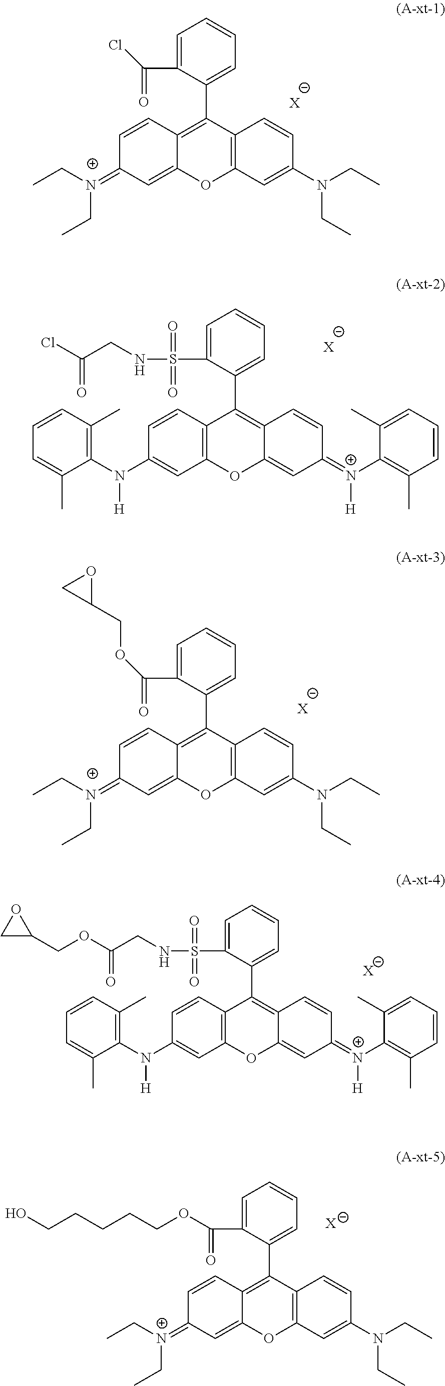

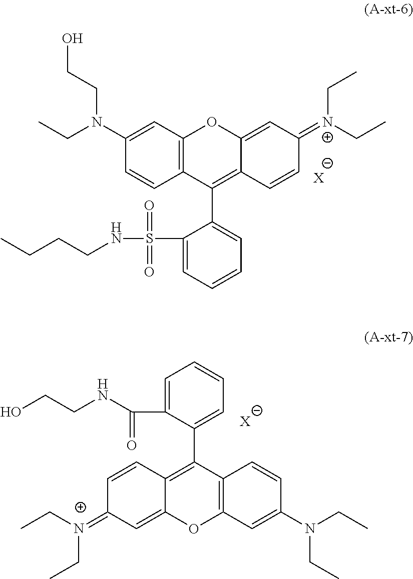

TABLE 6

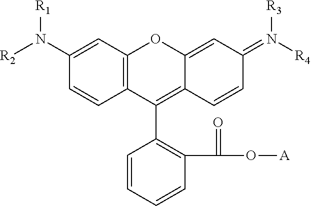

| No. | R¹ | R² | R³ | R⁴ |
|---|---|---|---|---|
| (XT-1) | Me | Me | Me | Me |
| (XT-2) | Et | Et | Et | Et |
| (XT-3) | n-Pr | n-Pr | n-Pr | n-Pr |
| (XT-4) | i-Pr | i-Pr | i-Pr | i-Pr |
| (XT-5) | n-Bu | n-Bu | n-Bu | n-Bu |
| (XT-6) | sec-Bu | sec-Bu | sec-Bu | sec-Bu |
| (XT-7) | i-Bu | i-Bu | i-Bu | i-Bu |
| (XT-8) | tert-Bu | tert-Bu | tert-Bu | tert-Bu |
| (XT-9) | n-C₆H₁₃ | n-C₆H₁₃ | n-C₆H₁₃ | n-C₆H₁₃ |
| (XT-10) | n-C₁₈H₃₇ | n-C₁₈H₃₇ | n-C₁₈H₃₇ | n-C₁₈H₃₇ |
| (XT-11) | Me | Et | Me | Et |
| (XT-12) | —CH₂CH₂OCH₂CH₂— | | —CH₂CH₂OCH₂CH₂— | |
| (XT-13) | —(CH₂)₅— | | —(CH₂)₅— | |
| (XT-14) | —(CH₂)₄— | | —(CH₂)₄— | |
| (XT-15) | —(CH₂)₅— | | —(CH₂)₄— | |
| (XT-16) | CH₂Ph | CH₂Ph | CH₂Ph | CH₂Ph |
| (XT-17) | Et | CH₂CH₂OMe | Et | CH₂CH₂OMe |
| (XT-18) | Me | cyclo-C₆H₁₁ | Me | cyclo-C₆H₁₁ |
| (XT-19) | CH₂C≡CH | CH₂C≡CH | CH₂C≡CH | CH₂C≡CH |
| (XT-20) | CH₂CH═CH₂ | CH₂CH═CH₂ | CH₂CH═CH₂ | CH₂CH═CH₂ |
| (XT-21) | Me | H | Me | H |
| (XT-22) | Et | H | Et | H |
| (XT-23) | n-Pr | H | n-Pr | H |
| (XT-24) | i-Pr | H | i-Pr | H |
| (XT-25) | n-Bu | H | n-Bu | H |
| (XT-26) | H | H | H | H |
| (XT-27) | i-Bu | H | i-Bu | H |
| (XT-28) | tert-Bu | H | tert-Bu | H |
| (XT-29) | n-C₆H₁₃ | H | n-C₆H₁₃ | H |
| (XT-30) | n-C₁₈H₃₇ | H | n-C₁₈H₃₇ | H |
| (XT-31) | Ph | H | Ph | H |
| (XT-32) | CH₂Ph | H | CH₂Ph | H |
| (XT-33) | cyclo-C₆H₁₁ | H | cyclo-C₆H₁₁ | H |
| (XT-34) | cyclo-C₅H₉ | H | cyclo-C₅H₉ | H |
| (XT-35) | CH₂C≡CH | H | CH₂C≡CH | H |
| (XT-36) | CH₂CH═CH₂ | H | CH₂CH═CH₂ | H |
| (XT-37) | 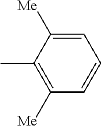 | H | 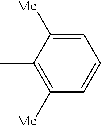 | H |
| (XT-38) | 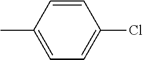 | H | 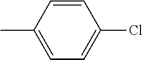 | H |

A (reactive group)

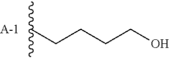

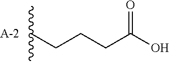

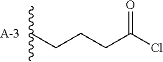

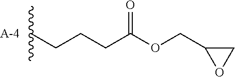

The reactive group A is any one of reactive groups A-1 to A-4.

TABLE 7

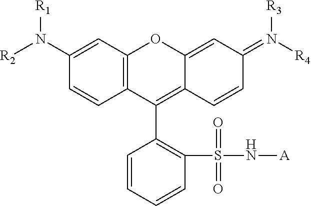

| No. | R¹ | R² | R³ | R⁴ |
|---|---|---|---|---|
| (XT-1) | Me | Me | Me | Me |
| (XT-2) | Et | Et | Et | Et |
| (XT-3) | n-Pr | n-Pr | n-Pr | n-Pr |
| (XT-4) | i-Pr | i-Pr | i-Pr | i-Pr |
| (XT-5) | n-Bu | n-Bu | n-Bu | n-Bu |
| (XT-6) | sec-Bu | sec-Bu | sec-Bu | sec-Bu |
| (XT-7) | i-Bu | i-Bu | i-Bu | i-Bu |
| (XT-8) | tert-Bu | tert-Bu | tert-Bu | tert-Bu |
| (XT-9) | n-C₆H₁₃ | n-C₆H₁₃ | n-C₆H₁₃ | n-C₆H₁₃ |
| (XT-10) | n-C₁₈H₃₇ | n-C₁₈H₃₇ | n-C₁₈H₃₇ | n-C₁₈H₃₇ |
| (XT-11) | Me | Et | Me | Et |
| (XT-12) | —CH₂CH₂OCH₂CH₂— | | —CH₂CH₂OCH₂CH₂— | |
| (XT-13) | —(CH₂)₅— | | —(CH₂)₅— | |
| (XT-14) | —(CH₂)₄— | | —(CH₂)₄— | |
| (XT-15) | —(CH₂)₅— | | —(CH₂)₄— | |
| (XT-16) | CH₂Ph | CH₂Ph | CH₂Ph | CH₂Ph |
| (XT-17) | Et | CH₂CH₂OMe | Et | CH₂CH₂OMe |
| (XT-18) | Me | cyclo-C₆H₁₁ | Me | cyclo-C₆H₁₁ |
| (XT-19) | CH₂C≡CH | CH₂C≡CH | CH₂C≡CH | CH₂C≡CH |
| (XT-20) | CH₂CH═CH₂ | CH₂CH═CH₂ | CH₂CH═CH₂ | CH₂CH═CH₂ |
| (XT-21) | Me | H | Me | H |
| (XT-22) | Et | H | Et | H |
| (XT-23) | n-Pr | H | n-Pr | H |
| (XT-24) | i-Pr | H | i-Pr | H |
| (XT-25) | n-Bu | H | n-Bu | H |
| (XT-26) | H | H | H | H |
| (XT-27) | i-Bu | H | i-Bu | H |
| (XT-28) | tert-Bu | H | tert-Bu | H |
| (XT-29) | n-C₆H₁₃ | H | n-C₆H₁₃ | H |
| (XT-30) | n-C₁₈H₃₇ | H | n-C₁₈H₃₇ | H |
| (XT-31) | Ph | H | Ph | H |
| (XT-32) | CH₂Ph | H | CH₂Ph | H |
| (XT-33) | cyclo-C₆H₁₁ | H | cyclo-C₆H₁₁ | H |
| (XT-34) | cyclo-C₅H₉ | H | cyclo-C₅H₉ | H |
| (XT-35) | CH₂C≡CH | H | CH₂C≡CH | H |
| (XT-36) | CH₂CH═CH₂ | H | CH₂CH═CH₂ | H |
| (XT-37) | 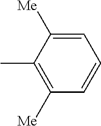 | H | 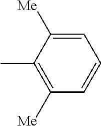 | H |
| (XT-38) | 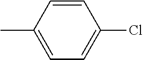 | H | 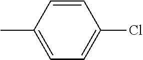 | H |

A (reactive group)

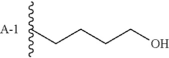

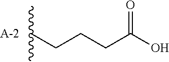

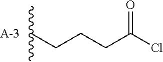

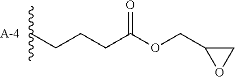

The reactive group A is any one of reactive groups A-1 to A-4.

TABLE 8

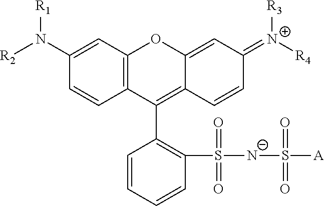

| No. | R¹ | R² | R³ | R⁴ |
|---|---|---|---|---|
| (XT-1) | Me | Me | Me | Me |
| (XT-2) | Et | Et | Et | Et |
| (XT-3) | n-Pr | n-Pr | n-Pr | n-Pr |
| (XT-4) | i-Pr | i-Pr | i-Pr | i-Pr |
| (XT-5) | n-Bu | n-Bu | n-Bu | n-Bu |
| (XT-6) | sec-Bu | sec-Bu | sec-Bu | sec-Bu |
| (XT-7) | i-Bu | i-Bu | i-Bu | i-Bu |
| (XT-8) | tert-Bu | tert-Bu | tert-Bu | tert-Bu |
| (XT-9) | n-C₆H₁₃ | n-C₆H₁₃ | n-C₆H₁₃ | n-C₆H₁₃ |
| (XT-10) | n-C₁₈H₃₇ | n-C₁₈H₃₇ | n-C₁₈H₃₇ | n-C₁₈H₃₇ |
| (XT-11) | Me | Et | Me | Et |
| (XT-12) | —CH₂CH₂OCH₂CH₂— | | —CH₂CH₂OCH₂CH₂— | |
| (XT-13) | —(CH₂)₅— | | —(CH₂)₅— | |
| (XT-14) | —(CH₂)₄— | | —(CH₂)₄— | |
| (XT-15) | —(CH₂)₅— | | —(CH₂)₄— | |
| (XT-16) | CH₂Ph | CH₂Ph | CH₂Ph | CH₂Ph |
| (XT-17) | Et | CH₂CH₂OMe | Et | CH₂CH₂OMe |
| (XT-18) | Me | cyclo-C₆H₁₁ | Me | cyclo-C₆H₁₁ |
| (XT-19) | CH₂C≡CH | CH₂C≡CH | CH₂C≡CH | CH₂C≡CH |
| (XT-20) | CH₂CH═CH₂ | CH₂CH═CH₂ | CH₂CH═CH₂ | CH₂CH═CH₂ |
| (XT-21) | Me | H | Me | H |
| (XT-22) | Et | H | Et | H |
| (XT-23) | n-Pr | H | n-Pr | H |
| (XT-24) | i-Pr | H | i-Pr | H |
| (XT-25) | n-Bu | H | n-Bu | H |
| (XT-26) | H | H | H | H |
| (XT-27) | i-Bu | H | i-Bu | H |
| (XT-28) | tert-Bu | H | tert-Bu | H |
| (XT-29) | n-C₆H₁₃ | H | n-C₆H₁₃ | H |
| (XT-30) | n-C₁₈H₃₇ | H | n-C₁₈H₃₇ | H |
| (XT-31) | Ph | H | Ph | H |
| (XT-32) | CH₂Ph | H | CH₂Ph | H |
| (XT-33) | cyclo-C₆H₁₁ | H | cyclo-C₆H₁₁ | H |
| (XT-34) | cyclo-C₅H₉ | H | cyclo-C₅H₉ | H |
| (XT-35) | CH₂C≡CH | H | CH₂C≡CH | H |
| (XT-36) | CH₂CH═CH₂ | H | CH₂CH═CH₂ | H |
| (XT-37) | 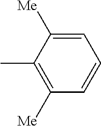 | H | 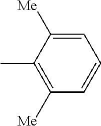 | H |
| (XT-38) | 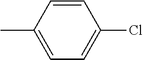 | H | 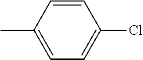 | H |

A (reactive group)

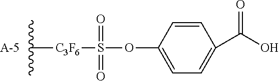

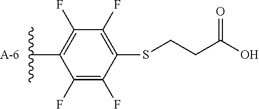

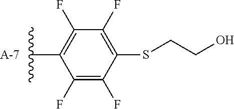

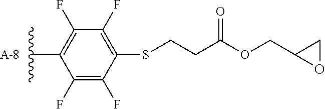

The reactive group A is any one of reactive groups A-5 to A-8.

Cyanine Dye

One of the embodiments of the compound having a dye structure according to the present invention is one having a dye structure derived from a cyanine dye (cyanine compound). Examples of the compound having a dye structure include a compound which has a dye structure derived from a compound (cyanine compound) represented by the following General Formula (PM). The cyanine compounds in the present invention collectively refer to compounds having a dye moiety containing a cyanine skeleton in a molecule thereof

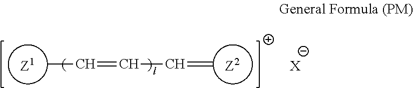

(In General Formula (PM), a ring Z¹ and a ring Z² each independently represent a heterocycle which may have a substituent, with at least one having a substituent having a reactive group capable of reacting with a polymer. 1 represents an integer of 0 to 3 and X⁻ represents an anion.)

Examples of the ring Z¹ and the ring Z² each independently include oxazole, benzoxazole, oxazoline, thiazole, thiazoline, benzothiazole, indolenine, benzoindolenine, and 1,3-thiadiazine.

The substituents which the ring Z¹ and the ring Z² may have are the same substituents exemplified in the section of the substituent group A which will be described later. X⁻represents a counter anion.

The compound represented by General Formula (PM) is preferably a compound represented by the following General Formula (PM-2).

General Formula (PM-2)

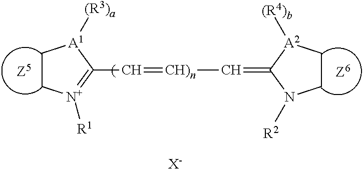

(In General Formula (PM-2), the ring Z⁵ and the ring Z⁶ each independently represent a benzene ring which may have a substituent or a naphthalene ring which may have a substituent. X⁻ represents a counter anion. At least one of R¹ to R¹⁴ has a reactive group capable of reacting with a polymer.)

n represents an integer of 0 to 3.

A¹ and A² each independently represent an oxygen atom, a sulfur atom, a selenium atom, a carbon atom, or a nitrogen atom.

R¹ and R² each independently represent a monovalent aliphatic hydrocarbon group having 1 to 20 carbon atoms which may have a substituent.

R³ and R⁴ each independently represent a hydrogen atom, a monovalent aliphatic hydrocarbon group having 1 to 6 carbon atoms, or a divalent aliphatic hydrocarbon group having 2 to 6 carbon atoms, which is formed when one R³ and one R⁴ are combined with each other.

a and b each independently represent an integer of 0 to 2.

Specific examples of the cyanine compounds are shown below, but the present invention is not limited thereto. Further, a compound obtained by substituting an arbitrary hydrogen atom of the cyanine compound exemplified below with a reactive group capable of reacting with a polymer is preferably used as the compound having a dye structure of the present invention.

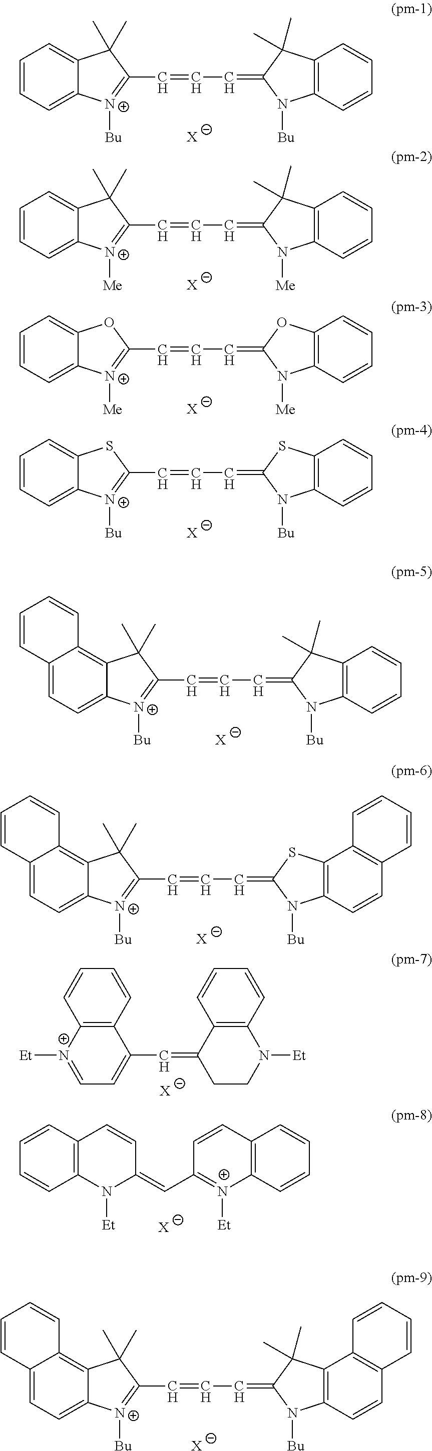

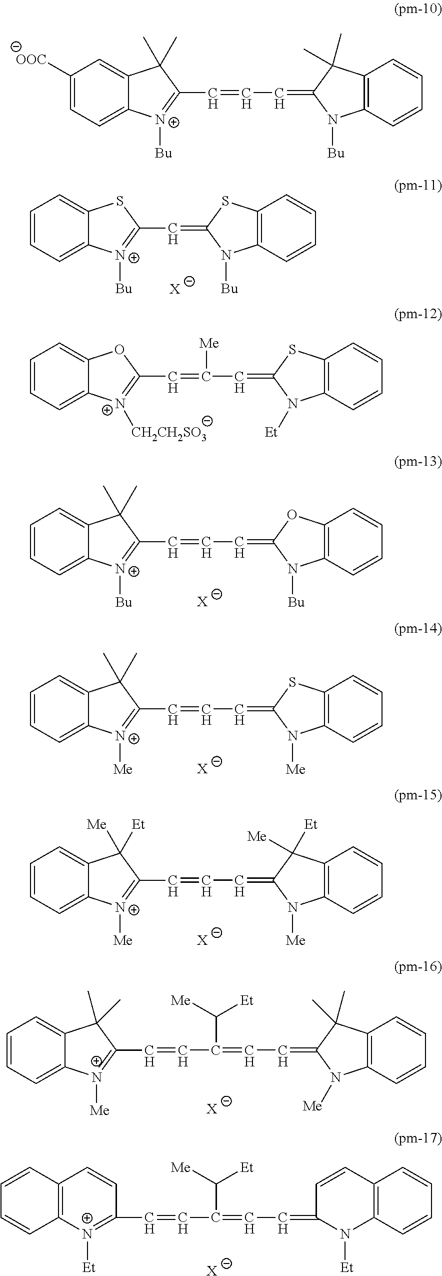

Among the specific examples, the structures represented by (pm-1) to (pm-6), (pm-9), and (pm-10) are preferable, and among these, the dye structures represented by (pm-1), (pm-2), and (pm-10) are particularly preferable from the viewpoint of color characteristics and heat resistance.

As the cyanine compound having a reactive group capable of reacting with a polymer, specifically, compounds represented by any one of the following General Formulae (PM-3) to (PM-6) are preferable.

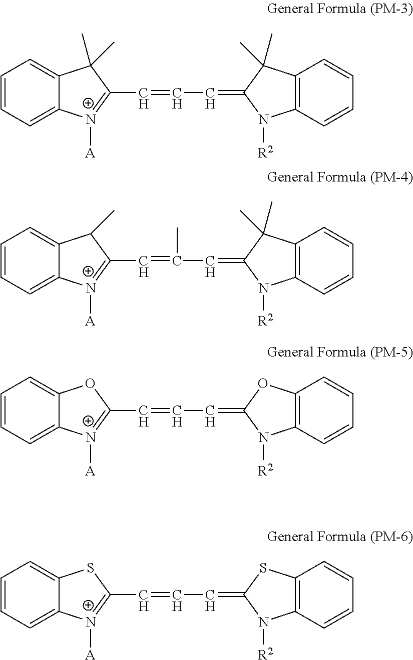

(In General Formulae (PM-3) to (PM-6), R² represents a monovalent aliphatic hydrocarbon group having 1 to 20 carbon atoms, which may have a substituent, A represents a group having a reactive group, and X represents a counter anion.)

R² in General Formulae (PM-3) to (PM-6) has the same definition as R² in General Formula (PM-2), and a preferred range thereof is also the same.

A in General Formulae (PM-3) to (PM-6) represents a group having a reactive group and has the same definition as A in General Formula (M-1), and a preferred range thereof is also the same.

X in General Formulae (PM-3) to (PM-6) represents a counter anion and has the same definition as X in General Formula (M-1), and a preferred range thereof is also the same.

Specific examples of the cyanine dye having a reactive group capable of reacting with a polymer are shown below, but the present invention is not limited thereto.

TABLE 9

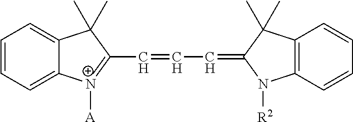

| Reactive group A | R² |
|---|---|
| A-1 | Me |
| A-2 | Et |
| A-3 | Bu |
| A-4 | Me, Et, or Bu |

A (reactive group)

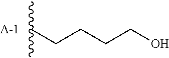

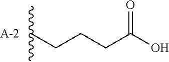

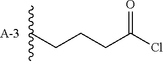

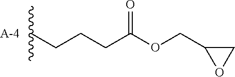

TABLE 10

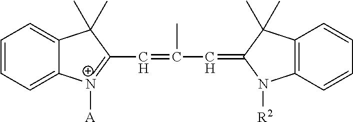

| Reactive group A | R² |
|---|---|
| A-1 | Me |
| A-2 | Et |
| A-3 | Bu |
| A-4 | Me, Et, or Bu |

A (reactive group)

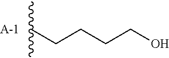

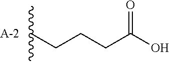

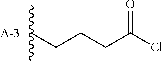

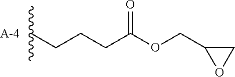

TABLE 11

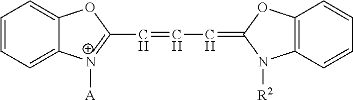

| Reactive group A | R² |
|---|---|
| A-1 | Me |
| A-2 | Et |
| A-3 | Bu |
| A-4 | Me, Et, or Bu |

A (reactive group)

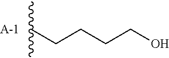

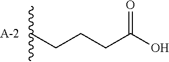

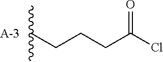

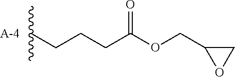

TABLE 12

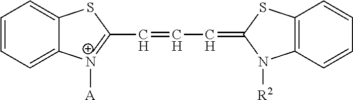

| Reactive group A | R² |
|---|---|
| A-1 | Me |
| A-2 | Et |
| A-3 | Bu |
| A-4 | Me, Et, or Bu |

A (reactive group)

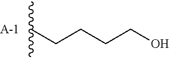

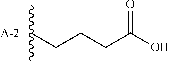

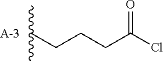

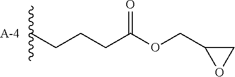

Subphthalocyanine Compound

One of the embodiments of the compound having a dye structure according to the present invention is one having a dye structure derived from a subphthalocyanine dye (phthalocyanine compound). Examples of the said compound having a dye structure include a said compound having a dye structure derived from a compound (subphthalocyanine compound) represented by the following General Formula (SP). The subphthalocyanine dyes in the present invention collectively refer to compounds having a dye moiety including a subphthalocyanine skeleton in a molecule thereof. In the present invention, it is preferable that the following compound forms a cationic structure, and for example, it is preferable that a boron atom in General Formula (SP) forms a cationic structure.

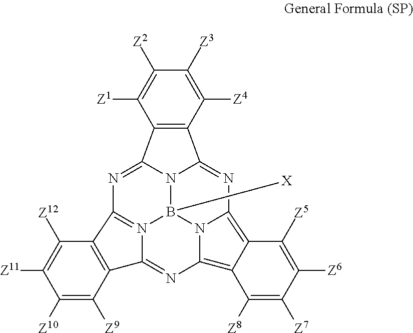

(In General Formula (SP), Z¹ to Z¹² each independently represent a hydrogen atom, an alkyl group, an aryl group, a hydroxyl group, a mercapto group, an amino group, an alkoxy group, an aryloxy group, or a thioether group. X represents a counter anion. At least one of Z¹ to Z¹² has a reactive group capable of reacting with a polymer.)

General Formula (SP) will be described in detail.

The alkyl group which Z¹ to Z¹² in General Formula (SP) may have represents a linear or branched substituted or unsubstituted alkyl group. In particular, Z¹ to Z¹² preferably have 1 to 20 carbon atoms, and more preferably have 1 to 10 carbon atoms. Examples of the substituents which Z¹ to Z¹² may have include the substituents exemplified in the section of the substituent group A which will be described later, and among those, a fluorine atom, a hydroxyl group, and a mercapto group are particularly preferable.

Specific examples of the subphthalocyanine compound are shown below, but the present invention is not limited thereto. Further, a compound obtained by substituting an arbitrary hydrogen atom of the subphthalocyanine compound exemplified below with a reactive group capable of reacting with a polymer is preferably used as the compound having a dye structure of the present invention.

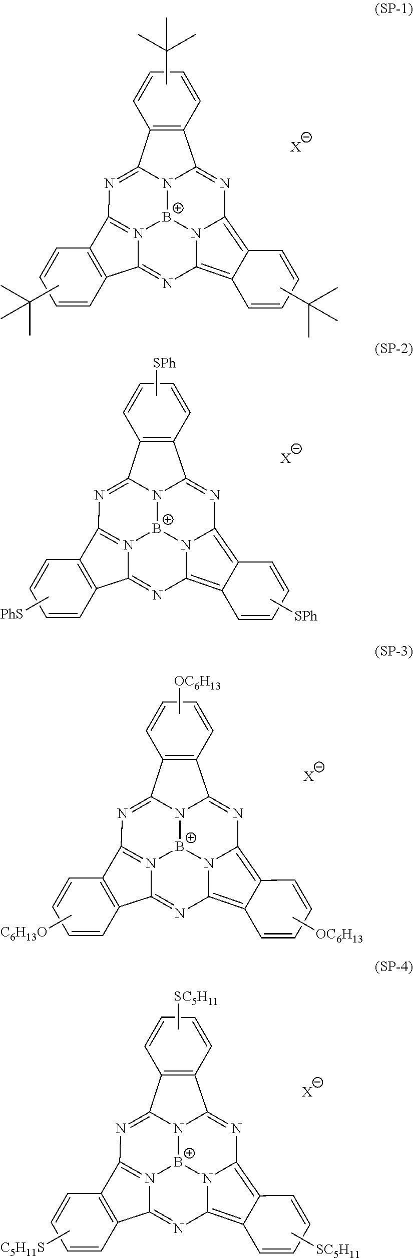

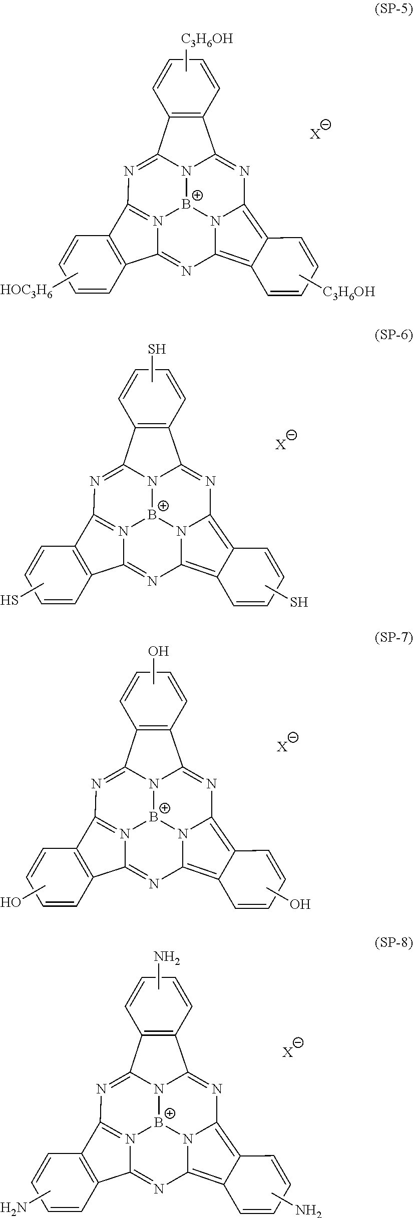

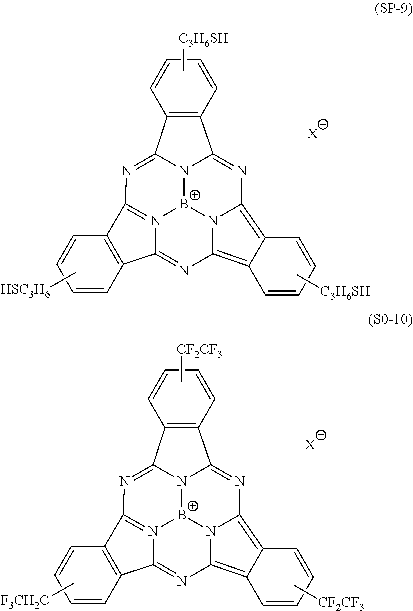

Among the specific examples, (SP-2), (SP-3), (SP-4), (SP-5), (SP-6), and (SP-7) are particularly preferable from the viewpoint of color characteristics and heat resistance.

As the subphthalocyanine compound having a reactive group capable of reacting with a polymer, specifically, a compound represented by the following General Formula (SP′) is preferable.

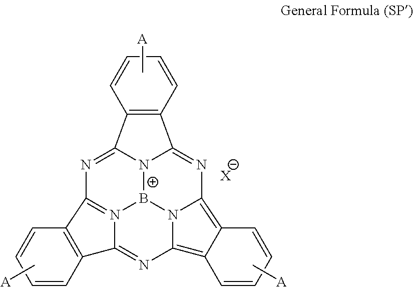

(In General Formula (SP′), A represents a group having a reactive group, and X represents a counter anion.)

A in General Formula (SP′) represents a group having a reactive group and has the same definition as A in General Formula (M-1), and a preferred range thereof is also the same.

X in General Formula (SP′) represents a counter anion and has the same definition as X in General Formula (M-1), and a preferred range thereof is also the same.

Specific examples of the subphthalocyanine compound having a reactive group capable of reacting with a polymer are shown below, but the present invention is not limited thereto.

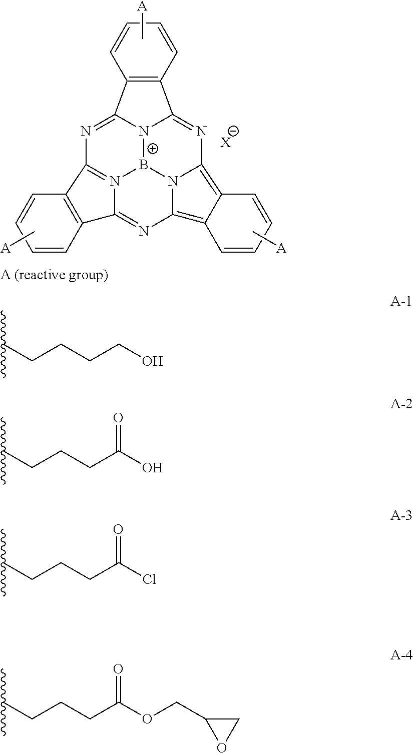

For the compound having a dye structure according to the present invention, a hydrogen atom in the dye structure may be substituted with a substituent selected from the following substituent group A.

Substituent Group A

Examples of the substituent which the dye multimer may have include a halogen atom, an alkyl group, a cycloalkyl group, an alkenyl group, a cycloalkenyl group, an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an amino group (including an alkylamino group and an anilino group), an acylamino group, an aminocarbonylamino group, an alkoxycarbonylamino group, an aryloxycarbonylamino group, a sulfamoylamino group, an alkylsulfonylamino or arylsulfonylamino group, a mercapto group, an alkylthio group, an arylthio group, a heterocyclic thio group, a sulfamoyl group, a sulfo group, an alkylsulfinyl or arylsulfinyl group, an alkylsulfonyl or arylsulfonyl group, an acyl group, an aryloxycarbonyl group, an alkoxycarbonyl group, a carbamoyl group, an arylazo or heterocyclic azo group, an imide group, a phosphino group, a phosphinyl group, a phosphinyloxy group, a phosphinylamino group, and a silyl group. These will be described in detail below.

Examples of the substituent include a halogen atom (for example, a fluorine atom, a chlorine atom, a bromine atom, and an iodine atom), a linear or branched alkyl group (a linear or branched substituted or unsubstituted alkyl group, and preferably an alkyl group having 1 to 30 carbon atoms, for example, methyl, ethyl, n-propyl, isopropyl, tert-butyl, n-octyl, 2-chloroethyl, 2-cyanoethyl, and 2-ethylhexyl), a cycloalkyl group (preferably a substituted or unsubstituted cycloalkyl group having 3 to 30 carbon atoms, for example, cyclohexyl and cyclopentyl, or a polycycloalkyl group, for example, a group having a polycyclic structure such as a bicycloalkyl group (preferably a substituted or unsubstituted bicycloalkyl group having 5 to 30 carbon atoms, for example, bicyclo[1,2,2]heptan-2-yl and bicyclo[2,2,2]octan-3-yl), and a tricycloalkyl group. Among these, a monocyclic cycloalkyl group and a bicycloalkyl group are preferable, and a monocyclic cycloalkyl group is particularly preferable),

a linear or branched alkenyl group (a linear or branched substituted or unsubstituted alkenyl group, which is preferably an alkenyl group having 2 to 30 carbon atoms, for example, vinyl, allyl, prenyl, geranyl, and oleyl), a cycloalkenyl group (preferably a substituted or unsubstituted cycloalkenyl group having 3 to 30 carbon atoms, for example, 2-cyclopenten-1-yl and 2-cyclohexen-1-yl, a polycyclic alkenyl group, for example, a bicycloalkenyl group (which is preferably a substituted or unsubstituted bicycloalkenyl group having 5 to 30 carbon atoms, for example, bicyclo[2,2,1]hepto-2-en-1-yl and bicyclo[2,2,2]octo-2-en-4-yl), or a tricycloalkenyl group. Among these, a monocyclic cycloalkenyl group is particularly preferable), an alkynyl group (preferably a substituted or unsubstituted alkynyl group having 2 to 30 carbon atoms, for example, an ethynyl group, a propargyl group, and a trimethylsilylethynyl group),

an aryl group (preferably a substituted or unsubstituted aryl group having 6 to 30 carbon atoms, for example, phenyl, p-tolyl, naphthyl, m-chlorophenyl, and o-hexadecanoylaminophenyl), a heterocyclic group (preferably a substituted or unsubstituted, saturated or unsaturated, aromatic or non-aromatic, and monocyclic or ring-fused 5- to 7-membered heterocyclic group, more preferably a heterocyclic group of which ring-constituting atoms are selected from a carbon atom, a nitrogen atom, and a sulfur atom, and which has at least any one of hetero atoms including a nitrogen atom, an oxygen atom, and a sulfur atom, and still more preferably a 5- or 6-membered aromatic heterocyclic group having 3 to 30 carbon atoms, for example, 2-furyl, 2-thienyl, 2-pyridyl, 4-pyridyl, 2-pyrimidinyl, and 2-benzothiazolyl), a cyano group, a hydroxyl group, a nitro group, a carboxyl group,

an alkoxy group (preferably a substituted or unsubstituted alkoxy group having 1 to 30 carbon atoms, for example, methoxy, ethoxy, isopropoxy, tert-butoxy, n-octyloxy, and 2-methoxyethoxy), an aryloxy group (preferably a substituted or unsubstituted aryloxy group having 6 to 30 carbon atoms, for example, phenoxy, 2-methylphenoxy, 2,4-di-tert-amylphenoxy, 4-tert-butylphenoxy, 3-nitrophenoxy, and 2-tetradecanoylaminophenoxy), a silyloxy group (preferably a silyloxy group having 3 to 20 carbon atoms, for example, trimethylsilyloxy and tert-butyldimethylsilyloxy), a heterocyclic oxy group (preferably a substituted or unsubstituted heterocyclic oxy group having 2 to 30 carbon atoms, in which a heterocyclic moiety is preferably the heterocyclic moiety explained for the aforementioned heterocyclic group, the heterocyclic oxy group is, for example, 1-phenyltetrazol-5-oxy or 2-tetrahydropyranyloxy),

an acyloxy group (preferably a formyloxy group, a substituted or unsubstituted alkylcarbonyloxy group having 2 to 30 carbon atoms, and a substituted or unsubstituted arylcarbonyloxy group having 6 to 30 carbon atoms, for example, formyloxy, acetyloxy, pivaloyloxy, stearoyloxy, benzoyloxy, and p-methoxyphenylcarbonyloxy), a carbamoyloxy group (preferably a substituted or unsubstituted carbamoyloxy group having 1 to 30 carbon atoms, for example, N,N-dimethylcarbamoyloxy, N,N-diethylcarbamoyloxy, morpholinocarbonyloxy, N,N-di-n-octylaminocarbonyloxy, and N-n-octylcarbamoyloxy), an alkoxycarbonyloxy group (preferably a substituted or unsubstituted alkoxycarbonyloxy group having 2 to 30 carbon atoms, for example, methoxycarbonyloxy, ethoxycarbonyloxy, tert-butoxycarbonyloxy, and n-octylcarbonyloxy), an aryloxycarbonyloxy group (preferably a substituted or unsubstituted aryloxycarbonyloxy group having 7 to 30 carbon atoms, for example, phenoxycarbonyloxy, p-methoxyphenoxycarbonyloxy, and p-n-hexadecyloxyphenoxycarbonyloxy),

an amino group (preferably an amino group, a substituted or unsubstituted alkylamino group having 1 to 30 carbon atoms, a substituted or unsubstituted arylamino group having 6 to 30 carbon atoms, and a heterocyclic amino group having 0 to 30 carbon atoms, for example, amino, methylamino, dimethylamino, anilino, N-methyl-anilino, diphenylamino, and N-1,3,5-triazin-2-ylamino), an acylamino group (preferably a formylamino group, a substituted or unsubstituted alkylcarbonylamino group having 1 to 30 carbon atoms, and a substituted or unsubstituted arylcarbonylamino group having 6 to 30 carbon atoms, for example, formylamino, acetylamino, pivaloylamino, lauroylamino, benzoylamino, and 3,4,5-tri-n-octyloxyphenyl carbonylamino), an aminocarbonylamino group (preferably a substituted or unsubstituted aminocarbonylamino group having 1 to 30 carbon atoms, for example, carbamoylamino, N,N-dimethylaminocarbonylamino, N,N-diethylaminocarbonylamino, and morpholinocarbonylamino), an alkoxycarbonylamino group (preferably a substituted or unsubstituted alkoxycarbonylamino group having 2 to 30 carbon atoms, for example, methoxycarbonylamino, ethoxycarbonylamino, tert-butoxycarbonylamino, n-octadecyloxycarbonylamino, and N-methyl-methoxycarbonylamino),

an aryloxycarbonylamino group (preferably a substituted or unsubstituted aryloxycarbonylamino group having 7 to 30 carbon atoms, for example, phenoxycarbonylamino, p-chlorophenoxycarbonylamino, and m-n-octyloxyphenoxycarbonylamino), a sulfamoylamino group (preferably a substituted or unsubstituted sulfamoylamino group having 0 to 30 carbon atoms, for example, sulfamoylamino, N,N-dimethylaminosulfonylamino, and N-n-octylaminosulfonylamino), an alkylsulfonylamino or arylsulfonylamino group (preferably a substituted or unsubstituted alkylsulfonylamino group having 1 to 30 carbon atoms, or a substituted or unsubstituted arylsulfonylamino group having 6 to 30 carbon atoms, for example, methylsulfonylamino, butylsulfonylamino, phenylsulfonylamino, 2,3,5-trichlorophenylsulfonylamino, and p-methylphenylsulfonylamino), a mercapto group,

an alkylthio group (preferably a substituted or unsubstituted alkylthio group having 1 to 30 carbon atoms, for example, methylthio, ethylthio, and n-hexadecylthio), an arylthio group (preferably a substituted or unsubstituted arylthio group having 6 to 30 carbon atoms, for example, phenylthio, p-chlorophenylthio, and m-methoxyphenylthio), a heterocyclic thio group (preferably a substituted or unsubstituted heterocyclic thio group having 2 to 30 carbon atoms, in which a heterocyclic moiety is preferably the heterocyclic moiety explained for the aforementioned heterocyclic group, for example, 2-benzothiazolylthio and 1-phenyltetrazol-5-ylthio), a sulfamoyl group (preferably a substituted or unsubstituted sulfamoyl group having 0 to 30 carbon atoms, for example, N-ethylsulfamoyl, N-(3-dodecyloxypropyl)sulfamoyl, N,N-dimethylsulfamoyl, N-acetylsulfamoyl, N-benzoylsulfamoyl, and N—(N′-phenylcarbamoyl)sulfamoyl), a sulfo group,

an alkylsulfinyl or arylsulfinyl group (preferably a substituted or unsubstituted alkylsulfinyl group having 1 to 30 carbon atoms or a substituted or unsubstituted arylsulfinyl group having 6 to 30 carbon atoms, for example, methylsulfinyl, ethylsulfinyl, phenylsulfinyl, and p-methylphenylsulfinyl), an alkylsulfonyl or arylsulfonyl group (preferably a substituted or unsubstituted alkylsulfonyl group having 1 to 30 carbon atoms or a substituted or unsubstituted arylsulfonyl group having 6 to 30 carbon atoms, for example, methylsulfonyl, ethylsulfonyl, phenylsulfonyl, and p-methylphenylsulfonyl), an acyl group (preferably a formyl group, a substituted or unsubstituted alkyl carbonyl group having 2 to 30 carbon atoms, or a substituted or unsubstituted arylcarbonyl group having 7 to 30 carbon atoms, for example, acetyl, pivaloyl, 2-chloroacetyl, stearoyl, benzoyl, and p-n-octyloxyphenylcarbonyl), an aryloxycarbonyl group (preferably a substituted or unsubstituted aryloxycarbonyl group having 7 to 30 carbon atoms, for example, phenoxycarbonyl, o-chlorophenoxycarbonyl, m-nitrophenoxycarbonyl, and p-tert-butylphenoxycarbonyl),

an alkoxycarbonyl group (preferably a substituted or unsubstituted alkoxycarbonyl group having 2 to 30 carbon atoms, for example, methoxycarbonyl, ethoxycarbonyl, tert-butoxycarbonyl, and n-octadecyloxycarbonyl), a carbamoyl group (preferably substituted or unsubstituted carbamoyl having 1 to 30 carbon atoms, for example, carbamoyl, N-methylcarbamoyl, N,N-dimethylcarbamoyl, N,N-di-n-octylcarbamoyl, and N-(methylsulfonyl)carbamoyl), an arylazo or heterocyclic azo group (preferably a substituted or unsubstituted arylazo group having 6 to 30 carbon atoms, or a substituted or unsubstituted heterocyclic azo group having 3 to 30 carbon atoms (in which a heterocyclic moiety is preferably the heterocyclic moiety explained for the aforementioned heterocyclic group), for example, phenylazo, p-chlorophenylazo, and 5-ethylthio-1,3,4-thiadiazol-2-ylazo), an imide group (preferably a substituted or unsubstituted imide group having 2 to 30 carbon atoms, for example, N-succinimide and N-phthalimide), a phosphino group (preferably a substituted or unsubstituted phosphino group having 2 to 30 carbon atoms, for example, dimethylphosphino, diphenylphosphino, and methylphenoxyphosphino), a phosphinyl group (preferably a substituted or unsubstituted phosphinyl group having 2 to 30 carbon atoms, for example, phosphinyl, dioctyloxyphosphinyl, and diethoxyphosphinyl),

a phosphinyloxy group (preferably a substituted or unsubstituted phosphinyloxy group having 2 to 30 carbon atoms, for example, diphenoxyphosphinyloxy and dioctyloxyphosphinyloxy), a phosphinylamino group (preferably a substituted or unsubstituted phosphinylamino group having 2 to 30 carbon atoms, for example, dimethoxyphosphinylamino and dimethylaminophosphinylamino), and a silyl group (preferably a substituted or unsubstituted silyl group having 3 to 30 carbon atoms, for example, trimethylsilyl, tert-butyldimethylsilyl, and phenyldimethylsilyl).

Among the above functional groups, in the functional groups having hydrogen atoms, the portion of hydrogen atoms in the functional groups may be substituted with any one of the above groups. Examples of the functional groups which can be introduced as substituents include an alkylcarbonylaminosulfonyl group, an arylcarbonylaminosulfonyl group, an alkylsulfonylaminocarbonyl group, and an arylsulfonylaminocarbonyl group, and specific examples thereof include methylsulfonylaminocarbonyl, p-methylphenylsulfonylaminocarbonyl, acetylaminosulfonyl, and benzoylaminosulfonyl.

<<<Counter Anion>>>

The counter anion in the present invention is not particularly limited, but is preferably a non-nucleophilic anion from the viewpoint of further improving heat resistance. Examples of the non-nucleophilic counter anion include known non-nucleophilic anions described in “0075” of JP2007-310315A, and the like. Preferable examples thereof include a sulfonic acid anion, a carboxylic acid anion, sulfonylimide anion, a bis(alkylsulfonyl)imide anion, a tris(alkylsulfonyl)methide anion, a tetraarylborate anion, —CON⁻CO—, —CON⁻SO₂—, BF₄⁻, SbF₆⁻, and B⁻(CN)₃OMe. The non-nucleophilic counter anion is particularly preferably a sulfonic acid anion, a sulfonylimide anion, a bis(alkylsulfonyl)imide anion, a tris(alkylsulfonyl), a methide anion, a carboxylic acid anion, a tetraarylborate anion, BF₄⁻, PF₆⁻, or SbF₆⁻.

Among these, as the counter anion, non-nucleophilic anions having structures represented by the following (AN-1) to (AN-5) are more preferable.

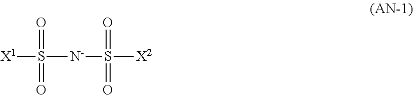

(In Formula (AN-1), X¹ and X² each independently represent a fluorine atom or an alkyl group having 1 to 10 carbon atoms, having a fluorine atom, or X¹ and X² may be bonded to each other to form a ring.)

X¹ and X² are each independently preferably a perfluoroalkyl group having 1 to 10 carbon atoms, and more preferably a perfluoroalkyl group having 1 to 4 carbon atoms.

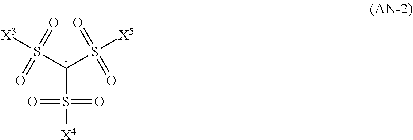

(In Formula (AN-2), X³, X⁴, and X⁵ each independently represent a fluorine atom or an alkyl group having 1 to 10 carbon atoms, having a fluorine atom.)

X³, X⁴, and X⁵ are preferably a perfluoroalkyl group having 1 to 10 carbon atoms, and more preferably a perfluoroalkyl group having 1 to 4 carbon atoms.

X⁶—SO₃⁻ (AN-3)

(In Formula (AN-3), X⁶ represents an alkyl group having 1 to 10 carbon atoms, having a fluorine atom.)

X⁶ is preferably a perfluoroalkyl group having 1 to 10 carbon atoms, and more preferably a perfluoroalkyl group having 1 to 4 carbon atoms.

O₃⁻S—X⁷—SO₃⁻ (AN-4)

(In Formula (AN-4), X⁷ represents an alkylene group having 1 to 10 carbon atoms, having a fluorine atom.)

X⁷ is preferably a perfluoroalkylene group having 1 to 10 carbon atoms, and more preferably a perfluoroalkylene group having 1 to 4 carbon atoms.

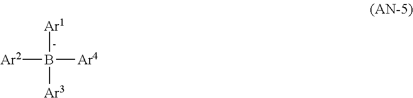

(In Formula (AN-5), Ar¹, Ar², Ar³, and Ar⁴ represent an aryl group.)

The aryl groups represented by Ar¹, Ar², Ar³, and Ar⁴ may have a substituent. Examples of the substituent include a halogen atom, an alkyl group, an aryl group, an alkoxy group, a carbonyl group, a carbonyloxy group, a carbamoyl group, a sulfo group, a sulfonamide group, and a nitro group, and in particular, a fluorine atom and an alkyl group are preferable, and a fluorine atom, a perfluoroalkyl group having 1 to 4 carbon atoms is still more preferable.

Ar¹, Ar², Ar³, and Ar⁴ are preferably a phenyl group, a pentafluorophenyl group, or a 3,5-trifluorophenyl group, and most preferably a pentafluorophenyl group.

The molecular weight per molecule of the counter anion which is used in the present invention is preferably 100 to 800, and more preferably 200 to 700.

The compound having a dye structure of the present invention may include one kind or two or more kinds of counter anion.

Specific examples of the counter anion which is used in the present invention are shown below, but the present invention is not limited thereto.

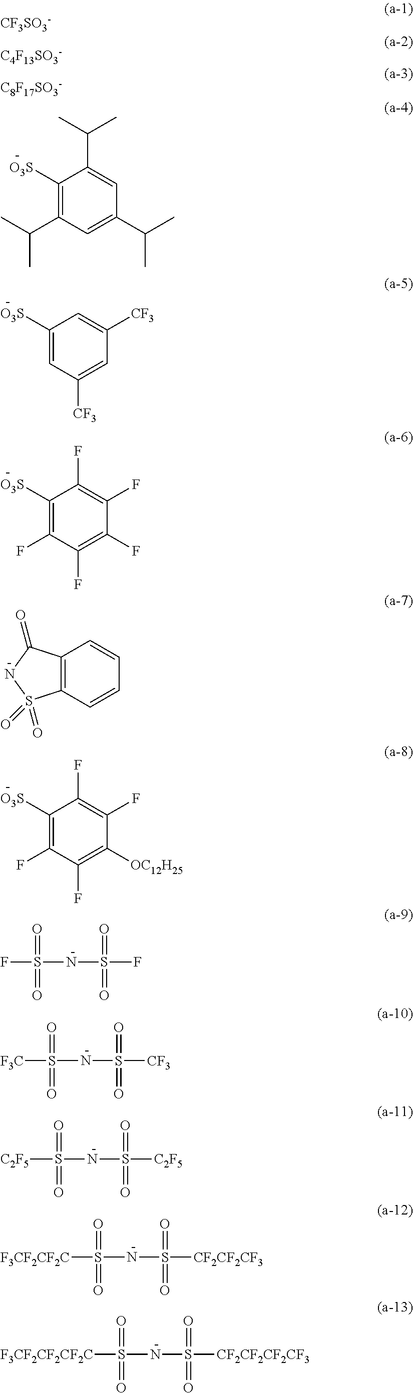

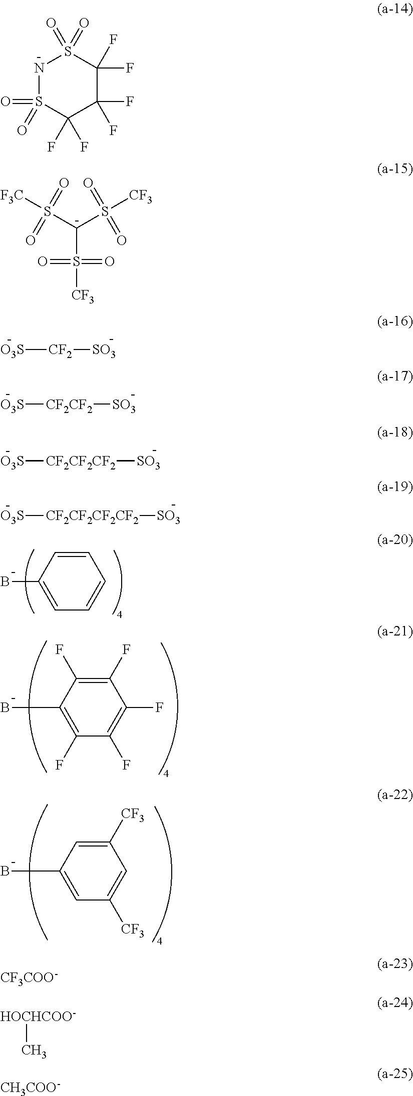

<<Other Compounds to be Reacted with Polymer>>

In the production method of the present invention, another compound, in addition to the compound having a dye structure, may be reacted with a polymer. As the other compound to be reacted with the polymer, a compound having a polymerizable group is preferable. By using such a compound, a polymerizable group can be introduced into the polymer, heat resistance is further increased, color migration is more effectively inhibited, and thus, a pattern deficit can be more effectively inhibited.

Furthermore, the polymer which is used in the present invention may include a repeating unit other than the repeating unit having the reactive group, and examples of such a repeating unit include a repeating unit having an acid group, a repeating unit having an alkali-soluble group, and a repeating unit having a polymerizable group. One kind or two or more kinds thereof may be included.

Examples of the acid group include a carboxylic acid group, a sulfonic acid group, and a phosphoric acid group.

Examples of the alkali-soluble group include a phenolic hydroxyl group and a carboxylic acid group.

The compound having a polymerizable group may be reacted, together with the compound having a dye structure; after the compound having a dye structure is reacted with the polymer, a compound having a polymerizable group is reacted with them; and before the compound having a dye structure is reacted with the polymer, the compound having a polymerizable group may be reacted. The compound having a polymerizable group, which is used in the present invention, usually has a reactive group which reacts with the polymer, in addition to the polymerizable group. Examples of such the reactive group are the same as the reactive groups which the compound having a dye structure has, and preferred ranges thereof are also the same.

The compound having a polymerizable group is incorporated in the amount of preferably 5% by mole to 80% by mole, and more preferably 10% by mole to 50% by mole, with respect to all the repeating units included in the polymer.

As the polymerizable group contained in the compound having a polymerizable group, known polymerizable groups which can be crosslinked by a radical, an acid, or heat can be used, and examples thereof include a group having an ethylenically unsaturated bond, a cyclic ether group (an epoxy group or an oxetane group), and a methylol group. In particular, a group having an ethylenically unsaturated bond is preferable, a (meth)acryloyl group is more preferable, and a (meth)acryloyl group derived from glycidyl(meth)acrylate and 3,4-epoxy-cyclohexylmethyl(meth)acrylate is particularly preferable.

Examples of the compound having a polymerizable group, which is reacted with the compound having a dye structure include glycidyl methacrylate, 2-hydroxyethyl methacrylate, 2-hydroxyethyl acrylate, 2-isocyanatoethyl methacrylate, 2-isocyanatoethyl acrylate, and the like.

In addition, examples of a repeating unit having an acid group and another repeating unit, which the polymer of the present invention may include, are shown below. n is a positive integer.

It is certain that the present invention is not limited thereto.

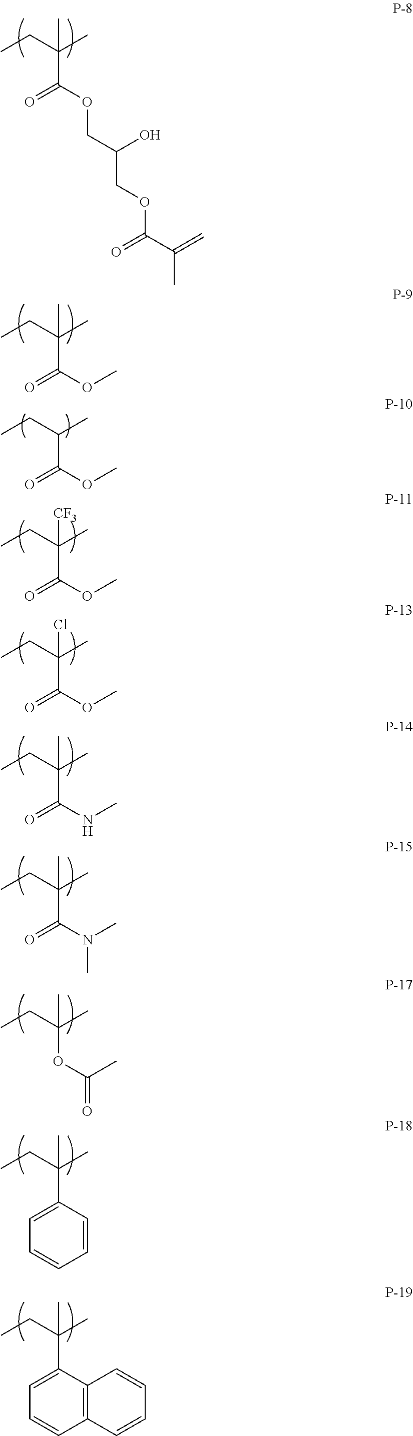

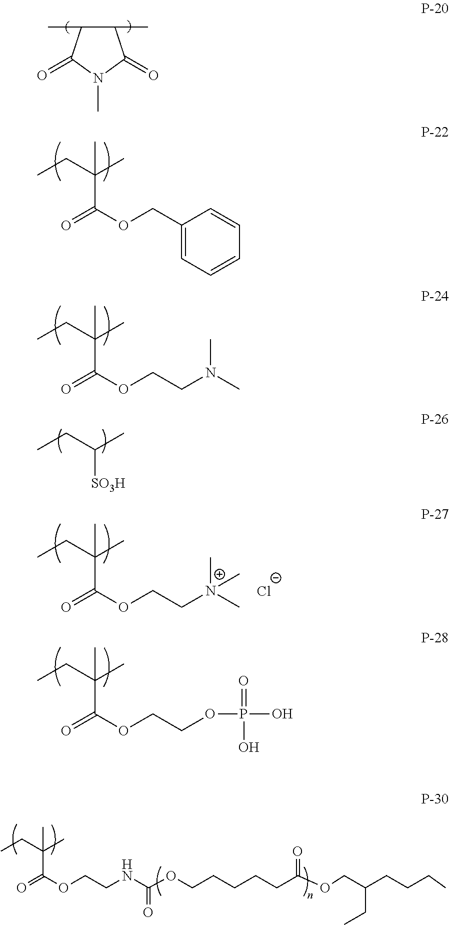

The weight-average molecular weight of the dye monomer produced by the production method of the present invention is, for example, 2,000 to 20,000, and further 3,000 to 15,000, and particularly 4,000 to 10,000.

Moreover, the molecular weight distribution of the dye monomer produced by the production method of the present invention can be set to 1.0 to 2.2, and further to 1.0 to 2.0, and particularly to 1.0 to 1.8. By using the molecular weight distribution set to the above range, the deviation in the molecular weight is further reduced, which makes it possible to further improve the pattern formability.

The glass transition temperature (Tg) of the dye multimer (A) produced by the production method of the present invention is preferably 50° C. or higher, and more preferably 100° C. or higher. Further, a 5%-weight reduction temperature measured by thermogravimetric analysis (TGA measurement) is preferably 120° C. or higher, more preferably 150° C. or higher, and still more preferably 200° C. or higher. If the temperature is within this range, when the coloring composition of the present invention is applied to the manufacture of a color filter or the like, a change in the concentration caused by a heating process can be reduced.

In addition, the absorption coefficient (hereinafter described as ∈′. ∈′=∈/average molecular weight, unit: L/g·cm) per unit weight of the dye multimer produced by the production method of the present invention is preferably 30 or more, more preferably 60 or more, and still more preferably 100 or more. If the absorption coefficient is within this range, in the case where a color filter is manufactured using the coloring composition of the present invention, a color filter having excellent color reproducibility can be manufactured.

It is preferable that the molar absorption coefficient of the dye multimer (A) used in the coloring composition of the present invention is as high as possible, from the viewpoint of coloring ability.

<Coloring Composition>

Furthermore, in the present invention, the dye multimer obtained by the method for producing a dye multimer is preferably blended into a coloring composition (hereinafter simply referred to as “the composition of the present invention” in some cases).

The composition of the present invention is preferably used so as to form a colored layer of a color filter. By forming a color filter using such a composition, color migration into other patterns is inhibited, and further, a pattern having excellent pattern formability can be formed.

Furthermore, in the related art, for a coloring composition into which the dye multimer has been blended, when a fine pattern is formed by a photolithography method, pattern deficit occurs or linearity of patterns is deteriorated in some cases. In contrast, by using the composition of the present invention, it is possible to inhibit pattern deficit or to inhibit deterioration of pattern linearity.

In addition, for a coloring composition into which the dye multimer has been blended, when a pattern is formed by a dry etching method, the resistance to a developer or the resistance to a peeling solution of a photoresist is poor in some cases. In contrast, in the present invention, it becomes possible to improve the resistance to a developer or the resistance to a peeling solution of a photoresist.

The coloring composition of the present invention preferably includes a curable compound and a pigment (C). Examples of the curable compound include a polymerizable compound (B) and an alkali-soluble resin (F) (including an alkali-soluble resin containing a polymerizable group), and the curable compound is suitably selected according to the purpose or production method therefor. Further, the coloring composition of the present invention preferably includes a photopolymerization initiator (D).

For example, in the case of forming a colored layer by a photoresist, the coloring composition of the present invention is preferably a composition including the dye multimer (A), the alkali-soluble resin (F) as a curable compound, the pigment (C), and the photopolymerization initiator (D) in the present invention. Further, the coloring composition may include components such as a surfactant and a solvent.

In addition, in the case of forming a colored layer by dry etching, the composition including the dye multimer (A), the polymerizable compound as a curable compound, the pigment (C), and the photopolymerization initiator (D) of the present invention is preferable. Further, the composition may include components such as a surfactant and a solvent.

In the coloring composition of the present invention, the dye multimer (A) may be used alone or in combination of two or more kinds thereof. In the case of using two or more kinds, the total amount thereof preferably corresponds to the content which will be described later.

The content of the dye multimer (A) in the coloring composition of the present invention is determined after considering its content ratio to the pigment (C) which will be described later.

The mass ratio of the dye multimer to the pigment (dye multimer (A)/pigment) is preferably 0.1 to 5, more preferably 0.2 to 2, and still more preferably 0.3 to 1.

The coloring composition of the present invention may include known dyes other than the dye multimer (A). For example, the dyes disclosed in JP1989-90403A (JP-S64-90403A), JP1989-91102A (JP-S64-91102A), JP1989-94301A (JP-H01-94301A), JP1994-11614A (JP-H06-11614A), JP2592207B, U.S. Pat. No. 4,808,501A, U.S. Pat. No. 5,667,920A, U.S. Pat. No. 5,059,500A, U.S. Pat. No. 5,667,920A, JP1993-333207A (JP-H05-333207A), JP1994-35183A (JP-H06-35183A), JP1994-51115A (JP-H06-51115A), and JP1994-194828A (JP-H06-194828A) can be used. With respect to the chemical structure, dyes such as a pyrazoleazo based-dye, a pyromethene based-dye, an anilinoazo based-dye, a triphenylmethane based-dye, an anthraquinone based-dye, a benzylidene based-dye, an oxonol based-dye, a pyrazoletriazole azo based-dye, a pyridoneazo based-dye, a cyanine based-dye, a phenothiazine based-dye, and a pyrrolopyrazoleazomethine-based dye can be used.

<Polymerizable Compound (B)>

The coloring composition of the present invention preferably contains a polymerizable compound.

Known polymerizable compounds which can be crosslinked by a radical, an acid, or heat can be used. Examples thereof include polymerizable compounds having an ethylenically unsaturated bond, a cyclic ether (epoxy or oxetane), methylol, or the like. From the viewpoint of sensitivity, the polymerizable compound is suitably selected from compounds having at least one and preferably two or more terminal ethylenically unsaturated bonds. Among these, polyfunctional polymerizable compounds having 4 or more functional groups are preferable, and polyfunctional polymerizable compounds having 5 or more functional groups are more preferable.

Such compound groups are widely known in the industrial field of the relevant art and can be used in the present invention without particular limitation. These may be in any type of chemical forms such as a monomer, a prepolymer, that is, a dimer, a trimer, an oligomer, a mixture thereof, and an oligomer thereof. The polymerizable compound in the present invention may be used alone or in combination of two or more kinds thereof.

More specifically, examples of the monomer and prepolymer include unsaturated carboxylic acids (for example, acrylic acid, methacrylic acid, itaconic acid, crotonic acid, isocrotonic acid, maleic acid, and the like) or esters thereof, amides, and multimers of these, and among these, an ester of unsaturated carboxylic acid and an aliphatic polyol compound, amides of unsaturated carboxylic acid and an aliphatic polyamine compound, and multimers of these are preferable. Moreover, products of an addition reaction between unsaturated carboxylic esters or amides having nucleophilic substituent such as a hydroxyl group, an amino group, or a mercapto group and monofunctional or polyfunctional isocyanates or epoxies, products of a dehydration condensation reaction between the unsaturated carboxylic esters or amides and a monofunctional or polyfunctional carboxylic acid, and the like are also suitably used. In addition, products of an addition reaction between unsaturated carboxylic esters or amides having an electrophilic substituent such as an isocyanate group or an epoxy group and monofunctional or polyfunctional alcohols, amines, or thiols, and products of a substitution reaction between unsaturated carboxylic esters or amides having an eliminatable substituent such as a halogen group or tosyloxy group and monofunctional or polyfunctional alcohols, amines, or thiols are also suitable. As other examples, instead of the above unsaturated carboxylic acid, vinyl benzene derivatives of unsaturated phosphonic acid, styrene, and the like and compound groups substituted with vinyl ether, allyl ether, or the like can also be used.

As these specific compounds, the compounds described in paragraph Nos. “0095” to “0108” of JP2009-288705A can also be suitably used in the present invention.

Moreover, as the polymerizable compound, a compound which has at least one addition-polymerizable ethylene group and has an ethylenically unsaturated group having a boiling point of 100° C. or higher under normal pressure is also preferable. Examples of the compound include a monofunctional acrylate or methacrylate such as polyethylene glycol mono(meth)acrylate, polypropylene glycol mono(meth)acrylate, and phenoxyethyl(meth)acrylate; a compound which is obtained by adding ethylene oxide or propylene oxide to a polyfunctional alcohol, and then (meth)acrylating the resultant, such as polyethylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol penta(meth)acrylate, dipentaerythritol hexa(meth)acrylate, hexanediol(meth)acrylate, trimethylolpropane tri(acryloyloxypropyl)ether, tri(acryloyloxyethyl) isocyanurate, glycerin, and trimethylolethane; the urethane(meth)acrylates described in JP1973-41708B (JP-S48-41708B), JP1975-6034B (JP-S50-6034B), and JP1976-37193A (JP-S51-37193A); the polyester acrylates described in JP1973-64183A (JP-S48-64183A), JP1974-43191B (JP-S49-43191B), and JP1977-30490B (JP-S52-30490B); a polyfunctional acrylate or methacrylate such as epoxy acrylate as a product of a reaction between an epoxy resin and a (meth)acrylic acid; and a mixture thereof.

Other examples thereof include a polyfunctional (meth)acrylate which is obtained by reacting a polyfunctional carboxylic acid with a compound having a cyclic ether group such as glycidyl(meth)acrylate, and an ethylenically unsaturated group.

Furthermore, as other preferred polymerizable compounds, the compounds having a fluorene ring and an ethylenically unsaturated group having 2 or more functional groups described in JP2010-160418A, JP2010-129825A, and JP4364216B, and a cardo resin can also be used.

Moreover, as the compound which has a boiling point of 100° C. or higher under normal pressure and has at least one addition-polymerizable ethylenically unsaturated group, compounds described in paragraph Nos. “0254” to “0257” of JP2008-292970A are also suitable.

Furthermore, radical polymerizable monomers can also be used. With respect to the monomer, there are descriptions in paragraph Nos. “0248” to “0251” of JP2007-269779A, the contents of which are incorporated herein.

In addition, a compound which is obtained by adding ethylene oxide or propylene oxide to the polyfunctional alcohol, which is described as General Formulae (1) and (2) in JP1998-62986A (JP-H10-62986A) together with the specific examples thereof, and then (meth)acrylating the resultant can also be used as a polymerizable compound.

Among these, as the polymerizable compound, dipentaerythritol triacrylate (KAYARAD D-330 as a commercially available product; manufactured by Nippon Kayaku Co., Ltd.), dipentaerythritol tetraacrylate (KAYARAD D-320 as a commercially available product; manufactured by Nippon Kayaku Co., Ltd.), dipentaerythritol penta(meth)acrylate (KAYARAD D-310 as a commercially available product; manufactured by Nippon Kayaku Co., Ltd.), dipentaerythritol hexa(meth)acrylate (KAYARAD DPHA as a commercially available product; manufactured by Nippon Kayaku Co., Ltd.), and a structure in which ethylene glycol or a propylene glycol residue is interposed between these (meth)acryloyl groups are preferable. Oligomer types of these can also be used. Preferred embodiments of the polymerizable compound are shown below.

The polymerizable compound is a polyfunctional monomer and may have an acid group such as a carboxyl group, a sulfonic acid group, and a phosphoric acid group. If an ethylenic compound has an unreacted carboxyl group as in a case where the ethylene compound is a mixture described above, this compound can be used as is, but if desired, a hydroxyl group of the aforementioned ethylenic compound may be reacted with a non-aromatic carboxylic anhydride so as to introduce an acid group. In this case, specific examples of the non-aromatic carboxylic anhydride used include tetrahydrophthalic anhydride, alkylated tetrahydrophthalic anhydride, hexahydrophthalic anhydride, alkylated hexahydrophthalic anhydride, succinic anhydride, and maleic anhydride.

In the present invention, as a monomer having an acid group, preferable is a polyfunctional monomer which is an ester obtained between an aliphatic polyhydroxy compound and an unsaturated carboxylic acid and provides an acid group by reacting an unreacted hydroxyl group of the aliphatic polyhydroxy compound with a non-aromatic carboxylic anhydride. A monomer in which the aliphatic polyhydroxy compound in the ester is pentaerythritol and/or dipentaerythritol is particularly preferable. Examples of commercially available products thereof include M-510 and M-520, which are polybasic modified acryl oligomers manufactured by TOAGOSEI, CO., LTD.

These monomers may be used alone, but since it is difficult to use a single compound in production, two or more kinds thereof may be used as a mixture. Moreover, if desired, a polyfunctional monomer not having an acid group and a polyfunctional monomer having an acid group may be used in combination therewith as the monomer.

The acid value of the polyfunctional monomer having an acid group is preferably 0.1 mg KOH/g to 40 mg KOH/g, and particularly preferably 5 mg KOH/g to 30 mg KOH/g. If the acid value of the polyfunctional monomer is too low, the development solubility characteristics deteriorates. If the acid value is too high, difficulty is caused in the production and handleability, hence a photopolymerization performance deteriorates, which leads to deterioration of curability such as surface smoothness of pixels. Therefore, in the case where a combination of two or more kinds of polyfunctional monomers having different acid groups is used, or when a combination of polyfunctional monomers not having an acid group is used, it is preferable to adjust the acid group such that the acid group of all the polyfunctional monomers falls within the above range.

Furthermore, it is also a preferred embodiment that a polyfunctional monomer having a caprolactone structure is contained as a polymerizable monomer.

The polyfunctional monomer having a caprolactone structure is not particularly limited as long as it has a caprolactone structure in a molecule thereof, and examples thereof include ε-caprolactone-modified polyfunctional (meth)acrylates which are obtained by esterifying polyols such as trimethylolethane, ditrimethylolethane, trimethylolpropane, ditrimethylolpropane, pentaerythritol, dipentaerythritol, tripentaerythritol, glycerin, diglycerol, and trimethylolmelamine with (meth)acrylic acid and ε-caprolactone. Such a polyfunctional monomer having a caprolactone structure is described in paragraphs “0135” to “0142” of JP2013-077009A, the contents of which are incorporated herein.

Furthermore, as the specific monomer in the present invention, at least one selected from the group consisting of compound groups represented by the following General Formula (Z-4) or (Z-5) is also preferable.

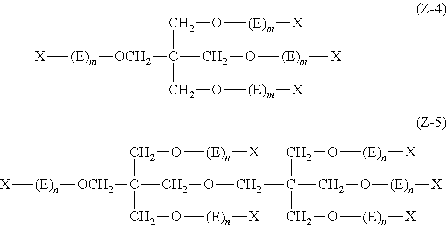

In General Formulae (Z-4) and (Z-5), E's each independently represent —((CH₂)yCH₂O)— or —((CH₂)yCH(CH₃)O)—, y's each independently represent an integer of 0 to 10, and X's each independently represent an acryloyl group, a methacryloyl group, a hydrogen atom, or a carboxyl group.

In General Formula (Z-4), the sum of the acryloyl group and the methacryloyl group is 3 or 4, m's each independently represent an integer of 0 to 10, and the sum of the respective m's is an integer of 0 to 40. Herein, in the case where the sum of the respective m's is 0, any one of X's is a carboxyl group.

In General Formula (Z-5), the sum of the acryloyl group and the methacryloyl group is 5 or 6, n's each independently represent an integer of 0 to 10, and the sum of the respective n's is an integer of 0 to 60. Herein, in the case where the sum of the respective n's is 0, one of X's is a carboxyl group.

In General Formula (Z-4), m is preferably an integer of 0 to 6, and more preferably an integer of 0 to 4. Further, the sum of the respective m's is preferably an integer of 2 to 40, more preferably an integer of 2 to 16, and particularly preferably an integer of 4 to 8.

In General Formula (Z-5), n is preferably an integer of 0 to 6, and more preferably an integer of 0 to 4.

Furthermore, the sum of the respective n's is preferably an integer of 3 to 60, more preferably an integer of 3 to 24, and particularly preferably an integer of 6 to 12.

In addition, —((CH₂)yCH₂O)— or —((CH₂)yCH(CH₃)O)— in General Formula (Z-4) or (Z-5) is preferably in the form in which the terminal at an oxygen atom side binds to X.

The compound represented by General Formula (Z-4) or (Z-5) may be used alone or in combination of two or more kinds thereof. In particular, a form in which all of six X's in General Formula (Z-5) are an acryloyl group is preferable.

Moreover, the total content of the compound represented by General Formula (Z-4) or (Z-5) in the polymerizable compound is preferably 20% by mass or more, and more preferably 50% by mass or more.

The compound represented by General Formula (Z-4) or (Z-5) can be synthesized by steps known in the related art, which includes a step of binding ethylene oxide or propylene oxide to pentaerythritol or dipentaerythritol by a ring-opening addition reaction to form a ring-opening skeleton, and a step of reacting, for example, (meth)acryloyl chloride to a terminal hydroxyl group of the ring-opening skeleton to introduce a (meth)acryloyl group. The respective steps are well-known and a person skilled in the art can easily synthesize the compound represented by General Formula (Z-4) or (Z-5).

Among the compounds represented by General Formula (Z-4) or General Formula (Z-5), a pentaerythritol derivative and/or a dipentaerythritol derivative is/are more preferable.

With respect to the specific pentaerythritol derivative and/or dipentaerythritol derivative, there are descriptions in paragraphs “0149” to “0155” of JP2013-077009A, the contents of which are incorporated herein.

Examples of commercially available products of the polymerizable compounds represented by General Formulae (Z-4) and (Z-5) include SR-494 which is a tetrafunctional acrylate having four ethyleneoxy chains, manufactured by Sartomer, and DPCA-60 which is a hexafunctional acrylate having six pentyleneoxy chains and TPA-330 which is a trifunctional acrylate having three isobutyleneoxy chains, manufactured by Nippon Kayaku Co., Ltd.

Moreover, as the polymerizable compounds, the urethane acrylates described in JP1973-41708B (JP-S48-41708B), JP1976-37193A (JP-S51-37193A), JP1990-32293B (JP-H02-32293B), and JP1990-16765B (JP-H02-16765B) or urethane compounds having an ethylene oxide-based skeleton described in JP1983-49860B (JP-S58-49860B), JP1981-17654B (JP-S56-17654B), JP1987-39417B (JP-S62-39417B), and JP1987-39418B (JP-S62-39418B) are also preferable. Furthermore, if addition-polymerizable compounds, which have an amino structure or a sulfide structure in a molecule and are described in JP1988-277653A (JP-S63-277653A), JP1988-260909A (JP-S63-260909A), and JP1989-105238A (JP-H01-105238A), are used as the polymerizable compounds, a curable composition which is extremely excellent in photosensitization speed can be obtained.

Examples of commercially available products of the polymerizable compounds include urethane oligomers UAS-10 and UAB-140 (manufactured by Sanyo-Kokusaku Pulp, Co., Ltd.), UA-7200 (manufactured by SHIN-NAKAMURA CHEMICAL CO., LTD.), DPHA-40H (manufactured by Nippon Kayaku Co., Ltd.), and UA-306H, UA-306T, UA-306I, AH-600, T-600, and AI-600 (manufactured by KYOEISHA CHEMICAL CO., LTD.).

As the cyclic ether (epoxy or oxethane), examples of a bisphenol A type epoxy resin, which have an epoxy group, include JER-827, JER-828, JER-834, JER-1001, JER-1002, JER-1003, JER-1055, JER-1007, JER-1009, and JER-1010 (all manufactured by Japan Epoxy Resins Co., Ltd.), and EPICLON 860, EPICLON 1050, EPICLON 1051, and EPICLON 1055 (all manufactured by DIC Corporation); examples of a bisphenol F type epoxy resin include JER-806, JER-807, JER-4004, JER-4005, JER-4007, and JER-4010 (all manufactured by Japan Epoxy Resins Co., Ltd.), EPICLON 830 and EPICLON 835 (both manufactured by DIC Corporation), and LCE-21 and RE-602S (all manufactured by Nippon Kayaku Co., Ltd.); examples of a phenol novolac type epoxy resin include JER-152, JER-154, JER-157 S70, and JER-157 S65 (all manufactured by Japan Epoxy Resins Co., Ltd.), and EPICLON N-740, EPICLON N-770, and EPICLON N-775 (all manufactured by DIC Corporation); examples of a cresol novolac type epoxy resin include EPICLON N-660, EPICLON N-665, EPICLON N-670, EPICLON N-673, EPICLON N-680, EPICLON N-690, and EPICLON N-695 (all manufactured by DIC Corporation), and EOCN-1020 (all manufactured by Nippon Kayaku Co., Ltd.); and examples of an aliphatic epoxy resin include ADEKA RESIN EP-4080S, ADEKA RESIN EP-4085S, and ADEKA RESIN EP-4088S (all manufactured by ADEKA CORPORATION), CELLOXIDE 2021P, CELLOXIDE 2081, CELLOXIDE 2083, CELLOXIDE 2085, EHPE-3150 (a 1,2-epoxy-4-(2-oxylanyl(cyclohexane adduct of 2,2-bis(hydroxymethyl)-1-butanol), EPOLEAD PB 3600, and EPOLEAD PB 4700 (all manufactured by Daicel Chemical Industries, Ltd.), DENACOL EX-211L, EX-212L, EX-214L, EX-216L, EX-321L, and EX-850L (all manufactured by Nagase ChemteX Corporation), ADEKA RESIN EP-4000S, ADEKA RESIN EP-4003S, ADEKA RESIN EP-4010S, and ADEKA RESIN EP-4011S (all manufactured by ADEKA CORPORATION), NC-2000, NC-3000, NC-7300, XD-1000, EPPN-501, and EPPN-502 (all manufactured by ADEKA CORPORATION), and JER-1031S (manufactured by Japan Epoxy Resins Co., Ltd.). Such polymerizable compounds are suitable for a case of forming a pattern by a dry etching method.

Details of how to use these polymerizable compounds, such as the structure, whether the polymerizable compounds are used singly or used in combination thereof, and the amount of the polymerizable compounds added, can be arbitrarily set according to the designed final performance of the coloring composition. For example, from the viewpoint of sensitivity, a structure in which the content of an unsaturated group per molecule is large is preferable, and in many cases, it is preferable that the polymerizable compound has 2 or more functional groups. Moreover, from the viewpoint of enhancing the strength of a cured film formed of the coloring composition, it is preferable that the polymerizable compound has 3 or more functional groups. In addition, a method for adjusting both the sensitivity and the strength by using a combination of compounds which differ in the number of functional groups and have different polymerizable groups (for example, an acrylic ester, a methacrylic ester, a styrene-based compound, and a vinyl ether-based compound) is also effective. Further, it is preferable to use polymerizable compounds having 3 or more functional groups and differing in the length of an ethylene oxide chain since the developability of the coloring composition can be adjusted, and excellent pattern formability is obtained.

In addition, from the viewpoints of the compatibility with other components (for example, a photopolymerization initiator, a substance to be dispersed, and an alkali-soluble resin) contained in the coloring composition, and the dispersibility, how to select and use the polymerizable compound is an important factor. For example, if a low-purity compound is used or a combination of two or more kinds thereof is used, the compatibility can be improved in some cases. In addition, from the viewpoint of improving the adhesiveness of the composition to a hard surface of a support or the like, specific structures may be selected in some cases.

The content of the polymerizable compound in the coloring composition of the present invention is preferably 0.1% by mass to 90% by mass, more preferably 1.0% by mass to 50% by mass, and particularly preferably 2.0% by mass to 30% by mass, with respect to the total solid contents of the coloring composition.

<Pigment (C)>

It is preferable that the coloring composition of the present invention further contains a pigment.

As the pigment used in the present invention, various inorganic or organic pigments known in the related art can be used. As the pigment, one having a high transmittance is preferable.

Examples of the inorganic pigment include black pigments such as carbon black and titanium black, metal compounds represented by a metal oxide, a metal complex salt, or the like, and specific examples thereof include metal oxides of iron, cobalt, aluminum, cadmium, lead, copper, titanium, magnesium, chromium, zinc, antimony, and the like, and complex oxides of the metals.

Examples of the organic pigment include:
C. I. Pigment Yellow 11, 24, 31, 53, 83, 93, 99, 108, 109, 110, 138, 139, 147, 150, 151, 154, 155, 167, 180, 185, 199;
C. I. Pigment Orange 36, 38, 43, 71;
C. I. Pigment Red 81, 105, 122, 149, 150, 155, 171, 175, 176, 177, 209, 220, 224, 242, 254, 255, 264, 270;
C. I. Pigment Violet 19, 23, 32, 39;
C. I. Pigment Blue 1, 2, 15, 15:1, 15:3, 15:6, 16, 22, 60, 66;
C. I. Pigment Green 7, 36, 37, 58;
C. I. Pigment Brown 25, 28; and
C. I. Pigment Black 1.

Examples of the pigment which can be preferably used in the present invention include the following pigments, but the present invention is not limited thereto:
C. I. Pigment Yellow 11, 24, 108, 109, 110, 138, 139, 150, 151, 154, 167, 180, 185,
C. I. Pigment Orange 36, 71;
C. I. Pigment Red 122, 150, 171, 175, 177, 209, 224, 242, 254, 255, 264,
C. I. Pigment Violet 19, 23, 32,
C. I. Pigment Blue 15:1, 15:3, 15:6, 16, 22, 60, 66,
C. I. Pigment Green 7, 36, 37, 58, and
C. I. Pigment Black 1.

These organic pigments can be used alone or in various combinations for spectral adjustment or improvement of color purity. Specific examples of the combination are shown below. For example, as a red pigment, an anthraquinone-based pigment, a perylene-based pigment, or a diketopyrrolopyrrole-based pigment can be used alone or as a mixture of at least one kind of these with a disazo-based yellow pigment, an isoindoline-based yellow pigment, a quinophthalone-based yellow pigment, or a perylene-based red pigment. Examples of the anthraquinone-based pigment include C. I. Pigment Red 177, examples of the perylene-based pigment include C. I. Pigment Red 155, and C. I. Pigment Red 224, and examples of the diketopyrrolopyrrole-based pigment include C. I. Pigment Red 254. In view of chromatic resolving properties, a mixture of the above pigment with C. I. Pigment Yellow 139 is preferable. The mass ratio between the red pigment and the yellow pigment is preferably 100:5 to 100:50. If the mass ratio is 100:4 or less, it is difficult to reduce the light transmittance at 400 nm to 500 nm, and if it is 100:51 or more, a dominant wavelength moves closer to a short wavelength, so a chromatic resolving power cannot be improved in some cases. In particular, the mass ratio is optimally in a range of 100:10 to 100:30. In addition, in the case of a combination of red pigments, the mass ratio can be adjusted according to the required spectrum.

In addition, as a green pigment, a halogenated phthalocyanine-based pigment can be used alone or as a mixture of this pigment with a disazo-based yellow pigment, a quinophthalone-based yellow pigment, an azomethine-based yellow pigment, or an isoindoline-based yellow pigment. As an example of such pigments, a mixture of C. I. Pigment Green 7, 36, or 37 with C. I. Pigment Yellow 83, C. I. Pigment Yellow 138, C. I. Pigment Yellow 139, C. I. Pigment Yellow 150, C. I. Pigment Yellow 180, or C. I. Pigment Yellow 185 is preferable. The mass ratio between the green pigment and the yellow pigment is preferably 100:5 to 100:150. The mass ratio is particularly preferably in a range of 100:30 to 100:120.

As a blue pigment, a phthalocyanine-based pigment can be used alone or as a mixture of this pigment with a dioxazine-based violet pigment. For example, a mixture of C. I. Pigment Blue 15:6 with C. I. Pigment Violet 23 is preferable. The mass ratio between the blue pigment and the violet pigment is preferably 100:0 to 100:100 and more preferably 100:10 or less.

Moreover, as a pigment for a black matrix, carbon, titanium black, iron oxide, or titanium oxide may be used alone or as a mixture, and a combination of carbon with titanium black is preferable. The mass ratio between carbon and titanium black is preferably in a range of 100:0 to 100:60.

In the case where the coloring composition is used for a color filter, the primary particle size of the pigment is preferably 100 nm or less from the viewpoint of color unevenness or contrast. From the viewpoint of dispersion stability, the primary particle size is preferably 5 nm or more. The primary particle size of the pigment is more preferably 5 nm to 75 nm, still more preferably 5 nm to 55 nm, and particularly preferably 5 nm to 35 nm.

The primary particle size of the pigment can be measured by a known method such as electron microscopy.

Among these, the pigment is preferably a pigment selected from an anthraquinone pigment, a diketopyrrolopyrrole pigment, a phthalocyanine pigment, a quinophthalone pigment, an isoindoline pigment, an azomethine pigment, and a dioxazine pigment. In particular, C. I. Pigment Red 177 (anthraquinone pigment), C. I. Pigment Red 254 (diketopyrrolopyrrole pigment), C. I. Pigment Green 7, 36, 58, C. I. Pigment Blue 15:6 (phthalocyanine pigment), C. I. Pigment Yellow 138 (quinophthalone pigment), C. I. Pigment Yellow 139, 185 (isoindoline pigments), C. I. Pigment Yellow 150 (azomethine pigment), and C. I. Pigment Violet 23 (dioxazine pigment) are most preferable.

In the case where the pigment is blended into the composition of the present invention, the content of the pigment is preferably 10% by mass to 70% by mass, more preferably 20% by mass to 60% by mass, and still more preferably 30% by mass to 60% by mass, with respect to the total amount of components excluding a solvent, contained in the coloring composition.

—Pigment Dispersant—

In the case where the coloring composition of the present invention has a pigment, a pigment dispersant can be used in combination with other components, as desired.

Examples of the pigment dispersant which can be used in the present invention include polymer dispersants [for example, a polyamide amine and a salt thereof, a polycarboxylic acid and a salt thereof, a high-molecular-weight unsaturated acid ester, a modified polyurethane, a modified polyester, a modified poly(meth)acrylate, a (meth)acrylic copolymer, and a naphthalene sulfonate formalin condensate], surfactants such as a polyoxyethylene alkyl phosphoric acid ester, a polyoxyethylene alkylamine, and a alkanolamine; and pigment derivatives.

The polymer dispersants can be further classified into straight-chain polymers, terminal-modified polymers, graft polymers, and block polymers, according to the structure.

Examples of the terminal-modified polymers which has a moiety anchored to the pigment surface include a polymer having a phosphoric acid group in the terminal as described in JP1991-112992A (JP-H03-112992A), JP2003-533455A, and the like, a polymer having a sulfonic acid group in the terminal as described in JP2002-273191A, a polymer having a partial skeleton or a heterocycle of an organic dye as described in JP1997-77994A (JP-H09-77994A), and the like. Moreover, a polymer obtained by introducing two or more moieties (acid groups, basic groups, partial skeletons of an organic dye, or heterocycles) anchored to the pigment surface into a polymer terminal as described in JP2007-277514A is also preferable since this polymer is excellent in dispersion stability.

Examples of the graft polymers having a moiety anchored to the pigment surface include polyester-based dispersant and the like, and specific examples thereof include a product of a reaction between a poly(lower alkyleneimine) and a polyester, which is described in JP1979-37082A (JP-S54-37082A), JP1996-507960A (JP-1108-507960A), JP2009-258668A, and the like, a product of a reaction between a polyallylamine and a polyester, which is described in JP1997-169821A (JP-H09-169821A) and the like, a copolymer of a macromonomer and a nitrogen atom monomer, which is described in JP1998-339949A (JP-H10-339949A), JP2004-37986A, WO2010/110491A, and the like, a graft polymer having a partial skeleton or a heterocycle of an organic dye, which is described in JP2003-238837A, JP2008-9426A, JP2008-81732A, and the like, and a copolymer of a macromonomer and an acid group-containing monomer, which is described in JP2010-106268A, and the like. In particular, from the viewpoint of dispersibility of a pigment dispersion, dispersion stability, and developability which a coloring composition using the pigment exhibits, an amphoteric dispersion resin having basic and acid groups, which is described in JP2009-203462A, is particularly preferable.

As the macromonomer used in production of a graft polymer having a moiety anchored to the pigment surface by radical polymerization, known macromonomers can be used. For example, there is a description in paragraph “0341” of JP2013-073104A, the contents of which are incorporated herein.

Preferable examples of the block polymer having an anchor moiety to a pigment surface include those described in JP2003-49110A and JP2009-52010A.

Other pigment dispersant which can be used in the present invention can be obtained as a commerically available product, and with respect to the specific examples thereof, there is a description in paragraph “0343” of JP2013-073104A, the contents of which are incorporated herein.

These pigment dispersants may be used alone or in combination of two or more kinds thereof. In the present invention, it is particularly preferable to use a combination of a pigment derivative and a polymer dispersant. Further, the pigment dispersant may be used in combination with an alkali-soluble resin, together with a terminal-modified polymer having a moiety anchored to the pigment surface, a graft polymer, or a block polymer. Examples of the alkali-soluble resin include a (meth)acrylic acid copolymer, an itaconic acid copolymer, a crotonic acid copolymer, a maleic acid copolymer, a partially esterified maleic acid copolymer, and an acidic cellulose derivative having a carboxylic acid in a side chain, and a (meth)acrylic acid copolymer is particularly preferable. In addition, the N-position-substituted maleimide monomers copolymer described in JP1998-300922A (JP-H10-300922A), the ether dimer copolymers described in JP2004-300204A, and the alkali-soluble resins containing a polymerizable group described in JP1995-319161A (JP-H07-319161A) are also preferable.

In the case where the coloring composition contains the pigment dispersant, the total content of the pigment dispersant is preferably 1 part by mass to 80 parts by mass, more preferably 5 parts by mass to 70 parts by mass, and still more preferably 10 parts by mass to 60 parts by mass, with respect to 100 parts by mass of the pigment.

Specifically, in the case where a polymer dispersant is used, the amount of the polymer dispersant used is preferably 5 parts by mass to 100 parts by mass, and more preferably 10 parts by mass to 80 parts by mass, with respect to 100 parts by mass of the pigment.

Moreover, in the case where a pigment derivative is used in combination with other components, the amount of the pigment derivative used is preferably 1 part by mass to 30 parts by mass, more preferably 3 parts by mass to 20 parts by mass, and particularly preferably 5 parts by mass to 15 parts by mass, with respect to 100 parts by mass of the pigment.

In the coloring composition, from the viewpoint of curing sensitivity and color density, the total content of the dye and the pigment dispersant is preferably 50% by mass to 90% by mass, more preferably 55% by mass to 85% by mass, and still more preferably 60% by mass to 80% by mass, with respect to the total solid contents constituting the coloring composition.

<Photopolymerization Initiator (D)>

From the viewpoint of further improving sensitivity, it is preferable that the coloring composition of the present invention contains a photopolymeriation initiator.

The photopolymerization initiator is not particularly limited as long as the photopolymerization initiator has a function of initiating polymerization of the polymerizable compound, and can be appropriately selected from known photopolymerization initiators. For example, photopolymerization initiators sensitive to light rays in a range from ultraviolet region to visible light are preferable. In addition, the photopolymerization initiator may be either an activator which interacts with a photo-excited sensitizer in any way and generates active radicals or an initiator which initiates cationic polymerization according to the type of monomer.

Furthermore, it is preferable that the photopolymerization initiator contains at least one kind of compound having at least a molar absorption coefficient of about 50 in a range of about 300 nm to 800 nm (more preferably 330 nm to 500 nm).

Examples of the photopolymerization initiator include halogenated hydrocarbon derivatives (for example, a derivative having a triazine skeleton, and a derivative having an oxadiazole skeleton), acyl phosphine compounds such as acyl phosphine oxide, oxime compounds such as hexaaryl biimidazole and oxime derivatives, organic peroxides, thio compounds, ketone compounds, aromatic onium salts, ketoxime ethers, aminoacetophenone compounds, and hydroxyacetophenone.

Furthermore, from the viewpoint of exposure sensitivity, the compound is preferably a compound selected from a group consisting of a trihalomethyl triazine compound, a benzyl dimethyl ketal compound, an a-hydroxyketone compound, an a-aminoketone compound, an acyl phosphine compound, a phosphine oxide compound, a metallocene compound, an oxime compound, a triallylimidazole dimer, an onium compound, a benzothiazole compound, a benzophenone compound, an acetophenone compound and a derivative thereof, a cyclopentadiene-benzene-iron complex and a salt thereof, a halomethyl oxadiazole compound, and a 3-aryl-substituted coumarin compound.

The compound is more preferably a trihalomethyl triazine compound, an α-aminoketone compound, an acyl phosphine compound, a phosphine oxide compound, an oxime compound, a triallylimidazole dimer, a triarylimidazole compound, a benzoimidazole compound, an onium compound, a benzophenone compound, or an acetophenone compound, and particularly preferably at least one kind of compound selected from a group consisting of a trihalomethyl triazine compound, an α-aminoketone compound, an oxime compound, a triallylimidazole compound, a benzophenone compound, a triarylimidazole compound, and a benzoimidazole compound. Further, the triarylimidazole compound may be a mixture thereof with benzoimidazole.

Specifically, the trihalomethyltriazine compound is exemplified as follows. Incidentally, Ph is a phenyl group.

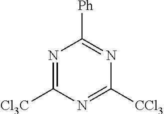

As the triarylimidazole compound and the benzoimidazole compound, the following compounds are exemplified.

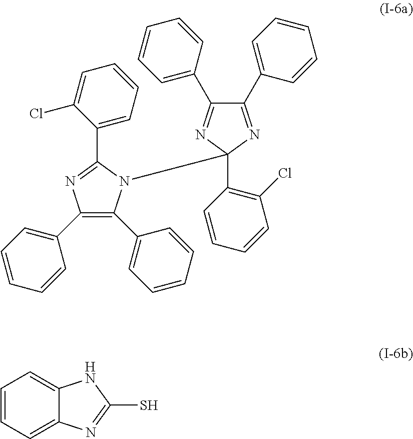 [SMILES: Clc1ccccc1-c1nc(-c2ccccc2)c(-c2ccccc2)n1C1(c2ccccc2Cl)N=C(c2ccccc2)C(c2ccccc2)=N1 ; Sc1nc2ccccc2[nH]1]

As the trihalomethyltriazine compound, a commercially available product can also be used, and for example, TAZ-107 (manufactured by Midori Kagaku Co., Ltd.) can also be used.

In particular, in the case where the coloring composition of the present invention is used for the manufacture of a color filter included in a solid-state imaging element, a fine pattern needs to be formed in a sharp shape. Accordingly, it is important that the composition has curability and is developed without residues in an unexposed area. From this viewpoint, an oxime compound is particularly preferable as a polymerization initiator. In particular, in the case where a fine pattern is formed in the solid-state imaging element, stepper exposure is used for exposure for curing. However, the exposure machine used at this time is damaged by halogen in some cases, so it is necessary to reduce the amount of a polymerization initiator added. In consideration of this point, in order to form a fine pattern as in a solid-state imaging element, it is most preferable to use an oxime compound as the photopolymerization initiator (D).

Examples of the halogenated hydrocarbon compound having a triazine skeleton include the compounds described in Wakabayashi, et al., Bull. Chem. Soc. Japan, 42, 2924 (1969), the compounds described in UK1388492B, the compounds described in JP1978-133428A (JP-S53-133428A), the compounds described in GE3337024B, the compound described in F. C. Schaefer, et al., J. Org. Chem.; 29, 1527 (1964), the compounds described in JP1987-58241A (JP-S62-58241A), the compounds described in JP1993-281728A (JP-H05-281728A), the compounds described in JP1993-34920A (JP-H05-34920A), and the compounds described in U.S. Pat. No. 4,212,976A.

Moreover, other examples thereof include the compounds described in JP1978-133428A (JP-S53-133428A), JP1982-1819B (JP-S57-1819B), JP1982-6096B (JP-S57-6296B), and U.S. Pat. No. 3,615,455A, and the like.

Examples of the ketone compound include the compounds described in paragraph No. “0077” of JP2013-077009A, the contents of which are incorporated herein.

As the photopolymerization initiator, a hydroxyacetophenone compound, an aminoacetophenone compound, and an acyl phosphine compound can also be suitably used. More specifically, for example, the aminoacetophenone-based initiator described in JP1998-291969A (JP-H10-291969A), and the acyl phosphine oxide-based initiator described in JP4225898B can also be used.

As the hydroxyacetophenone-based initiator, IRGACURE (registered trademark)-184, DAROCUR (registered trademark)-1173, IRGACURE (registered trademark)-500, IRGACURE (registered trademark)-2959, and IRGACURE (registered trademark)-127 (product names, all manufactured by BASF) can be used. As the aminoacetophenone, IRGACURE (registered trademark)-907, IRGACURE (registered trademark)-369, IRGACURE (registered trademark)-379, and IRGACURE (registered trademark)-OXE379 (product names, all manufactured by BASF) which are commercially available products can be used. In addition, as the aminoacetophenone-based initiator, the compound described in JP2009-191179A, of which an absorption wavelength matches a light source of a long wavelength of 365 nm, 405 nm, or the like can be used. Moreover, as the acyl phosphine-based initiator, IRGACURE (registered trademark)-819 or DAROCUR-TPO (product name, both manufactured by BASF) which are commercially available products can be used.

Examples of the photopolymerization initiator more preferably include oxime compounds. As specific examples of the oxime compounds, the compound described in JP2001-233842A, the compound described in JP2000-80068A, or the compound described in JP2006-342166A can be used.

Examples of the oxime compound such as an oxime derivative, which is suitably used as the photopolymerization initiator in the present invention, include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-(4-toluenesulfonyloxy)iminobutan-2-one, and 2-ethoxycarbonyloxyimino-1-phenylpropan-1-one.

Examples of the oxime compound include the compounds described in J. C. S. Perkin II (1979), pp. 1653 to 1660, J. C. S. Perkin II (1979), pp. 156-162, Journal of Photopolymer Science and Technology (1995), pp. 202-232, and JP2000-66385A; and the compounds described in each of JP2000-80068A, JP2004-534797A, and JP2006-342166A.

As the commercially available product, IRGACURE-OXE01 (registered trademark) (manufactured by BASF) and IRGACURE-OXE02 (registered trademark) (manufactured by BASF) are also suitably used.

Furthermore, as the oxime compound, TRONLY TR-PBG-304, TRONLY TR-PBG-309, and TRONLY TR-PBG-305 (manufactured by Changzhou Tronly New Electronic Materials CO., LTD.), and ADEKA ARKLS NCI-831 and ADEKA ARKLS NCI-930 (manufactured by ADEKA Corporation) are also suitably used.

Moreover, with respect to the oxime compounds, there is a description in paragraphs “0082” to “0121” of JP2013-077009A, the contents of which are incorporated herein.

A combination of two or more kinds of the photopolymerization initiator used in the present invention can be used, as desired.

In the case where the coloring composition of the present invention contains the (D) photopolymerization initiator, the content of the (D) photopolymerization initiator is preferably 0.1% by mass to 50% by mass, more preferably 0.5% by mass to 30% by mass, and still more preferably 1% by mass to 20% by mass, with respect to the total solid contents of the coloring composition. Within this range, improved sensitivity and pattern formability are obtained.

<Alkali-Soluble Resin (F)>

It is preferable that the coloring composition of the present invention further contains an alkali-soluble resin. Further, the alkali-soluble resin as mentioned herein does not include the components contained in the coloring composition of the present invention as a dispersant component.

The alkali-soluble resin can be appropriately selected from alkali-soluble resins which are linear organic high molecular-weight polymers and have at least one group enhancing alkali-solubility in a molecule (preferably, a molecule having an acrylic copolymer or a styrene-based copolymer as a main chain). From the viewpoint of heat resistance, a polyhydroxystyrene-based resin, a polysiloxane-based resin, an acrylic resin, an acrylamide-based resin, and an acryl/acrylamide copolymer resin are preferable. Further, from the viewpoint of controlling developability, an acryl-based resin, an acrylamide-based resin, and an acryl/acrylamide copolymer resin are preferable.

Examples of the group promoting alkali-solubility (hereinafter also referred to as an “acid group”) include a carboxyl group, a phosphoric acid group, a sulfonic acid group, a phenolic hydroxyl group, and the like. The group promoting alkali-solubility is preferably a group which is soluble in an organic solvent and can be developed by an aqueous weak alkaline solution, and particularly preferred examples thereof include a (meth)acrylic acid. These acid groups may be used alone or in combination of two or more kinds thereof.

Examples of the monomer which can give the acid group after polymerization include monomers having a hydroxyl group, such as 2-hydroxyethyl(meth)acrylate, monomers having an epoxy group, such as glycidyl(meth)acrylate, and monomers having an isocyanate group, such as 2-isocyanatoethyl(meth)acrylate. The monomers for introducing these acid groups may be used alone or in combination of two or more kinds thereof. In order to introduce the acid group into the alkali-soluble resin, for example, the monomer having the acid group and/or the monomer which can give the acid group after polymerization (hereinafter referred to as a “monomer for introducing an acid group” in some cases) may be polymerized as a monomer component.

Incidentally, in the case where a monomer which can give the acid group after polymerization is used as a monomer component to introduce the acid group, a treatment for giving the acid group, which will be described later, needs to be performed after polymerization.

With respect to the alkali-soluble resin, there are descriptions in paragraphs “0179” to “0210” of JP2013-077009A, the contents of which are incorporated herein.

Furthermore, the alkali-soluble resin may include a structure unit derived from an ethylenically unsaturated monomer represented by the following Formula (X).

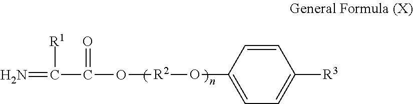

(In Formula (X), R¹ represents a hydrogen atom or a methyl group, R² represents an alkylene group having 2 to 10 carbon atoms, R³ represents a hydrogen atom or an alkyl group having 1 to 20 carbon atoms, which may contain a benzene ring, and n represents an integer of 1 to 15.)

In Formula (X), the number of carbon atoms of the alkylene group of R² is preferably 2 or 3. Further, the number of carbon atoms of the alkyl group of R³ is 1 to 20, and more preferably 1 to 10, and the alkyl group of R³ may contain a benzene ring. Examples of the alkyl group containing a benzene ring, represented by R³, include a benzyl group and a 2-phenyl(iso)propyl group.

With respect to the alkali-soluble resin, reference can be made to the descriptions in paragraphs “0558” to “0571” of JP2012-208494A (“0685” to “0700” of the corresponding US2012/0235099A), the contents of which are incorporated herein.

Furthermore, it is preferable to use the copolymers (B) described in paragraph Nos. “0029” to “0063” of JP2012-32767A and the alkali-soluble resins used in Examples of the document; the binder resins described in paragraph Nos. “0088” to “0098” of JP2012-208474A and the binder resins used in Examples of the document; the binder resins described in paragraph Nos. “0022” to “0032” of JP2012-137531A and the binder resins in Examples of the document; the binder resins described in paragraph Nos. “0132” to “0143” of JP2013-024934A and the binder resins used in Examples of the document; the binder resins described in paragraph Nos. “0092” to “0098” of JP2011-242752A and used in Examples; or the binder resins described in paragraph Nos. “0030” to 0072″ of JP2012-032770A, the contents of which are incorporated herein. More specifically, the following resins are preferable.

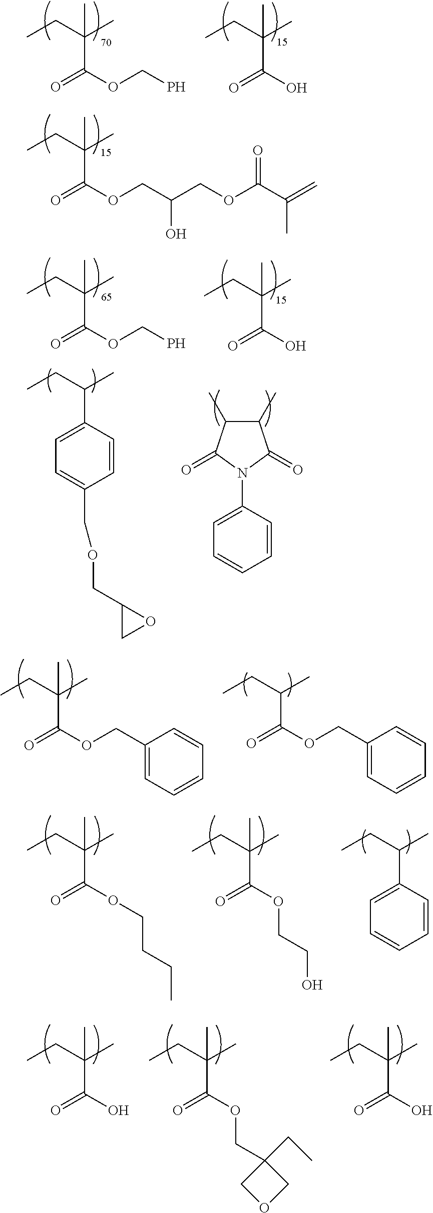

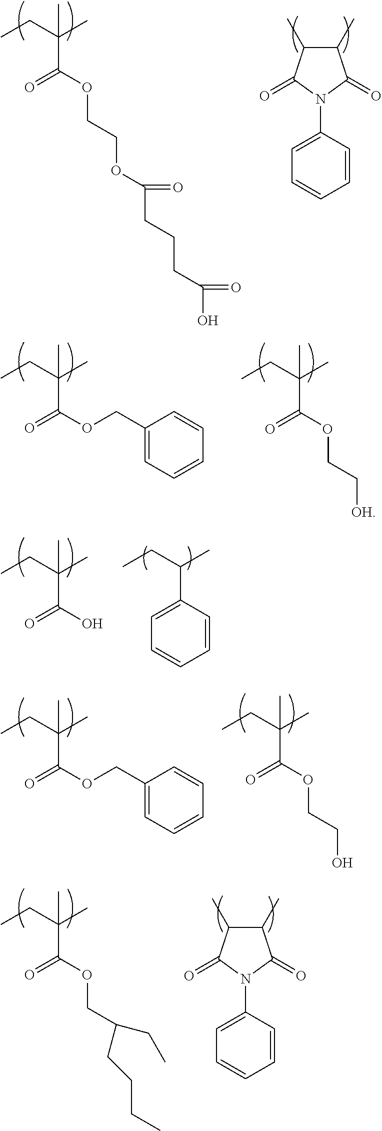

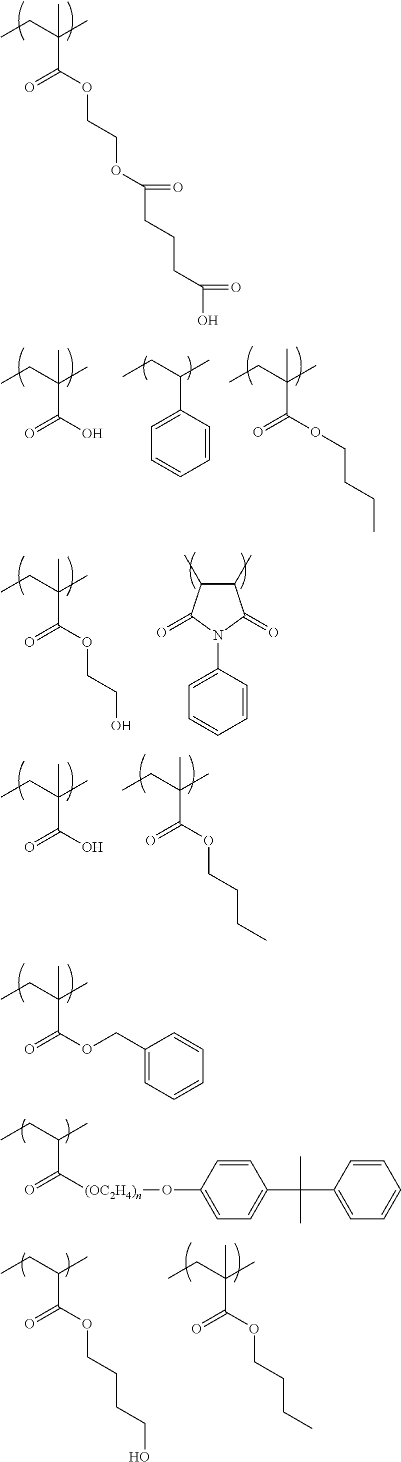

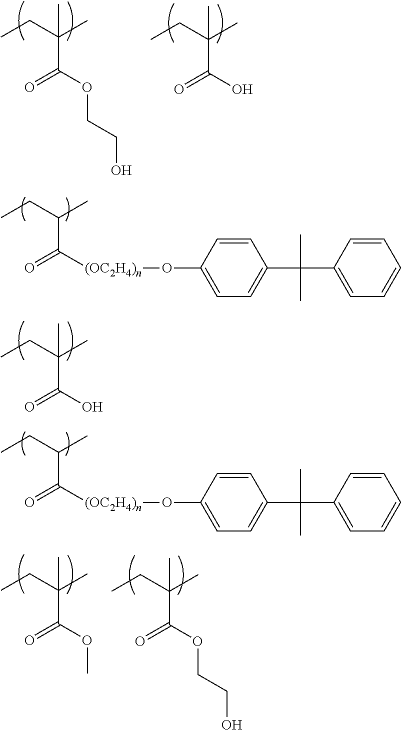

The acid value of the alkali-soluble resin is preferably 30 mgKOH/g to 200 mgKOH/g, more preferably 50 mgKOH/g to 150 mgKOH/g, and most preferably 70 mgKOH/g to 120 mgKOH/g.

Furthermore, the weight-average molecular weight (Mw) of the alkali-soluble resin is preferably 2,000 to 50,000, more preferably 5,000 to 30,000, and most preferably 7,000 to 20,000.

In the case where the coloring composition contains an alkali-soluble resin, the content of the alkali-soluble resin in the coloring composition is preferably 1% by mass to 15% by mass, more preferably 2% by mass to 12% by mass, and particularly preferably 3% by mass to 10% by mass, with respect to the total solid contents of the coloring composition.

The composition of the present invention may include one kind or two or more kinds of alkali-soluble resin. In the case where the composition includes two or more kinds of the alkali-soluble resin, the total amount thereof is preferably within the range.

<Other Components>

The coloring composition of the present invention may further contain other components such as an organic solvent and a crosslinking agent, in addition to the respective components as mentioned above, within a range which does not diminish the effects of the present invention.

<<Organic Solvent>>

The coloring composition of the present invention may contain an organic solvent.

Basically, the organic solvent is not particularly limited as long as the solvent satisfies the solubility of the respective components or the coatability of the coloring composition. In particular, it is preferable to select the organic solvent in consideration of the solubility, coatability, and safety of an ultraviolet absorber, the alkali-soluble resin, the dispersant, or the like. In addition, when the coloring composition in the present invention is prepared, the composition preferably includes at least two kinds of organic solvents.

Suitable examples of the organic solvent include esters such as ethyl acetate, n-butyl acetate, isobutyl acetate, amyl formate, isoamyl acetate, isobutyl acetate, butyl propionate, isopropyl butyrate, ethyl butyrate, butyl butyrate, methyl lactate, ethyl lactate, alkyl oxyacetate (for example, methyl oxyacetate, ethyl oxyacetate, and butyl oxyacetate (for example, methyl methoxyacetate, ethyl methoxyacetate, butyl methoxyacetate, methyl ethoxyacetate, and ethyl ethoxyacetate)), alkyl 3-oxypropionate esters (for example, methyl 3-oxypropionate and ethyl 3-oxypropionate (for example, methyl 3-methoxypropionate, ethyl 3-methoxypropionate, methyl 3-ethoxypropionate, and ethyl 3-ethoxypropionate)), alkyl 2-oxypropionate esters (for example, methyl 2-oxypropionate, ethyl 2-oxypropionate, or propyl 2-oxypropionate (for example, methyl 2-methoxypropionate, ethyl 2-methoxypropionate, propyl 2-methoxypropionate, methyl 2-ethoxypropionate, or ethyl 2-ethoxypropionate)), methyl 2-oxy-2-methyl propionate and ethyl 2-oxy-2-methyl propionate (for example, methyl 2-methoxy-2-methyl propionate and ethyl 2-ethoxy-2-methyl propionate), methyl pyruvate, ethyl pyruvate, propyl pyruvate, methyl acetoacetate, ethyl acetoacetate, methyl 2-oxobutanoate, and ethyl 2-oxobutanoate; ethers such as diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether, propylene glycol monomethy ether acetate, propylene glycol monoethyl ether acetate, and propylene glycol monopropyl ether acetate; ketones such as methyl ethyl ketone, cyclohexanone, cyclopentanone, 2-heptanone, and 3-butanone; and aromatic hydrocarbons such as toluene and xylene.

From the viewpoint of the solubility of an ultraviolet absorber and the alkali-soluble resin, and improvement of the shape of the coated surface, it is also preferable to mix two or more kinds of these organic solvents. In this case, a mixed solution consisting of two or more kinds selected from the aforementioned methyl 3-ethoxypropionate, ethyl 3-ethoxypropionate, ethyl cellosolve acetate, ethyl lactate, diethylene glycol dimethyl ether, butyl acetate, methyl 3-methoxypropionate, 2-heptanone, cyclohexanone, ethylcarbitol acetate, butylcarbitol acetate, propylene glycol methyl ether, and propylene glycol methyl ether acetate is particularly preferable.

From the viewpoint of coatability, the content of the organic solvent in the coloring composition is set such that the concentration of the total solid contents of the composition becomes preferably 5% by mass to 80% by mass, more preferably 5% by mass to 60% by mass, and particularly preferably 10% by mass to 50% by mass.

<<Crosslinking Agent>>

It is also possible to improve the hardness of the colored cured film obtained by curing the coloring composition by using a crosslinking agent complementarily in the coloring composition of the present invention.

The crosslinking agent is not particularly limited as long as it makes it possible to cure a film by a crosslinking reaction, and examples thereof include (a) an epoxy resin, (b) a melamine compound, a guanamine compound, a glycoluril compound, or a urea compound substituted with at least one substituent selected from a methylol group, an alkoxymethyl group, and an acyloxymethyl group, and (c) a phenol compound, a naphthol compound, or a hydroxyanthracene compound, which is substituted with at least one substituent selected from a methylol group, an alkoxymethyl group, and an acyloxymethyl group. Among these, a polyfunctional epoxy resin is preferable.

With regard to the details of specific examples and the like of the crosslinking agent, reference can be made to the description of paragraphs “0134” to “0147” of JP2004-295116A.

In the case where the coloring composition of the present invention contains a crosslinking agent, the blending amount of the crosslinking agent is not particularly limited, but is preferably 2% by mass to 30% by mass, and more preferably 3% by mass to 20% by mass, with respect to the total solid contents of the composition.

The composition of the present invention may include one kind or two or more kinds of crosslinking agent. In the case where the composition includes two or more kinds of the crosslinking agent, the total amount thereof is preferably within the range.

<<Polymerization Inhibitor>>

It is preferable to add a small amount of a polymerization inhibitor to the coloring composition of the present invention in order to suppress the occurrence of unnecessary thermal polymerization of the polymerizable compound during production or storage of the coloring composition.

Examples of the polymerization inhibitor which can be used in the present invention include hydroquinone, p-methoxyphenol, di-tert-butyl-p-cresol, pyrogallol, tert-butylcatechol, benzoquinone, 4,4′-thiobis(3-methyl-6-tert-butylphenol), 2,2′-methylenebis(4-methyl-6-tert-butylphenol), and a cerium (III) salt of N-nitrosophenyl hydroxylamine.

In the case where the coloring composition of the present invention contains a polymerization inhibitor, the amount of the polymerization inhibitor added is preferably about 0.01% by mass to about 5% by mass, with respect to the total mass of the composition.

The composition of the present invention may include one kind or two or more kinds of polymerization inhibitor. In the case where the composition includes two or more kinds of the polymerization inhibitor, the total amount thereof is preferably within the range.

<<Surfactant>>

From the viewpoint of further improving coatability, various surfactants may be added to the coloring composition of the present invention. As the surfactants, it is possible to use various surfactants such as a fluorine-based surfactant, a nonionic surfactant, a cationic surfactant, an anionic surfactant, and a silicon-based surfactant.

Particularly, if the coloring composition of the present invention contains a fluorine-based surfactant, liquid characteristics (particularly, fluidity) are further improved when the composition is prepared as a coating liquid, whereby evenness of the coating thickness or liquid saving properties can be further improved.

That is, in the case where a coating liquid obtained by applying the coloring composition containing a fluorine-based surfactant is used to form a film, the surface tension between a surface to be coated and the coating liquid is reduced to improve wettability with respect to the surface to be coated, and enhance coatability with respect to the surface to be coated. Therefore, even in the case where a thin film of about several μm is formed of a small amount of liquid, the coloring composition containing a fluorine-based surfactant is effective in that a film with a uniform thickness which exhibits a small extent of thickness unevenness can be more suitably formed.

The fluorine content in the fluorine-based surfactant is preferably 3% by mass to 40% by mass, more preferably 5% by mass to 30% by mass, and particularly preferably 7% by mass to 25% by mass. The fluorine-based surfactant in which the fluorine content is within this range is effective in terms of the uniformity of the thickness of the coating film or liquid saving properties, and the solubility of the surfactant in the coloring composition is also good.

Examples of the fluorine-based surfactant include Megaface F171, Megaface F172, Megaface F173, Megaface F176, Megaface F177, Megaface F141, Megaface F142, Megaface F143, Megaface F144, MegafaceR30, Megaface F437, Megaface F475, Megaface F479, Megaface F482, Megaface F554, Megaface F780, and Megaface F781 (all manufactured by DIC Corporation), Fluorad FC430, FC431, and FC171 (all manufactured by Sumitomo 3M), and Surflon S-382, Surflon SC-101, Surflon SC-103, Surflon SC-104, Surflon SC-105, Surflon SC1068, Surflon SC-381, Surflon SC-383, Surflon SC-393, and Surflon KH-40 (all manufactured by ASAHI GLASS Co., Ltd.).

With respect to the nonionic surfactant, the cationic surfactant, the anionic surfactant, and the silicon-based surfactant, there are descriptions in paragraphs “0224” to “0227” of JP2013-077009A, the contents of which are incorporated herein.

The surfactant may be used alone or in combination of two or more kinds thereof

In the case where the coloring composition of the present invention contains a surfactant, the amount of the surfactant added is preferably 0.001% by mass to 2.0% by mass, and more preferably 0.005% by mass to 1.0% by mass, with respect to the total mass of the coloring composition.

The composition of the present invention may include one kind or two or more kinds of surfactant. In the case where the composition includes two or more kinds of the surfactant, the total amount thereof is preferably within the range.

<<Other Additives>>

If desired, various additives such as a filler, an adhesion promoting agent, an antioxidant, an ultraviolet absorber, and an anti-aggregation agent may be blended into the coloring composition. Examples of these additives include those described in paragraphs “0155” and “0156” of JP2004-295116A.

The coloring composition of the present invention can contain the sensitizer or the light stabilizer described in paragraph “0078” of JP2004-295116A, and the thermal polymerization inhibitor described in paragraph “0081” of JP2004-295116A.

<<Organic Carboxylic Acid and Organic Carboxylic Anhydride>>

The coloring composition of the present invention may contain an organic carboxylic acid having a molecular weight of 1,000 or less, and/or an organic carboxylic anhydride.

With respect to the organic carboxylic acid anhydride and the organic carboxylic acid compound, there are descriptions in paragraphs “0462” to “0464” of JP2013-073104A, the contents of which are incorporated herein.

(Method for Preparing Coloring Composition)

The coloring composition of the present invention is prepared by mixing the aforementioned components.

Furthermore, when the coloring composition is prepared, the respective components constituting the coloring composition may be mixed together at the same time or mixed together sequentially after being dissolved and dispersed in a solvent. Further, the order of adding the components and the operation conditions during the mixing is not particularly restricted. For example, all the components may be dissolved and dispersed in a solvent at the same time to prepare the composition. Alternatively, if desired, the respective components may be appropriately prepared as two or more solutions or dispersions and mixed at the time of use (at the time of coating) to prepare the composition.

The coloring composition prepared above can be filtered and separated using a filter or the like, and then used.

It is preferable that the coloring composition of the present invention is filtered using a filter for the purpose of removing impurities or reducing deficit. Filters that have been used in the related art for filtration uses and the like may be used without particular limitation. Examples thereof include filters formed of a fluorine resin such as polytetrafluoroethylene (PTFE), a polyamide-based resin such as Nylon-6 and Nylon-6,6, and a polyolefin resin (including a high density and a ultrahigh molecular weight) such as polyethylene and polypropylene (PP). Among these materials, polypropylene (including high density polypropylene) is preferable.

The pore diameter of the filter is preferably 0.01 μm or more, and more preferably 0.05 μm or more. Further, the pore diameter of the filter is preferably 7.0 μm or less, preferably 3.0 μm or less, still more preferably 2.5 μm or less, even still more preferably 2.0 μm or less, and particularly preferably 0.5 μm or less. By setting the pore diameter to this range, it is possible to reliably remove fine impurities which interfere with preparation of uniform and smooth coloring composition in a subsequent step.

When a filter is used, other filters may be used in combination therewith. At that time, filtering at a first filter may be performed once or two or more times.

In addition, first filters having different pore diameters within the aforementioned range may be combined. As the pore diameter herein, a reference may be made to nominal values of a filter maker. A commercially available filter may be selected from various filters provided by, for example, Pall Corporation, Advantec Toyo Kaisha, Ltd., Nihon Entegris K.K. (former Nippon Microlith Co., Ltd.), Kitz Micro Filter Corporation, or the like.

As a second filter, a filter formed of a material which is the same as the material for the aforementioned first filter and the like can be used.

For example, the filtering at the first filter may be performed with only the liquid dispersion, and the other components may be mixed and then the second filtering may be performed.

Since the coloring composition of the present invention can form a colored cured film having excellent heat resistance and color characteristics, it is suitably used for forming a colored pattern (colored layer) of a color filter. Further, the coloring composition of the present invention can be suitably used for forming a colored pattern of a color filter or the like used in a solid-state imaging element (for example, a CCD and a CMOS) or an image display device such as a liquid crystal display (LCD). Further, the composition can also be suitably used in an application of the manufacture of a print ink, an ink jet ink, a coating material, or the like. Among these, the composition can be suitably used in an application of the manufacture of a color filter for a solid-state imaging element such as a CCD and a CMOS.

<Cured Film, Pattern Forming Method, Color Filter, and Method for Manufacturing Color Filter>

Next, the colored cured film, the pattern forming method, and the color filter in the present invention will be described in detail by an explanation of production methods thereof.

The pattern forming method of the present invention may include a coloring composition layer forming step of applying the coloring photosensitive composition of the present invention onto a support to form a coloring composition layer, an exposing step of patternwise exposing the coloring composition layer, and a pattern forming step of removing an unexposed area by development to form a colored pattern.

The pattern forming method of the present invention can be suitably applied for forming a colored pattern (pixel) included in a color filter.

The support for forming a pattern by the pattern forming method of the present invention is not particularly limited as long as it is a support that can be applied for pattern formation, other than a planar material such as a substrate.

The respective steps in the pattern forming method of the present invention will be described in detail below with reference to the method for manufacturing a color filter for a solid-state imaging element, but the present invention is not limited to this method.

The method for manufacturing a color filter of the present invention involves applying the pattern forming method of the present invention, and includes a step of forming a colored pattern on a support using the pattern forming method of the present invention.

That is, the method for manufacturing a color filter of the present invention involves applying the pattern forming method of the present invention, and includes a coloring composition layer forming step of applying the coloring photosensitive composition of the present invention onto a support to form a coloring composition layer, an exposing step of patternwise exposing the coloring composition layer, and a pattern forming step of removing an unexposed area by development to form a colored pattern. Further, it may include a step of baking the coloring composition layer (a pre-baking step), and a step of baking the developed colored pattern (a post-baking step). Hereinafter, these steps are collectively referred to as a pattern forming step in some cases.

The color filter of the present invention can be suitably obtained by the manufacturing method.

Hereinafter, the color filter for a solid-state imaging element may be simply referred to as a “color filter” in some cases.

The respective steps in the pattern forming method of the present invention will be described in detail below with reference to the method for manufacturing a color filter of the present invention.

The method for manufacturing a color filter of the present invention involves applying the pattern forming method of the present invention, and includes a step of forming a colored pattern on a support using the pattern forming method of the present invention.

<Coloring Composition Layer Forming Step>

In the coloring composition layer forming step, the coloring composition of the present invention is provided on a support to form a coloring composition layer forming step.

As the support which can be used in the present step, for example, it is possible to use a substrate for a solid-state imaging element, which is formed by providing an imaging element (light-receiving element) such as a charge coupled device (CCD) or a complementary metal-oxide semiconductor (CMOS) onto a substrate (for example, a silicon substrate).

The colored pattern in the present invention may be formed on the surface (front surface) on which an imaging element is formed or on the surface (back surface) where an imaging element is not formed, of a substrate for a solid-state imaging element.

A light shielding film may be disposed between the colored pattern in a solid-state imaging element or onto the back surface of the substrate for a solid-state imaging element.

In addition, if desired, an undercoat layer may be disposed on the support in order to improve adhesiveness with the upper layer, prevent diffusion of substances, or planarize the substrate surface.

As the method for applying the coloring composition of the present invention onto the support, various coating methods such as slit coating, ink jet coating, spin coating, cast coating, roll coating, and a screen printing method can be applied.

Drying (pre-baking) of the coloring composition layer applied onto the support can be carried out using a hot plate, an oven, or the like at a temperature of 50° C. to 140° C. for 10 seconds to 300 seconds.

<<Case of Forming Pattern by Photolithography Method>>

<<Exposing Step>>

In the exposing step, the coloring composition layer formed in the coloring composition layer forming step is patternwise exposed through a mask having a predetermined mask pattern by using, for example, an exposure device such as a stepper. Thus, a colored cured film is obtained.

As radiation (light) usable in exposure, particularly, ultraviolet rays such as a g-ray and an i-ray are preferably used (an i-ray is particularly preferably used). The irradiation dose (exposure dose) is preferably 30 mJ/cm² to 1500 mJ/cm², more preferably 50 mJ/cm² to 1,000 mJ/cm², and most preferably 80 mJ/cm² to 500 mJ/cm².

The film thickness of the colored cured film is preferably 1.0 μm or less, more preferably 0.1 μm to 0.9 μm, and still more preferably 0.2 μm to 0.8 μm

It is preferable to set the film thickness to 1.0 μm or less since high resolution and high adhesiveness are obtained.

Moreover, in this step, a colored cured film having a small film thickness of 0.7 μm or less can be suitably formed. Further, if the colored cured film thus obtained is subjected to a development treatment in a pattern forming step which will be described later, it is possible to obtain a colored pattern which is a thin film and exhibits excellent developability and reduced surface roughness with an excellent pattern shape.

<<<Pattern Forming Step>>>

Thereafter, by performing an alkaline developing treatment, the coloring composition layer in an area not irradiated with light in the exposing step is eluted into an aqueous alkaline solution, and as a result, only a photocured area remains.

As a developer, an organic alkaline developer not damaging an imaging element, a circuit, or the like in an underlayer is preferable. The development temperature is usually from 20° C. to 30° C., and the development time is 20 seconds to 90 seconds in the related art. In order to further remove residues, development is recently carried out for 120 seconds to 180 seconds in some cases. Further, in order to improve residue removal properties, a step of sufficiently shaking the developer every 60 seconds and newly supplying a developer is repeated plural times in some cases.

Examples of an alkaline agent used for the developer include organic alkaline compounds such as tetrapropylammonium hydroxide, tetrabutylammonium hydroxide, benzyltrimethylammonium hydroxide, aqueous ammonia, ethylamine, diethylamine, dimethyl ethanolamine, tetramethylammonium hydroxide, tetraethylammonium hydroxide, choline, pyrrole, piperidine, and 1,8-diazabicyclo-[5,4,0]-7-undecene. An aqueous alkaline solution obtained by diluting these alkaline agents with pure water so as to yield a concentration of the alkaline agent of 0.001% by mass to 10% by mass, and preferably 0.01% by mass to 1% by mass is preferably used as the developer.

Incidentally, inorganic alkali may be used for the developer, and as the inorganic alkali, for example, sodium hydroxide, potassium hydroxide, sodium carbonate, sodium hydrogen carbonate, sodium silicate, sodium metasilicate, and the like are preferable.

Furthermore, in the case where a developer formed of such an aqueous alkaline solution is used, the pattern is generally cleaned (rinsed) with pure water after development.

Next, it is preferable to carry out a heating treatment (post-baking) after drying. If a multi-colored pattern is formed, the above steps can be sequentially repeated for each color to produce a cured coat. Thus, a color filter is obtained.

The post-baking is a heating treatment performed after development so as to complete curing, and in the post-baking, a thermal curing treatment is carried out usually at 100° C. to 240° C., and preferably at 200° C. to 240° C.

The post-baking treatment can be carried out on the coating film obtained after development in a continuous or batch manner, by using heating means such as a hot plate, a convection oven (a hot-air circulation type drier), and a high-frequency heater under the conditions described above.

<<Case of Forming Pattern by Dry Etching Method>>

For the colored layer, the dry etching can be carried out with an etching gas, using a patterned photoresist layer as a mask. Specifically, a positive-type or negative-type radiation-sensitive composition is applied onto the colored layer and dried to form a photoresist layer. In the formation of the photoresist layer, it is preferable to further carry out a pre-baking treatment. In particular, as a process for forming a photoresist, a configuration in which a post-exposure heating treatment (PEB) or a post-development heating treatment (post-baking treatment) is carried out is preferable.

As the photoresist, for example, a positive-type radiation-sensitive composition is used. As the positive-type radiation-sensitive composition, a positive-type resist composition suitable for a positive-type photoresist, which responds to radiation, for example, an ultraviolet ray (a g-ray, an h-ray, or an i-ray), a far ultraviolet ray including an excimer laser and the like, an electron beam, an ion beam, or an X-ray, can be used. Among the radiations, a g-ray, an h-ray, or an i-ray is preferable, among which the i-ray is more preferable.

Specifically, as the positive-type radiation-sensitive composition, a composition containing a quinonediazide compound and an alkali-soluble resin is preferable. The positive-type radiation-sensitive composition containing a quinonediazide compound and an alkali-soluble resin utilizes a quinonediazide group being decomposed to generate a carboxyl group by light irradiation at a wavelength of 500 nm or less, and as a result, the quinonediazide compound is shifted from an alkali-insoluble state to an alkali-soluble state. Since this positive-type photoresist is remarkably excellent in the resolving power, it is used for the manufacture of an integrated circuit, for example, IC and LSI. Examples of the quinonediazide compound include a naphthoquinonediazide compound. Examples of commercially available products thereof include “FHi622BC” (manufactured by FUJIFILM Electronics Materials Co., Ltd.).

The thickness of the photoresist layer is preferably 0.1 μm to 3 μm, more preferably 0.2 μm to 2.5 μm, and still more preferably 0.3 μm to 2 μm. Incidentally, coating of the photoresist layer can be suitably carried out using the coating method described with respect to the above-described colored layer.

Next, a resist pattern (patterned photoresist layer) in which a resist through-hole group is disposed is formed by exposing and developing the photoresist layer. The formation of the resist pattern can be carried out by appropriately optimizing heretofore known techniques of photolithography without particular limitation. By providing the resist through-hole group in the photoresist layer by exposure and development, the resist pattern which is used as an etching mask in the subsequent etching is provided on the colored layer.

Exposure of the photoresist layer can be carried out by exposing a positive-type or negative-type radiation-sensitive composition to a g-ray, an h-ray, or an i-ray, and preferably to an i-ray through a predetermined mask pattern. After the exposure, a development treatment is carried out using a developer to remove the photoresist corresponding to the region where a colored pattern is to be formed.

As the developer, any developer which does not affect a colored layer containing a coloring agent and dissolves the exposed area of a positive resist or the uncured area of a negative resist may be used, and for example, a combination of various organic solvents or an aqueous alkaline solution is used. As the aqueous alkaline solution, an aqueous alkaline solution prepared by dissolving an alkaline compound to yield a concentration of 0.001% by mass to 10% by mass, and preferably 0.01% by mass to 5% by mass is suitable. Examples of the alkaline compound include tetrapropylammonium hydroxide, tetrabutylammonium hydroxide, benzyltrimethylammonium hydroxide, sodium hydroxide, potassium hydroxide, sodium carbonate, sodium silicate, sodium metasilicate, aqueous ammonia, ethylamine, diethylamine, dimethylethanolamine, tetramethylammonium hydroxide, tetraethylammonium hydroxide, choline, pyrrole, piperidine, and 1,8-diazabicyclo-[5.4.0]-7-undecene. Incidentally, in the case where an aqueous alkaline solution is used as the developer, a cleaning treatment with water is generally carried out after development.

Next, the colored layer is patterned by dry etching so as to form a through-hole group in the colored layer using the resist pattern as an etching mask. Thus, a colored pattern is formed. The through-hole group is provided checkerwise in the colored layer. Thus, a first colored pattern having the through-hole group provided in the colored layer has a plurality of first quadrangular colored pixels checkerwise.

Specifically, the dry etching is carried out by dry etching the colored layer using the resist pattern as an etching mask. Representative examples of the dry etching include the methods described in JP1984-126506A (JP-S59-126506A) JP1984-46628A (JP-S59-46628A), JP1983-9108A (JP-S58-9108A), JP1983-2809A (JP-S58-2809A), JP1982-148706A (JP-S57-148706A), JP1986-41102A (JP-S61-41102A), or the like.

It is preferable that the dry etching is carried out in a configuration as described below from the viewpoint of forming a pattern cross-section closer to that of a rectangle or of further reducing damage to a support.

A configuration is preferable, which includes a first-stage etching of etching up to an area (depth) where the support is not revealed by using a mixed gas of a fluorine-based gas and an oxygen gas (O₂), a second-stage etching of preferably etching up to the vicinity of an area (depth) where the support is revealed by using a mixed gas of a nitrogen gas (N₂) and an oxygen gas (O₂) after the first-stage etching, and an over-etching carried out after the support has been revealed. A specific manner of the dry etching as well as the first-stage etching, the second-stage etching, and the over-etching will be described below.

The dry etching is carried out by determining the etching conditions in advance in the following manner.

(1) An etching rate (nm/min) in the first-stage etching and an etching rate (nm/min) in the second-stage etching are respectively calculated. (2) A time for etching a predetermined thickness in the first-stage etching and a time for etching a predetermined thickness in the second-stage etching are calculated, respectively. (3) The first-stage etching is carried out according to the etching time calculated in (2) above. (4) The second-stage etching is carried out according to the etching time calculated in (2) above. Alternatively, an etching time is determined by endpoint detection, and the second-stage etching may be carried out according to the etching time determined. (5) The over-etching time is calculated in response to the total time of (3) and (4) above, and the over-etching is carried out.

The mixed gas used in the first-stage etching step preferably contains a fluorine-based gas and an oxygen gas (O₂) from the viewpoint of processing an organic material of the film to be etched into a rectangle shape. The first-stage etching step may avoid damage to the support by adopting the configuration of etching up to an area where the support is not revealed. After the etching is carried out up to an area where the support is not revealed by the mixed gas of a fluorine-based gas and an oxygen gas in the first-stage etching step, etching treatment in the second-stage etching step and etching treatment in the over-etching step are preferably carried out by using the mixed gas of a nitrogen gas and an oxygen gas from the viewpoint of avoiding damage to the support.

It is important that a ratio between the etching amount in the first-stage etching step and the etching amount in the second-stage etching step is determined so as not to deteriorate the rectangularity by the etching treatment in the first-stage etching step. Incidentally, the proportion of the etching amount in the second-stage etching step with respect to the total etching amount (the sum of the etching amount in the first-stage etching step and the etching amount in the second-stage etching step) is preferably in a range of more than 0% and 50% or less, and more preferably 10% to 20%. The etching amount means an amount determined by a difference between the remaining film thickness of the etched film and the film thickness of the film before the etching.

Furthermore, the etching preferably includes an over-etching treatment. The over-etching treatment is preferably carried out by determining an over-etching rate. The over-etching rate is preferably calculated from an etching treatment time which is carried out at first. Although the over-etching rate may be arbitrarily determined, it is preferably 30% or less, more preferably 5% to 25%, and particularly preferably 10% to 15%, of the etching processing time in the etching steps, from the viewpoint of etching resistance of the photoresist and preservation of the rectangularity of the etched pattern.

Next, the resist pattern (that is, the etching mask) remaining after the etching is removed. The removal of the resist pattern preferably includes a step of supplying a peeling solution or a solvent on the resist pattern to bring the resist pattern into a removable state, and a step of removing the resist pattern using cleaning water.

The step of supplying a peeling solution or a solvent on the resist pattern to make the resist pattern be in a removable state includes, for example, a step of paddle development by supplying a peeling solution or a solvent at least on the resist pattern and retaining for a predetermined time. The time for retaining the peeling solution or a solvent is not particularly limited, and is preferably several tens of seconds to several minutes.

Moreover, the step of removing the resist pattern using cleaning water includes, for example, a step of removing the resist pattern by spraying cleaning water from a spray-type or shower-type spray nozzles onto the resist pattern. As the cleaning water, pure water is preferably used. The spray nozzles include spray nozzles having a spray area which covers the entire support and mobile spray nozzles having a mobile area which covers the entire support. In the case where the spray nozzles are mobile spray nozzles, the resist pattern can be more effectively removed by moving the mobile spray nozzles twice or more times from the center of support to the edge of the support to spray cleaning water in the step of removing the resist pattern.

The peeling solution generally contains an organic solvent and may further contain an inorganic solvent. Examples of the organic solvent include 1) a hydrocarbon-based compound, 2) a halogenated hydrocarbon-based compound, 3) an alcohol-based compound, 4) an ether- or acetal-based compound, 5) a ketone- or aldehyde-based compound, 6) an ester-based compound, 7) a polyhydric alcohol-based compound, 8) a carboxylic acid- or its acid anhydride-based compound, 9) a phenol-based compound, 10) a nitrogen-containing compound, 11) a sulfur-containing compound, and 12) a fluorine-containing compound. The peeling solution preferably contains a nitrogen-containing compound, and more preferably contains an acyclic nitrogen-containing compound and a cyclic nitrogen-containing compound.

The acyclic nitrogen-containing compound is preferably an acyclic nitrogen-containing compound having a hydroxyl group. Specific examples thereof include monoisopropanolamine, diisopropanolamine, triisopropanolamine, N-ethylethanolamine, N,N-dibutylethanolamine, N-butylethanolamine, monoethanolamine, diethanolamine, and triethanolamine, among which monoethanolamine, diethanolamine, and triethanolamine are preferable, and monoethanolamine (H₂NCH₂CH₂OH) is more preferable. Further, examples of the cyclic nitrogen-containing compound include isoquinoline, imidazole, N-ethylmorpholine, ε-caprolactam, quinoline, 1,3-dimethyl-2-imidazolidinone, a-picoline, β-picoline, γ-picoline, 2-pipecoline, 3-pipecoline, 4-pipecoline, piperazine, piperidine, pyrazine, pyridine, pyrrolidine, N-methyl-2-pyrrolidone, N-phenyl morpholine, 2,4-lutidine, and 2,6-lutidine, among which N-methyl-2-pyrrolidone and N-ethyl morpholine are preferable, and N-methyl-2-pyrrolidone (NMP) is more preferable.

The peeling solution preferably includes both the acyclic nitrogen-containing compound and the cyclic nitrogen-containing compound, more preferably contains at least one selected from monoethanolamine, diethanolamine, and triethanolamine as the acyclic nitrogen-containing compound, and at least one selected from N-methyl-2-pyrrolidone and N-ethyl morpholine as the cyclic nitrogen-containing compound, and still more preferably contains monoethanolamine and N-methyl-2-pyrrolidone.

In the removal with the peeling solution, it is sufficient that the resist pattern formed on the first colored pattern is removed, and in a case where a deposit of an etching product is attached to the side wall of the first colored pattern, it is not always necessary to completely remove the deposit. The deposit means an etching product attached and deposited to the side wall of colored layer.

For the peeling solution, it is preferable that the content of the acyclic nitrogen-containing compound is 9 parts by mass to 11 parts by mass based on 100 parts by mass of the peeling solution, and the content of the cyclic nitrogen-containing compound is 65 parts by mass to 70 parts by mass based on 100 parts by mass of the peeling solution. The peeling solution is preferably one prepared by diluting a mixture of the acyclic nitrogen-containing compound and the cyclic nitrogen-containing compound with pure water.

Incidentally, the method for manufacturing a color filter of the present invention may have a step known as a method for manufacturing a color filter for a solid-state imaging element, if desired, as a step other than the above steps. For example, the method may include a curing step of curing the formed colored pattern by heating and/or exposure, if desired, after the coloring composition layer forming step, the exposing step, and the pattern forming step are carried out.

Moreover, in the case of using the coloring composition according to the present invention, contaminations or the like occur in some cases, for example, when a nozzle of an ejection portion or a piping portion of a coating device is clogged, or the coloring composition or a pigment adheres to or is precipitated or dried inside the coating machine. Accordingly, in order to efficiently clean off the contaminations caused by the composition of the present invention, it is preferable to use the solvent relating to the coloring composition of the present invention as a cleaning liquid. In addition, the cleaning liquids described in JP1995-128867A (JP-H07-128867A), JP1995-146562A (JP-1107-146562A), JP1996-278637A (JP-H08-278637A), JP2000-273370A, JP2006-85140A, JP2006-291191A, JP2007-2101A, JP2007-2102A, JP2007-281523A, and the like can also be suitably used to clean and remove the coloring composition according to the present invention.

Among the above, alkylene glycol monoalkyl ether carboxylate and alkylene glycol monoalkyl ether are preferable.

These solvents may be used alone or as a mixture of two or more kinds thereof. In the case where two or more kinds thereof are mixed, it is preferable to mix a solvent having a hydroxyl group with a solvent not having a hydroxyl group. The mass ratio between the solvent having a hydroxyl group and the solvent not having a hydroxyl group is 1/99 to 99/1, preferably 10/90 to 90/10, and still more preferably 20/80 to 80/20. A mixed solvent in which propylene glycol monomethyl ether acetate (PGMEA) is mixed with propylene glycol monomethyl ether (PGME) at a ratio of 60/40 is particularly preferable. Incidentally, in order to improve the permeability of the cleaning liquid with respect to the contaminant, it is preferable to add the aforementioned surfactants relating to the present formulation to the cleaning liquid.

Since the color filter of the present invention uses the coloring composition of the present invention, exposure having an excellent exposure margin can be carried out, and the formed colored pattern (colored pixel) has an excellent pattern shape. Further, since the surface roughness of the pattern and the amount of residues in a developed area are reduced, excellent color characteristics are exhibited.

The color filter of the present invention can be suitably used for a solid-state imaging element such as a CCD and a CMOS, and is particularly preferable for a CCD, a CMOS, and the like with a high resolution, having more than 1,000,000 pixels. The color filter for a solid-state imaging element of the present invention can be used as, for example, a color filter disposed between a light-receiving portion of each pixel constituting a CCD or a CMOS and a microlens for condensing light.

Incidentally, the film thickness of the colored pattern (colored pixel) in the color filter of the present invention is preferably 2.0 μm or less, more preferably 1.0 μm or less, and still more preferably 0.7 μm or less

Moreover, the size (pattern width) of the colored pattern (colored pixel) is preferably 2.5 μm or less, more preferably 2.0 μm or less, and particularly preferably 1.7 μm or less.

(Solid-State Imaging Element)

The solid-state imaging element of the present invention includes the color filter of the present invention. The constitution of the solid-state imaging element of the present invention is not particularly limited as long as the solid-state imaging element is constituted to include the color filter in the present invention and functions as a solid-state imaging element. However, for example, the solid-state imaging element can be constituted as below.

The solid-state imaging element has a configuration in which transfer electrodes consisting of a plurality of photodiodes and transfer electrodes formed of polysilicon or the like constituting a light-receiving area of a solid-state imaging element (a CCD image sensor, a CMOS image sensor, or the like) are arranged onto a support; a light shielding film which is opened only to the light-receiving portion of the photodiode and is formed of tungsten or the like is disposed on the photodiodes and the transfer electrodes; a device protecting film which is formed for covering the entire surface of the light shielding film and the light receiving portion of the photodiodes and is formed of silicon nitride or the like is disposed on the light shielding film; and the color filter for a solid-state imaging element of the present invention is disposed on the device protecting film

In addition, the solid-state imaging element may have a constitution in which light-condensing means (for example, a microlens or the like, which shall apply hereinafter) is disposed to a portion positioned on the device protecting layer and under the color filter (side close to the support), a constitution in which light-condensing means is disposed on the color filter, and the like.

(Image Display Device)

The color filter of the present invention can be used not only for a solid-state imaging element, but also for an image display device such as a liquid crystal display device and an organic EL display device. In particular, the color filter is suitable for the applications of a liquid crystal display device. The liquid crystal display device including the color filter of the present invention can display a high-quality image showing a good tone of a display image and having excellent display characteristics.

The definition of display devices or details of the respective display devices are described in, for example, “Electronic Display Device (Akio Sasaki, Kogyo Chosakai Publishing Co., Ltd., published in 1990)”, “Display Device (Sumiaki Ibuki, Sangyo Tosho Co., Ltd., published in 1989)”, and the like. In addition, the liquid crystal display device is described in, for example, “Next-Generation Liquid Crystal Display Technology (edited by Tatsuo Uchida, Kogyo Chosakai Publishing Co., Ltd., published in 1994)”. The liquid crystal display device to which the present invention can be applied is not particularly limited, and for example, the present invention can be applied to liquid crystal display devices employing various systems described in the “Next-Generation Liquid Crystal Display Technology”.

The color filter of the present invention may be used for a liquid crystal display device using a color TFT system. The liquid crystal display device using a color TFT system is described in, for example, “Color TFT Liquid Crystal Display (KYORITSU SHUPPAN Co., Ltd., published in 1996)”. Further, the present invention can be applied to a liquid crystal display device having an enlarged view angle, which uses an in-plane switching driving system such as IPS and a pixel division system such as MVA, or to STN, TN, VA, OCS, FFS, R—OCB, and the like.

In addition, the color filter in the present invention can be provided to a Color-filter On Array (COA) system which is a bright and high-definition system. In the liquid crystal display device of the COA system, the characteristics required for a color filter layer need to include characteristics required for an interlayer insulating film, that is, a low dielectric constant and resistance to a peeling solution in some cases, in addition to the generally required characteristics as described above. In the color filter of the present invention, a dye multimer having an excellent hue is used. Accordingly, the color purity, light-transmitting properties, and the like are excellent, and the tone of the colored pattern (pixel) is excellent. Consequently, a liquid crystal display device of a COA system which has a high resolution and is excellent in long-term durability can be provided. Further, in order to satisfy the characteristics required for a low dielectric constant, a resin coat may be provided on the color filter layer.

These image display systems are described in, for example, p. 43 of “EL, PDP, and LCD Display Technologies and Recent Trends in the Market (TORAY RESEARCH CENTER, Research Department, published in 2001)”, and the like.

The liquid crystal display device including the color filter in the present invention is constituted with various members such as an electrode substrate, a polarizing film, a phase difference film, a backlight, a spacer, and a view angle compensation film, in addition to the color filter of the present invention. The color filter of the present invention can be applied to a liquid crystal display device constituted with these known members. These members are described in, for example, “'94 Market of Peripheral Materials And Chemicals of Liquid Crystal Display (Kentaro Shima, CMC Publishing Co., Ltd., published in 1994)” and “2003 Current Situation of Market Relating to Liquid Crystal and Prospects (Vol. 2) (Ryokichi Omote, Fuji Chimera Research Institute, Inc., published in 2003)”.

The backlight is described in SID Meeting Digest 1380 (2005) (A. Konno, et al.), December Issue of Monthly “Display”, 2005, pp. 18 to 24 (Yasuhiro Shima) and pp. 25 to 30 (Takaaki Yagi) of this document, and the like.

If the color filter in the present invention is used in a liquid crystal display device, high contrast can be realized when the color filter is combined with a three-wavelength tube of a cold cathode tube known in the related art. Further, if a light source of red, green, and blue LED (RGB-LED) is used as a backlight, a liquid crystal display device having high luminance, high color purity, and good color reproducibility can be provided.

### EXAMPLES

Hereinafter, the present invention will be described in more detail with reference to Examples, but the present invention is not limited to the Examples below as long as the object of the present invention is not impaired. Further, “%” and “part(s)” are based on mass unless otherwise specified.

### Synthesis Example 1

### Synthesis of Dye Multimer (S-16)

12 g of a copolymer=33/67 (weight ratio) of methacrylic acid/isocyanatoethyl methacrylate, Mw=5,000, and 35 g of a xanthene dye (A-xt-5) were dissolved in PGMEA (150 mL). To this solution was added NEOSTANN (1 mL), followed by stirring at 80° C. for 2 hours. This reaction solution was cooled to room temperature, and added dropwise to 500 mL of a hexane solution. The precipitated crystal was filtered to 40 g of a compound S-16.

The weight-average molecular weight Mw of the synthesized dye multimer was measured by GPC and the molecular weight distribution was also measured by GPC.

### Synthesis Examples 2 to 28

### Synthesis of Other Dye Multimers

Other dye multimers were synthesized in the same manner as in Synthesis Example 1, except that the polymer component, the compound having a dye structure, and the compound having a polymerizable group were used as shown in the following table.

### Examples and Comparative Examples

### 1. Preparation of Resist Solution

Components having the following composition were mixed and dissolved to prepare a resist solution for an undercoat layer.

<Composition of Resist Solution for Undercoat Layer>

| | |
|---|---|
| Solvent: propylene glycol monomethyl ether acetate | 19.20 parts |
| Solvent: ethyl lactate | 36.67 parts |
| Alkali-soluble resin: 40% PGMEA solution of a benzyl | 30.51 parts |
| methacrylate/methacrylic acid/2-hydroxyethyl | |
| methacrylate copolymer (molar ratio = 60/22/18, | |
| weight-average molecular weight of 15,000, | |
| number-average molecular weight of 9,000) | |
| Compound containing an ethylenically unsaturated | 12.20 parts |
| double bond: dipentaerythritol hexaacrylate | |
| Polymerization inhibitor: p-methoxyphenol | 0.0061 parts |
| Fluorine-based surfactant: F-475, manufactured by | 0.83 parts |
| DIC Corporation | |
| Photopolymerization initiator: trihalomethyl | 0.586 parts |
| triazine-based photopolymerization initiator | |
| (TAZ-107, manufactured by Midori Kagaku Co., Ltd.) | |

### 2. Manufacture of Undercoat Layer-Attached Silicon Wafer Substrate

A 6-inch silicon wafer was heated in an oven at 200° C. for 30 minutes. Next, the resist solution was applied onto this silicon wafer such that the dry film thickness became 1.5 μm. Further, the resultant was further heated and dried in an oven at 220° C. for 1 hour to form an undercoat layer to obtain an undercoat layer-attached silicon wafer substrate.

### 3. Preparation of Coloring Composition

3-1. Preparation of Blue Pigment Dispersion

A blue pigment dispersion 1 was prepared in the following manner.

A mixed solution consisting of 13.0 parts of C. I. Pigment Blue 15:6 (blue pigment, average particle size of 55 nm), 5.0 parts of Disperbyk111 as a pigment dispersant, and 82.0 parts of PGMEA was mixed and dispersed for 3 hours by a beads mill (zirconia beads having a diameter of 0.3 mm) to prepare a pigment dispersion. Thereafter, the pigment dispersion was further subjected to a dispersion treatment under a pressure of 2000 kg/cm³ and at a flow rate of 500 g/min, by using a high-pressure dispersing machine equipped with a depressurizing mechanism, NANO-3000-10 (manufactured by Nihon B. E. E Co., Ltd.). This dispersion treatment was repeated 10 times to obtain a blue pigment dispersion 1 (a dispersion of C. I. Pigment Blue 15:6, pigment concentration of 13%) used in the coloring compositions of Examples or Comparative Examples.

For the obtained blue pigment dispersion, the particle size of the pigment was measured using a dynamic light scattering method (Microtrac Nanotrac UPA-EX150 (manufactured by NikkIso Co., Ltd.)), and as a result, was found to be 24 nm.

3-2. Preparation of Coloring Composition

(1) Coloring Composition

The following respective components were mixed, dispersed, and dissolved, and the solutions were filtered through a 0.45-μm nylon filter.

| | |
|---|---|
| Cyclohexanone | 1.133 parts |
| Alkali-soluble resin | 0.030 parts |
| Solsperse 20000 (1% cyclohexane solution, | 0.125 parts |
| manufactured by Lubrizol Japan Ltd.) | |
| Photopolymerization initiator | 0.012 parts |
| Dye multimer (the compound described in the | 0.040 parts in |
| following table, provided that in | terms of a |
| Comparative Examples 1 to 3, | solid content |
| a predetermined dye was used) | |
| Pigment dispersion described in the following | 0.615 parts |
| table (pigment concentration of 13.0%) | |
| Dipentaerythritol hexaacrylate | 0.070 parts |
| Glycerol propoxylate (1% cyclohexane solution) | 0.048 parts |

Photopolymerization Initiator
(I-1): IRGACURE (registered trademark)—OXE01

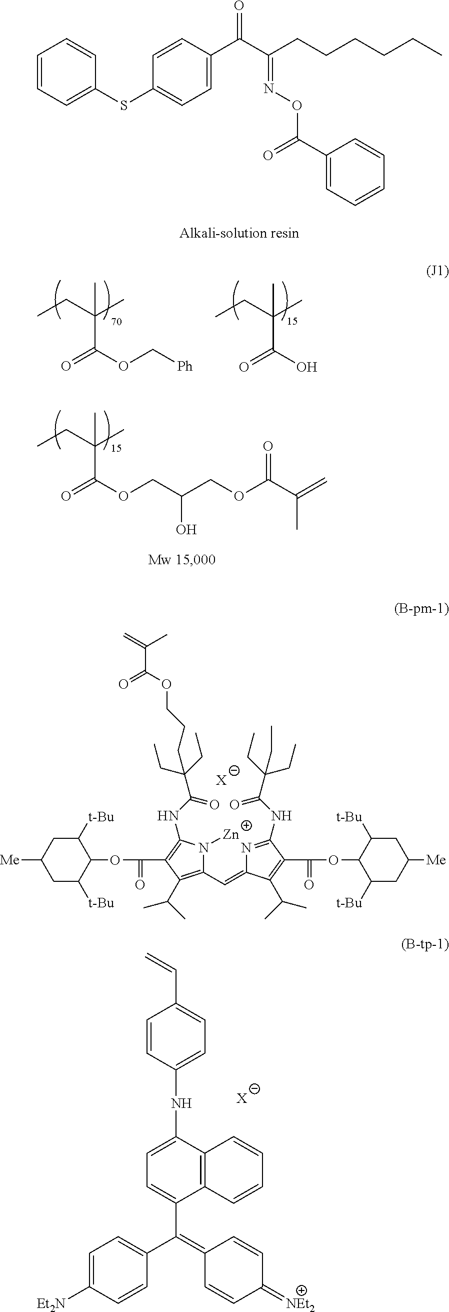

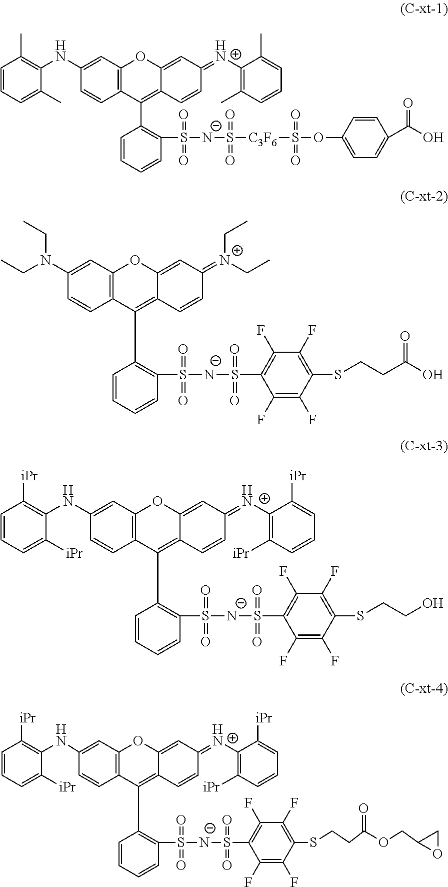

TABLE 13

| | Dye multimer (A) | | | | | | | | | |
|---|---|---|---|---|---|---|---|---|---|---|
| | | | Compound | | | | | | | |
| | Repeating | | having | | Compound | | | | | |
| | units of polymer | | a dye structure | | having a | | Molecular | | | |
| | Com- | Com- | | Counter | polymerizable | | weight | Pigment | Photopolymerization | Alkali-soluble |
| | ponent 1 | ponent 2 | Cation | anion | group | Mw | distribution | (C) | initiator (D) | resin (F) |
| S-1 | P-1 | P-4 | A-xt-1 | (a-10) | — | 20000 | 1.6 | PB 15:6 | I-1 | J1 |
| S-2 | P-1 | P-4 | A-xt-2 | (a-11) | — | 25000 | 1.6 | PB 15:6 | I-1 | J1 |
| S-3 | P-1 | P-4 | A-pm-1 | (a-25) | — | 23000 | 1.6 | PB 15:6 | I-1 | J1 |
| S-4 | P-1 | — | A-xt-3 | (a-14) | — | 21000 | 1.5 | PB 15:6 | I-1 | J1 |
| S-5 | P-1 | — | A-xt-4 | (a-15) | — | 30000 | 1.5 | PB 15:6 | I-1 | J1 |
| S-6 | P-1 | — | A-pm-2 | (a-23) | — | 27000 | 1.5 | PB 15:6 | I-1 | J1 |
| S-7 | P-1 | — | A-pm-3 | (a-24) | — | 28000 | 1.5 | PB 15:6 | I-1 | J1 |
| S-8 | P-1 | — | A-pm-4 | (a-7) | — | 26000 | 1.5 | PB 15:6 | I-1 | J1 |
| S-9 | P-5 | P-9 | A-xt-5 | (a-3) | — | 31000 | 1.6 | PB 15:6 | I-1 | J1 |
| S-10 | P-5 | P-9 | A-xt-6 | (a-4) | — | 22000 | 1.6 | PB 15:6 | I-1 | J1 |
| S-11 | P-5 | P-9 | A-xt-7 | (a-5) | — | 24000 | 1.6 | PB 15:6 | I-1 | J1 |
| S-12 | P-5 | P-9 | A-pm-5 | (a-11) | — | 23000 | 1.6 | PB 15:6 | I-1 | J1 |
| S-13 | P-5 | P-9 | A-pm-6 | (a-14) | — | 22000 | 1.6 | PB 15:6 | I-1 | J1 |
| S-14 | P-5 | P-9 | A-pm-7 | (a-15) | — | 20000 | 1.6 | PB 15:6 | I-1 | J1 |
| S-15 | P-5 | P-9 | A-tp-1 | (a-3) | — | 20000 | 1.6 | PB 15:6 | I-1 | J1 |
| S-16 | P-1 | P-6 | A-xt-5 | (a-6) | — | 21000 | 1.6 | PB 15:6 | I-1 | J1 |
| S-17 | P-1 | P-6 | A-xt-6 | (a-7) | — | 23000 | 1.6 | PB 15:6 | I-1 | J1 |
| S-18 | P-1 | P-6 | A-xt-7 | (a-8) | — | 25000 | 1.6 | PB 15:6 | I-1 | J1 |
| S-19 | P-1 | P-6 | A-pm-5 | (a-20) | — | 27000 | 1.6 | PB 15:6 | I-1 | J1 |
| S-20 | P-1 | P-6 | A-pm-6 | (a-22) | — | 29000 | 1.6 | PB 15:6 | I-1 | J1 |
| S-21 | P-1 | P-6 | A-pm-7 | (a-7) | — | 28000 | 1.6 | PB 15:6 | I-1 | J1 |
| S-22 | P-1 | P-6 | A-tp-1 | (a-11) | — | 24000 | 1.6 | PB 15:6 | I-1 | J1 |
| S-23 | P-2 | P-4 | A-xt-1 | (a-13) | — | 21000 | 1.6 | PB 15:6 | I-1 | J1 |
| S-24 | P-10 | P-5 | A-pm-5 | (a-11) | — | 30000 | 1.6 | PB 15:6 | I-1 | J1 |
| S-25 | P-2 | P-6 | A-tp-1 | (a-6) | — | 31000 | 1.6 | PB 15:6 | I-1 | J1 |
| S-26 | P-7 | — | A-xt-3 | (a-7) | — | 28000 | 1.6 | PB 15:6 | I-1 | J1 |
| S-27 | P-7 | — | A-pm-2 | (a-10) | — | 25000 | 1.6 | PB 15:6 | I-1 | J1 |
| S-28 | P-1 | — | A-xt-3 | (a-14) | P-8 | 26000 | 1.6 | PB 15:6 | I-1 | J1 |
| S-29 | Dye multimer (S-4) of JP2012-32754A | | | | | 5400 | 1.9 | PB 15:6 | I-1 | J1 |
| (Comparative) | | | | | | | | | | |
| S-30 | MAA | B-pm-1 | — | — | — | 7000 | 2.1 | PB 15:6 | I-1 | J1 |
| (Comparative) | | | | | | | | | | |
| S-31 | MAA | B-tp-1 | — | — | — | 7000 | 2 | PB 15:6 | I-1 | J1 |
| (Comparative) | | | | | | | | | | |
| S-32 | P-1 | P-4 | C-xt-1 | | — | 9000 | 1.5 | PB 15:6 | I-1 | J1 |
| S-33 | P-1 | P-16 | C-xt-2 | | — | 15000 | 1.5 | PB 15:6 | I-1 | J1 |
| S-34 | P-1 | P-6 | C-xt-3 | | — | 10000 | 1.6 | PB 15:6 | I-1 | J1 |
| S-35 | P-1 | — | C-xt-4 | | P-8 | 10000 | 1.6 | PB 15:6 | I-1 | J1 |

In the table, MAA represents methyl methacrylate.

### 4. Manufacture of Color Filter Using Coloring Composition

<Pattern Formation>

Each of the coloring compositions of Examples and Comparative Examples, which had been prepared as above, was applied onto the undercoat layer of the undercoat layer-attached silicon wafer substrate obtained in the above section 2, thereby forming a coloring composition layer (coating film) Then, a heating treatment (pre-baking) was carried out for 120 seconds by using a hot plate at 100° C. such that the dry film thickness of the coating film became 0.6 μm.

Next, by using an i-ray stepper exposure device FPA-3000i5+ (manufactured by CANON Inc.), the wafer was exposed at a wavelength of 365 nm through an island pattern mask having a 1.0 μm×1.0 μm pattern, by varying the exposure dose in a range from 50 mJ/cm² to 1,200 mJ/cm².

Subsequently, the silicon wafer substrate, on which the coating film irradiated with light had been formed, was loaded onto a horizontal spin table of a spin shower developing machine (Model DW-30, manufactured by Chemitronics Co., Ltd.), and subjected to paddle development at 23° C. for 60 seconds by using CD-2000 (manufactured by FUJIFILM Electronic Materials CO., LTD.), thereby forming a colored pattern on the silicon wafer substrate.

The silicon wafer on which the colored pattern had been formed was fixed onto the horizontal spin table by a vacuum chuck method, and the silicon wafer substrate was rotated at a rotation frequency of 50 r.p.m. by using a rotation device. In this state, from the position above the rotation center, pure water was supplied onto the wafer from a spray nozzle in the form of shower so as to perform a rinsing treatment, and then the wafer was spray-dried.

In the manner described above, a color filter having the colored pattern formed of the coloring compositions of Examples or Comparative Examples were manufactured.

Thereafter, the size of the colored pattern was measured by using a length measuring SEM “S-9260A” (manufactured by Hitachi High-Technologies Corporation). An exposure dose at which the pattern size became 1.0 μm was determined as an optimal exposure dose.

### 5. Evaluation of Performance

5-1. Pattern Deficit

100 colored patterns were observed and the number of patterns with a deficit was counted. A larger number indicates a worse pattern deficit. The results are shown in the following table.

5-2. Evaluation of Color Migration

The absorbance of the colored pattern in each of the color filters was measured with MCPD-3000 (manufactured by Otsuka Electronics Co., Ltd.) (Absorbance A).

A CT-2000L solution (a transparent undercoating agent, manufactured by FUJIFILM Electronics Materials Co., Ltd.) was applied onto the surface, on which the colored pattern of the color filter had been formed, such that the dried film thickness became 1 μm, and dried to form a transparent film, and the film was subjected to a heating treatment at 280° C. for 5 minutes.

After the completion of heating, the absorbance of the transparent film adjacent to the colored pattern was measured with MCPD-3000 (manufactured by Otsuka Electronics Co., Ltd.) (Absorbance B).

The ratio [%] of the value of the absorbance A of the colored pattern which had been measured before heating to the value of the absorbance B of the obtained transparent film was calculated [the following (Equation A)]. The ratio was used as an index for evaluating the color migration to adjacent pixels.

Color migration (%)=Absorbance B/Absorbance A×100 (Equation A)

5-3. Heat Resistance

The glass substrate on which the coloring curable composition obtained above had been applied was loaded onto a hot plate at 200° C. such that it came into contact with the substrate surface, and heated for 1 hour. Then, the color difference (ΔE*ab value) between before and after the heating was measured using a chromoscope MCPD-1000 (manufactured by Otsuka Electronics Co., Ltd.) and used as an index for evaluating the heat fastness, and the index was evaluated in accordance with the following evaluation criteria. A small ΔE*ab value indicates good heat resistance. Incidentally, the ΔE*ab value is a value determined from the following color-difference formula according to CIE 1976 (L*, a*, b*) color space (New Edition of Color Science Handbook (1985) p. 266, edited by The Color Science Association of Japan).

ΔE*ab={(ΔL*)2+(Δa*)2+(Δb*)2}1/2

TABLE 14

| | | | Color | Pattern |
|---|---|---|---|---|
| | Dye multimer | Heat resistance | migration | deficit |
| Example 1 | S-1 | 1.1 | 1 | 2 |
| Example 2 | S-2 | 1 | 2 | 3 |
| Example 3 | S-3 | 2.2 | 2 | 1 |
| Example 4 | S-4 | 1.5 | 2 | 2 |
| Example 5 | S-5 | 1.3 | 0 | 3 |
| Example 6 | S-6 | 2.1 | 1 | 0 |
| Example 7 | S-7 | 1.9 | 2 | 2 |
| Example 8 | S-8 | 1.7 | 1 | 1 |
| Example 9 | S-9 | 0.5 | 2 | 0 |
| Example 10 | S-10 | 1.8 | 1 | 2 |
| Example 11 | S-11 | 0.9 | 0 | 2 |
| Example 12 | S-12 | 1.6 | 0 | 1 |
| Example 13 | S-13 | 2 | 1 | 1 |
| Example 14 | S-14 | 2.1 | 1 | 0 |
| Example 15 | S-15 | 2.5 | 1 | 3 |
| Example 16 | S-16 | 1.4 | 1 | 2 |
| Example 17 | S-17 | 1.2 | 1 | 1 |
| Example 18 | S-18 | 1.1 | 1 | 0 |
| Example 19 | S-19 | 1.5 | 0 | 1 |
| Example 20 | S-20 | 1.3 | 0 | 1 |
| Example 21 | S-21 | 1.6 | 0 | 2 |
| Example 22 | S-22 | 2.2 | 1 | 3 |
| Example 23 | S-23 | 1 | 1 | 2 |
| Example 24 | S-24 | 1.4 | 0 | 2 |
| Example 25 | S-25 | 2 | 2 | 1 |
| Example 26 | S-26 | 2.2 | 2 | 1 |
| Example 27 | S-27 | 2.3 | 2 | 1 |
| Example 28 | S-28 | 0.9 | 0 | 0 |
| Comparative | S-29 (Comparative) | 4.2 | 5 | 5 |
| Example 1 | | | | |
| Comparative | S-30 (Comparative) | 4.3 | 7 | 5 |
| Example 2 | | | | |
| Comparative | S-31 (Comparative) | 5.2 | 6 | 7 |
| Example 3 | | | | |
| Example 29 | S-32 | 1.4 | 2 | 2 |
| Example 30 | S-33 | 1.1 | 2 | 1 |
| Example 31 | S-34 | 1.5 | 1 | 2 |
| Example 32 | S-35 | 0.8 | 0 | 0 |

As clearly seen from the above table, it could be seen that in the case where color filters were manufactured by photoresists, using the dye multimer produced by the production method of the present invention, the pattern deficit was small, the heat resistance was high, and the color migration was small.

### 6. Pattern Formation to which Dry Etching Method is Applied

Preparation of Coloring Composition

The following components were mixed and dissolved to obtain coloring compositions.

| | |
|---|---|
| Cyclohexanone | 1.133 parts |
| Dye multimer (the compound described in the | 0.040 parts in |
| following table) | terms of |
| | a solid content |
| The aforementioned blue pigment dispersion | 0.615 parts |
| (pigment concentration of 13.0%) | |
| Polymerizable compound (EHPE-3150 | 0.070 parts |
| (1,2-epoxy-4-(2-oxiranyl)cyclohexane adduct of | |
| 2,2-bis(hydroxymethyl)-1-butanol, manufactured | |
| by Daicel Chemical Industries, Ltd.)) | |
| Glycerol propoxylate (1% cyclohexane solution) | 0.048 parts |

### 7. Performance Evaluation

7-1. Resistance to Alkaline Developer (Resistance to Developer)

The coloring composition was applied onto a glass substrate, using a spin coater such that the film thickness became 0.6 μm, and subjected to a heating treatment (pre-baking) using a hot plate at 100° C. for 120 seconds. Subsequently, a heating treatment (post-baking) was carried out by using a hot plate at 220° C. for 300 seconds to prepare a cured film.

The transmittance of the color filter thus obtained was measured at a wavelength region of 300 nm to 800 nm by a spectrophotometer (reference: glass substrate), which is a UV-VIS-NIR spectrophotometer, UV3600 (manufactured by SHIMADZU Corporation). In addition, differential interference images were observed through reflective observation (50× magnifications) by using an optical microscope, BX60, manufactured by OLYMPUS Corporation.

Subsequently, the color filter was immersed in FHD-5 (manufactured by FUJIFILM Electronic Materials CO., LTD.) as an alkaline developer for 5 minutes, dried, and then subjected to spectrometry again. The change in the transmittance between before and after solvent immersion (in the case where the transmittance before solvent immersion is defined as T0 and the transmittance after solvent immersion is defined as T1), a value represented by a formula |T0−T1| and film surface anomalies were determined and evaluated according to the following criteria.

AA: Good. A case where the change in the transmittance between before and after solvent immersion is less than 2% in the entire region in a range from 300 nm to 800 nm.

A: Satisfactory. A case where the change in the transmittance between before and after solvent immersion is 2% or more and less than 5% in the entire region in a range from 300 nm to 800 nm.

B: Sufficient. A case where the change in the transmittance between before and after solvent immersion is 5% or more and less than 10% in the entire region in a range from 300 nm to 800 nm.

C: Insufficient. A case where the change in the transmittance between before and after solvent immersion is 10% or more in the entire region in a range from 300 nm to 800 nm.

7-2. Resistance to Peeling Solution

Then, a positive-type photoresist “FHi622BC” (manufactured by FUJIFILM Electronic Materials CO., LTD.) was applied onto the colored film manufactured in the section 7-1, and subjected to pre-baking to form a photoresist layer having a film thickness of 0.8 μm. Then, the photoresist layer was subjected to pattern exposure using an i-ray stepper (manufactured by CANON Inc.) in an exposure dose of 350 mJ/cm² and then to a heating treatment for 1 minute at temperature at which the temperature of the photoresist layer or ambient temperature reached 90° C. Thereafter, a peeling treatment was carried out using a photoresist peeling solution “MS230C” (manufactured by FUJIFILM Electronic Materials CO., LTD.) for 120 seconds to remove the resist pattern, and then cleaning with pure water and spin drying were carried out. Thereafter, dehydration and baking treatments at 100° C. for 2 minutes were carried out.

The obtained colored film was subjected to spectrometry and a change in the transmittance after peeling a value represented by a formula |T0−T2|(in the case where the transmittance before solvent immersion is defined as T0, and the transmittance after solvent immersion is defined as T2), and film surface anomalies were determined and evaluated according to the following criteria.

AA: Good. A case where the change in the transmittance between before and after solvent immersion is less than 2% in the entire region in a range from 300 nm to 800 nm.

A: Satisfactory. A case where the change in the transmittance between before and after solvent immersion is 2% or more and less than 5% in the entire region in a range from 300 nm to 800 nm

B: Sufficient. A case where the change in the transmittance between before and after solvent immersion is 5% or more and less than 10% in the entire region in a range from 300 nm to 800 nm.

C: Insufficient. A case where the change in the transmittance between before and after solvent immersion is 10% or more in the entire region in a range from 300 nm to 800 nm.

TABLE 15

| | | Resistance to | Resistance to |
|---|---|---|---|
| | | developing | peeling |
| | Dye multimer | solution | solution |
| Example 2-1 | S-1 | A | A |
| Example 2-2 | S-2 | AA | AA |
| Example 2-3 | S-3 | AA | AA |
| Example 2-4 | S-4 | A | AA |
| Example 2-5 | S-5 | AA | AA |
| Example 2-6 | S-6 | AA | AA |
| Example 2-7 | S-7 | AA | A |
| Example 2-8 | S-8 | AA | AA |
| Example 2-9 | S-9 | AA | AA |
| Example 2-10 | S-10 | A | A |
| Example 2-11 | S-11 | AA | AA |
| Example 2-12 | S-12 | AA | AA |
| Example 2-13 | S-13 | AA | AA |
| Example 2-14 | S-14 | AA | AA |
| Example 2-15 | S-15 | A | A |
| Example 2-16 | S-16 | A | AA |
| Example 2-17 | S-17 | AA | AA |
| Example 2-18 | S-18 | AA | A |
| Example 2-19 | S-19 | AA | AA |
| Example 2-20 | S-20 | AA | AA |
| Example 2-21 | S-21 | A | A |
| Example 2-22 | S-22 | A | AA |
| Example 2-23 | S-23 | AA | AA |
| Example 2-24 | S-24 | AA | AA |
| Example 2-25 | S-25 | A | AA |
| Example 2-26 | S-26 | AA | AA |
| Example 2-27 | S-27 | AA | AA |
| Example 2-28 | S-28 | AA | AA |
| Comparative Example 2-1 | S-29 | B | B |
| | (Comparative) | | |
| Comparative Example 2-2 | S-30 | A | B |
| | (Comparative) | | |
| Comparative Example 2-3 | S-31 | B | B |
| | (Comparative) | | |
| Example 2-29 | S-32 | A | A |
| Example 2-30 | S-33 | A | AA |
| Example 2-31 | S-34 | AA | A |
| Example 2-32 | S-35 | AA | AA |

As apparent from the table above, it could be seen that the resistance to a developer and the resistance to a peeling solution were excellent in the case where dry etching was carried out using the dye multimer produced by the production method of the present invention, whereas those properties were deteriorated with the dye multimers of Comparative Examples 2-1 to 2-3.

What is claimed is:

1. A method for producing a dye multimer, comprising reacting a compound having a dye structure with a polymer.

2. The method for producing a dye multimer according to claim 1, wherein the reaction is a reaction for forming a covalent bond between the compound having a dye structure and the polymer.

3. The method for producing a dye multimer according to claim 1, further comprising reacting a compound having a polymerizable group with the polymer.

4. The method for producing a dye multimer according to claim 1, wherein the compound having a dye structure includes a cation moiety and a counter anion.

5. The method for producing a dye multimer according to claim 4, wherein the dye structure is a dye structure derived from a dye selected from a dipyrromethene dye, a triarylmethane dye, a xanthene dye, a cyanine dye, and a squarylium dye.

6. The method for producing a dye multimer according to claim 4, wherein the counter anion is selected from a sulfonic acid anion, a sulfonylimide anion, a bis(alkylsulfonyl)imide anion, a tris(alkylsulfonyl)methide anion, a carboxylic acid anion, a tetraarylborate anion, BF₄⁻, PF₆⁻, and SbF₆⁻.

7. The method for producing a dye multimer according to of claim 1, wherein the compound having a dye structure includes a cation and an anion in the same molecule.

8. The method for producing a dye multimer according to claim 1, wherein the molecular weight distribution of the polymer is 1.0 to 2.5.

9. A method for producing a coloring composition, comprising:
producing a dye multimer by the method for producing a dye multimer according to claim 1; and
blending a polymerizable compound, a pigment other than the dye multimer, and a photopolymerization initiator with one another.
